(19) United States
(12) Patent Application Publication
(10) Pub. No.: US 2025/0359573 A1
(43) Pub. Date: Nov. 27, 2025

(54) PROCESSING OF STARCH-PROTEIN PULSES

(71) Applicant: KATHOLIEKE UNIVERSITEIT LEUVEN, Leuven (BE)

(72) Inventors: Wouter Merckx, Lovenjoel (BE); Mathijs Soogen, Lovenjoel (BE); Ivo Roelants, Leuven (BE)

(21) Appl. No.: 19/291,231

(22) Filed: Aug. 5, 2025

Related U.S. Application Data
(63) Continuation-in-part of application No. 18/805,391, filed on Aug. 14, 2024, now Pat. No. 12,402,646.

(30) Foreign Application Priority Data
Jan. 26, 2024 (EP) 24154270.3
Apr. 5, 2024 (EP) 24168781.3
Apr. 12, 2024 (EP) 24169929.7
Apr. 23, 2024 (EP) 24171857.6
Aug. 16, 2024 (EP) 24195034.4
Jan. 27, 2025 (WO) PCT/EP2025/052016
Jul. 23, 2025 (EP) 25191388.5
Jul. 24, 2025 (EP) 25191594.8
Jul. 28, 2025 (EP) 25192052.6

(51) Int. Cl. A23L 11/30; A23J 3/14; A23L 11/00

(52) U.S. Cl. CPC A23L 11/34; A23J 3/14; A23L 11/05

(57) ABSTRACT

This disclosure relates generally to removing the plant tones of starch-protein Fabaceae pulses consisting of chickpea (Cicer arietinum), yellow pea (Pisum sativum), common bean (Phaseolus vulgaris), and/or fava bean (Vicia faba) as hulled or de-hulled pulses whole pulses, as split pulses or as chopped solids thereof with a Feret diameter (Dmax) of 1 to 4 mm while transforming these in an emulsifying and emulsion stabilizing manner suitable for fermentation or emulsion thereof in fermented milk derivatives with a desired texture or form, and fermenting such hulled or de-hulled pulses whole pulses or split pulses into melt-in-mouth or self-disintegrating-in-mouth snacks or breakfast cereal analogues. To achieve these technical effects the pulses were pre-treated with an aqueous bicarbonate solution or bicarbonate/carbonate solution made of bicarbonate salt (MHCO₃), of bicarbonate salt (MHCO₃) and carbonate salt (M₂CO₃), or of bicarbonate salt (MHCO₃) and hydroxide salt (MOH), wherein M is an alkali metal cation, and with a pH between pH 7 and 10, preferably a pH between 7.5 and 10.

### CROSS-REFERENCE TO RELATED APPLICATIONS

This application is a continuation-in-part of U.S. patent application Ser. No. 18/805,391, filed Aug. 14, 2024, which claims the benefit under the Paris Convention and 35 U.S.C. § 119 to the following European Patent applications: EP 24154270.3 filed on Jan. 26, 2024, EP 24168781.3 filed on Apr. 5, 2024, EP 24169929.7 filed on Apr. 12, 2024, and EP 24171857.6 filed on Apr. 23, 2024, the contents of the entirety of each of which are incorporated herein by this reference. This application also claims the benefit of and claims priority under the Paris Convention and 35 U.S.C. § 119 to the following European Patent Applications: EP 24195034.4, filed Aug. 16, 2024, EP 25191388.5, filed Jul. 23, 2025, EP 25191594.8, filed Jul. 24, 2025, and EP 25192052.6, filed Jul. 28, 2025 and further claims priority to PCT/EP2025/052016, filed Jan. 27, 2025, the contents of the entirety of each of which are incorporated by this reference.

### TECHNICAL FIELD

This application relates to macronutrient mixtures, concentrates or isolates of pulse(s) for manufacture of consumables (e.g., food and beverage) of desired mouthfeel properties and taste without the need for improving or masking its original taste by non-nutritive additives or mouthfeel by gums. It also relates to processes to prepare such pulse macronutrient mixtures, concentrates or isolates and while removing off-flavor contaminants. More particularly it relates to treating starch-protein pulse(s) and Fabaceae pulses selected from the group consisting of chickpea (Cicer arietinum), yellow pea (Pisum sativum), common bean (Phaseolus vulgaris) and fava bean (Vicia faba) or pulses with a starch content above 20% on dry weight and a protein content above 15% with starch storage bodies and protein storage bodies, as whole pulses (hulled or de-hulled pulses), as split pulses, or as chopped solids thereof with a Feret diameter (Dmax) of 1 to 4 mm before preparing these in the food form into macronutrient mixtures, concentrates or isolates.

### BACKGROUND

The challenges associated with incorporating plant-based proteins into plant-derived food products are significant considerations in the food industry. Pulse proteins are known to have relative poor functionalities and unpleasant flavors, which have impeded their widespread utilization in food products (Zha et al., 2021). These off-flavors and undesirable sensory attributes, such as bitterness, pose challenges in incorporating pulse-derived proteins into various food applications (Nadeeshani et al., 2022). The taste profile of pulse proteins can be a limiting factor in consumer acceptance and may hinder the adoption of plant-based diets (Bazoche et al., 2023).

Despite the taste challenges, pulses are recognized for their nutritional qualities, including being a good source of protein (Szczebyło et al., 2020). However, altering the properties of pulse proteins during processing, such as through heating processes, can affect their taste and overall quality (Huang et al., 2023). Additionally, the incorporation of pulse proteins into food products, such as snacks and meat alternatives, requires careful consideration of taste modulation to enhance consumer acceptance (Pathiraje et al., 2023; Žugčić et al., 2018).

### SUMMARY OF THE DISCLOSURE

In addressing the taste challenges associated with pulse proteins, a technical solution was found that allows modifying whole pulses functionality and off-flavor profiles of whole multicellular natural produce or produce tissues while preserving cellular structure for separating storage bodies so to concentrate starched, proteins and fibers of neutral taste.

There is a long felt need to have these taste problems solved.

Thus, there is a need in the art for solutions to remove disturbing contaminants, such as plant tones and off tones, from starchy protein pulses such as the Fabaceae of the group consisting of chickpea (C. arietinum), yellow pea (P. sativum), common bean (Phaseolus vulgaris) and fava bean (Vicia faba). Moreover, to render such pulse functionalities to transform them with natural oils in stable non-dairy emulsions with a desired texture. Or to concentrate their macronutrients without disturbing the original contaminants such as plant tones, off tones and anti-nutrients. It is, in particular, also a challenge to ferment such into fermented milk substitutes and water-continuous non-dairy foodstuff on desired texture that are heat pasteurizable, stable when acidic and can be dried an instant powder that can be easily reconstituted in the dairy substitutes of desired textures.

The fundamental compositional differences between starch-protein pulses (chickpeas, peas, common beans, and faba beans) and the oil-protein pulse (soybean) are profound, originating from divergent energy storage strategies. These differences cascade through their macronutrient profiles, the molecular structure of their proteins and carbohydrates, and their functional properties.

The starch-protein pulses such as chickpea, pea, common bean, and/or fava bean devote 40%±10% of their dry matter to starch and a further 20-30% to protein, easily meeting one's >20% starch and >15% protein criteria. During seed fill of starch-protein pulses, sucrose unloaded from the phloem is channeled into amyloplasts where it is polymerized into semi-crystalline starch granules. In parallel, globulin storage proteins assemble into separate protein bodies in the protein storage vacuole system. Because the two reserves occupy distinct organelles, the cotyledon of starch-protein pulses is a mosaic of starch-rich and protein-rich domains in a cellular structure, as visualized in microscopy studies of whole chickpea and pea seeds.

Disclosed is a process of removing the off-tone taste of such starch-protein pulses while maintaining the cellular structure and semi-crystalline structure of both amorphous and crystalline regions as in native starch granules. So after the process of reducing the off-tone taste, the dry or wet separation of starch granules from protein bodies is in fractions with a negligible or barely perceptible off tone. A method hereof allowed that the starch granules of mature field harvested chickpea, pea, common bean, or fava bean can be intactly removed from the domains (clusters) during wet or dry milling into substantially the amount of intact starch bodies that can consequently easily be removed from the protein bodies and cell wall debris.

In contrast, the oil-protein pulse, such as soybean, follows a different sink strategy. After an early, transient starch phase, its amyloplasts are dismantled and carbon is redirected to fatty-acid synthesis and packaged as triacylglycerol into bidirectional oil bodies. By maturity, starch content falls below 1% DW, while oil climbs to ˜22% and protein to ˜38%. Oil bodies dominate the cytoplasm, each surrounded by a phospholipid monolayer studded with oleosin, caleosin, and steroleosin that keep them discrete; protein bodies (glycinin and 3-conglycinin) occupy the remaining space.

Starch-protein pulses supply slowly-digestible starch plus ˜20% protein and almost no fat, suiting low-fat foods or extrusion blends. In contrast, mature field harvested soybean supplies concentrated protein and heart-healthy unsaturated oil but negligible starch, fitting meat analogues or high-energy livestock feeds.

This disclosure solves the existing problems by removing the plant tones and off tones from starchy pulses and providing these with functionalities so that additives and the separation of the different pulse items can be avoided to make, e.g., vegan-dairy like items suitable for fermentation and directly edible snacks and fermented snacks with a unique mouth feel.

Disclosed is a method of manufacturing an acidic fermented colloidal dispersions or suspensions from a pulse selected from the group consisting of chickpea (C. arietinum), yellow pea (P. sativum), common bean (P. vulgaris), and fava bean (Vicia faba) as hulled or de-hulled pulses as whole pulses, as split pulses or as chopped solids thereof with a Feret diameter (Dmax) of 1 to 4 mm, or a combination thereof, the method comprising subjecting the pulses to
a process in which dry pulses are stirred for at least 30 minutes in the bicarbonate solution or bicarbonate/carbonate solution at a temperature in the range of 40 to 70° C., preferably 55-65° C.
a process of removing the aqueous bicarbonate salt solution with pulse flavor and off-tones from the pulse seeds or pulse seeds and seed coats.
optionally a process in which the pulse seeds or the pulse seeds and seed coats are stirred for a short period of 20 minutes to 60 minutes in aqueous solution made of an hydroxide salt (MOH) at a pH above 10, preferably 11 and yet more preferably above 11.5, wherein M is an alkali metal cation and further of removing the aqueous hydroxide salt (MOH) solution.
a process of rinse washing the pulse seeds or pulse seeds and seed coats with water or immersing in water for a period of 30 minutes to 180 minutes a temperature between 2° and 65° C. or immersing for a period 10 to 30 minutes at a temperature between 65° C. and 90° C.
a process of homogenizing the pulse mass from the previous steps with a natural oil and water into an emulsion.
a process of fermenting the homogenate with an added vegan ferment culture and optionally a vegan culture starter medium.

During this process the tissues of the hulled or de-hulled pulses as whole pulses, as split pulses or as chopped solids thereof with a Feret diameter (Dmax) of 1 to 4 mm keep their multicellular structures od cells with cell wall surrounding protein bodies and starch bodies.

One aspect of the disclosure concerns a fermented dairy substitute, comprising or consisting essentially of a fermented mixture of 1) from 1 to 50 wt %, preferably of from 5 to 40, even more preferably of from 10 to 30 wt % of a natural oil and 2) from 3 to 20 wt % by dry weight of bicarbonate modified pulse selected from the group of the starchy Fabaceae pulses consisting of chickpea (C. arietinum), yellow pea (P. sativum), common bean (P. vulgaris) and fava bean (V, faba) and 3) wherein the composition has a pH of between 2.5 and 5.5.

Another aspect of the disclosure is a process for manufacturing dry pulses, dry pulse halves or pulse pieces that are in mouth self-disintegrating, the process comprising the steps of 1) hydrating the pulse seeds in an aqueous bicarbonate solution or bicarbonate/carbonate solution, 2) removing the bicarbonate solution or bicarbonate/carbonate solution, 3) washing the pulse material, 4) fermenting the pulse material with a lactic acid bacteria (LAB) starter culture and optionally any one fermentation starter culture of the groups consisting of a bifidobacteria, a food yeast and a food mold or combination thereof and 4) drying the pulse material.

Also disclosed is a fermented vegan water-continuous product, comprising (or consisting essentially of) a fermented mixture of a) from 1 to 50 wt %, preferably of from 5 to 40, even more preferably of from 10 to 30 wt % of a natural oil and b) from 3 to 20 wt % by dry weight of bicarbonate-modified pulse selected from the group of the starchy Fabaceae pulses consisting of chickpea, yellow pea, common bean, and/or fava bean and c) wherein the composition has a pH of between 2.5 and 5.5.

A method of manufacturing starch enriched powders and protein-enriched powders from a pulse selected from the group consisting of chickpea, yellow pea, common bean, and fava bean as hulled or de-hulled pulses as whole pulses, as split pulses or as chopped solids thereof with a Dmax of 1 to 4 mm, or a combination thereof, the method comprising subjecting the pulses to
a process in which dry pulses are stirred for at least 30 minutes in the bicarbonate solution or bicarbonate/carbonate solution at a temperature in the range of 40 to 70° C., preferably 55-65° C.;
a process of removing the aqueous bicarbonate salt solution with pulse flavor and off-tones from the pulse seeds or pulse seeds and seed coats;
optionally a process in which the pulse seeds or the pulse seeds and seed coats are stirred for a short period of 20 to 60 minutes in aqueous solution made of a hydroxide salt (MOH) at a pH above 10, preferably 11 and yet more preferably above 11.5, wherein M is an alkali metal cation and further of removing the aqueous hydroxide salt (MOH) solution;
a process of rinse washing the pulse seeds or pulse seeds and seed coats with water or immersing in water for a period of 30 minutes to 180 minutes a temperature between 2° and 65° C. or immersing for a period 10 to 30 minutes at a temperature between 65° C. and 90° C.;
a process of drying the pulse seeds or the pulse seeds and seed coats; and
a process of separation of fractions enriched with starch bodies (pulse's starch storage bodies) from fractions enriched with protein bodies (pulse's protein storage bodies).

Further applicability of the disclosure will become apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from this detailed description. It is to be understood that both the foregoing general description and the following detailed description are exemplary and explanatory only and are not restrictive of the disclosure, as claimed.

In view of the foregoing description, the Examples, Figures and description, the disclosure also provides aspects and embodiments as set forth in the following Statements (1′ to 12′) directly below:

Statement 1′ A process for manufacturing dry pulses, dry pulse halves or pulse pieces and these with or without seed coat that are in mouth self-disintegrating or that when dry have a within the range of 20 N to 30 N (Newton), preferable within the range of 10 N to 20 N, the process comprising the steps of 1) stirring the pulse seeds in an aqueous bicarbonate solution or bicarbonate/carbonate solution at a temperature between 50° C. and 70° C. and preferably between 55° C. and 65° C., 2) removing the bicarbonate solution or bicarbonate/carbonate solution, 3) washing the pulse material, 4) fermenting the pulse material with a lactic acid bacteria (LAB) starter culture and optionally any one fermentation starter culture of the groups consisting of a bifidobacteria, a food yeast and a food mold or combination thereof and 4) drying the pulse material.

Statement 2′ The process of statement 1) wherein in step 1) the pulses are stirred for at least 30 minutes and preferably for a period of 1 to 6 hours, preferably between 1.5 and 4 hours in the bicarbonate solution or bicarbonate/carbonate solution at a temperature in the range of 40 to 70° C., preferably 55-65° C. or for a short period of 15 to 30 minutes at a temperature in the range of 70° C. to 90° C., preferably 80-90° C.

Statement 3′ The process of statement 1) wherein in step 1) the pulses are stirred for at least 30 minutes and preferably for a period of 1 to 6 hour, preferably between 1.5 and 4 hours in the bicarbonate solution or bicarbonate/carbonate solution at a temperature in the range of 40 to 70° C., preferably 55-65° C. and the solution has a pH lower than 10 or for a short period of 15 to 30 minutes at a temperature in the range of 70° C. to 90° C., preferably 80-90° C. and the solution has a pH lower than 10.

Statement 4′ The process of any one of statements 1 to 3, further comprising step 5) packaging the dry pulses, dry pulse halves or pulse pieces.

Statement 5′ The process of any one of statements 1 to 4, wherein the pulse selected from the group consisting of chickpea (C. arietinum), yellow pea (P. sativum), common bean (P. vulgaris) and fava bean (V. faba), or a combination thereof.

Statement 6′ The process of any one of statements 1 to 5, wherein the lactic acid bacteria (LAB) is of the group consisting of Lactobacillus acidophilus, Lactobacillus bulgaricus, Lactobacillus casei, Lactobacillus delbrueckii subsp. Bulgaricus, Lactobacillus helveticus, Lactobacillus paracasei, Lactobacillus plantarum, Lactobacillus rhamnosus, Lactococcus lactis (and its subspecies, optionally Lactococcus lactis subsp. Cremoris, Lactococcus lactis subsp. Diacetylactis or Lactococcus lactis subsp. Lactis), Leuconostoc mesenteroide and Streptococcus thermophiles, or a combination thereof

Statement 7′ The process of any one of statements 1 to 5, wherein the bifidobacteria is selected from the group consisting of Bifidobacterium animalis spp. Lactis, Bifidobacterium bifidum, Bifidobacterium lactis and Bifidobacterium breve, or a combination thereof.

Statement 8′ The process of any one of statements 1 to 5, wherein the food yeast is Saccharomyces cerevisiae.

Statement 9′ The process of any one of statements 1 to 5, wherein the food mold is Aspergillus oryzae.

Statement 10′ The process of any one of statements 1 to 9, wherein the aqueous bicarbonate solution or bicarbonate/carbonate solution comprising additionally CaCl₂ to prevent or inhibit material loos from the pulses under treatment in the solution.

Statement 11′ In mouth self-disintegrating dry pulse food, manufactured by the process of any one of statements 1 to 10.

Statement 12′ Dry pulses, dry pulse halves or pulse pieces (with or without seed coat) that when dry have a within the range of 20 N to 30 N (Newton), preferable within the range of 10 N to 20 N, manufactured by any one of statements 1 to 10.

In view of the foregoing description, the Examples, Figures and following description, the disclosure also provides aspects and statements as set forth in the following Statements (1″ to 15″) directly below:

Statement 1″ A fermented dairy substitute, comprising or consisting essentially of a fermented mixture of 1) from 1 to 50 wt %, from 5 to 40 wt %, or from 10 to 30 wt % of a natural oil and 2) from 3 to 60 wt %, from 4 to 59%, from 5 to 40%, from 6 to 30% or from 7 to 20% by dry weight of bicarbonate modified pulse selected from the group of the starchy Fabaceae pulses consisting of chickpea (C. arietinum), yellow pea (P. sativum), common bean (P. vulgaris) and fava bean (V. faba) that have been modified by stirring in a 1 to 5% water carbonate salt solution at a temperature of 55 to 65° C., preferably for a period of 30 min. to 4 hours and 3) wherein the composition has a pH of between 2.5 and 5.5.

Statement 2″ The fermented dairy substitute according to statement one, characterized in that it is a yogurt substitute, Quarg substitute, Kefir substitute, Koumiss substitute, fermented milk substitute, Skyr substitute, Viili substitute, Kurut substitute or a curd substitute.

Statement 3″ The fermented composition of anyone of the statement 1 to 2, wherein the composition does not comprise egg-derived emulsifier.

Statement 4″ The fermented composition of any one of statements 1 and 2, wherein the composition is free of an additional a surface-active emulsifier additive.

Statement 5″ The fermented composition of any one of statements 1 and 4, wherein the composition does not comprise an additive of the group consisting of mono- and diglycerides, polysorbates, carrageenan, guar gum, xanthan gum, carob gum, modified waxy maize starch, modified waxy potato starch, carboxymethylcellulose and methylcellulose.

Statement 6″ The fermented composition of any one of statements 1 and 5, wherein the natural oil is a vegetable oil, a microbial oil, a plant-based oil, a seed oil, a algal oil, a fungal oil, an invertebrate oil and/or a vertebrate oil.

Statement 7″ The fermented composition of any one of statements 1 and 6, wherein the natural oil is a food oil or a body oil.

Statement 8″ The fermented composition of any one of statements 1 to 7, wherein the bicarbonate modified pulse is an in-bicarbonate water slow cooked pulse.

Statement 9″ The fermented composition of any one of statements 1 to 8, wherein the fermented dairy substitute is fermented into a colloidal dispersion.

Statement 10″ The fermented composition of any one of statements 1 to 8, wherein the fermented dairy substitute is a fermented into a colloidal dispersion without the addition of hydrocolloids like gums.

Statement 11″ The fermented composition of any one of statements 1 to 8, characterized in that it is a water-continuous non-dairy product.

Statement 12″ The fermented composition of any one of statements 1 to 8, wherein the fermented dairy substitute is a fermented into a colloidal dispersion with the microstructure of a fermented dairy.

Statement 13″ The fermented composition of any one of statements 1 to 8, wherein the fermented dairy substitute is a fermented into a colloidal dispersion giving the characteristic properties of a fermented dairy.

Statement 14″ The fermented composition of any one of statements 1 to 8, wherein the fermented dairy substitute is a fermented into a in liquid phase suspended aggregates forming a network giving its characteristic properties of a fermented dairy.

Statement 15″ The fermented composition of any one of statements 1 to 8, wherein the fermented dairy substitute is a fermented into a in liquid phase suspended aggregates forming a network giving its texture, consistency, and stability.

In view of the description, the Examples, Figures and further description, the disclosure also provides aspects and embodiments as set forth in the following Statements (1* to 14*) directly below:

Statement 1* A fermented vegan water-continuous product comprising (or consisting essentially of) a fermented mixture of 1) from 1 to 50 wt %, or from 5 to 40 wt %, —or from 10 to 30 wt % of a natural oil and 2) from 3 to 60 wt %, or from 4 to 50 wt %, or from 5 to 40 wt %, or from 6 to 30 wt %, or from 7 to 20 wt % by dry weight of bicarbonate modified pulse selected from the group of the starchy Fabaceae pulses consisting of chickpea (C. arietinum), yellow pea (P. sativum), common bean (P. vulgaris) and fava bean (V. faba) wherein the bicarbonate modified pulse is an in bicarbonate water slow cooked pulse or an in bicarbonate water slow cooked and atmospheric steamed pulse and 3) wherein the composition has a pH of between 2.5 and 5.5.

Statement 2* The fermented composition of statement 1, wherein the composition does not comprise egg-derived emulsifier.

Statement 3* The fermented composition of statement 1 or 2, wherein the composition is free of an additional a surface-active emulsifier additive.

Statement 4* The fermented composition of any one of statements 1 and 3, wherein the composition does not comprise an additive of the group consisting of mono- and diglycerides, polysorbates, carrageenan, guar gum, xanthan gum, carob gum, modified waxy maize starch, modified waxy potato starch, carboxymethylcellulose and methylcellulose.

Statement 5* The fermented composition of any one of statements 1 and 4, wherein the natural oil is a vegetable oil, a microbial oil, a plant-based oil, a seed oil, a algal oil and/or a fungal oil.

Statement 6* The fermented composition of any one of statements 1 and 4, wherein the natural oil is a food oil or a body oil.

Statement 7* The fermented composition of any one of statements 1 to 6, wherein the bicarbonate modified pulse is an in-bicarbonate water slow cooked pulse.

Statement 8* The fermented composition of any one of statements 1 to 7, wherein the fermented dairy substitute is fermented into a colloidal dispersion.

Statement 9* The fermented composition of any one of statements 1 to 7, wherein the fermented dairy substitute is fermented into a colloidal dispersion without the addition of hydrocolloids like gums.

Statement 10* The fermented composition of any one of statements 1 to 7, characterized in that it is a water-continuous non-dairy product.

Statement 11* The fermented composition of any one of statements 1 to 4, wherein the fermented dairy substitute is fermented into a colloidal dispersion with the microstructure of a fermented dairy.

Statement 12* The fermented composition of any one of statements 1 to 4, wherein the fermented dairy substitute is a fermented into a colloidal dispersion giving the characteristic properties of a fermented dairy.

Statement 13* The fermented composition of any one of statements 1 to 8, wherein the fermented dairy substitute is a fermented into a in liquid phase suspended aggregates forming a network giving its characteristic properties of a fermented dairy.

Statement 14* The fermented composition of any one of statements 1 to 8, wherein the fermented dairy substitute is a fermented into liquid phase suspended aggregates forming a network giving its texture, consistency, and stability.

In view of the foregoing description, the examples, figures and following description, the disclosure also provides aspects and embodiments as set forth in the following Statements (1° to 12°) directly below:

Statement 1° A method of manufacturing an acidic fermented colloidal dispersion or suspension from a pulse selected from the group consisting of chickpea, yellow pea, common bean, and/or fava bean as whole pulses (hulled or de-hulled pulses), as split pulses or as chopped solids thereof with a Dmax of 1 to 4 mm, or a combination thereof, the method comprising subjecting the pulses to
a process in which dry pulses are stirred for at least 30 minutes and preferably between preferably for a period of 1 to 6 hour, more preferably between 1.5 and 4 hours, in the bicarbonate solution or bicarbonate/carbonate solution at a temperature in the range of 40 to 70° C., preferably 55-65° C. or for a short period of 15 to 30 minutes at a temperature in the range of 70° C. to 90° C., preferably 80-90° C.
a process of removing the aqueous bicarbonate salt solution with pulse flavor and off-tones from the pulse seeds or from the pulse seeds and seed coats
optionally a process in which the pulse seeds or the pulse seeds and seed coats are stirred for a short period of 20 minutes to 60 minutes in aqueous solution made of an hydroxide salt (MOH) at a pH above 10, preferably 11 and yet more preferably above 11.5, wherein M is an alkali metal cation and further of removing the aqueous hydroxide salt (MOH) solution.
a process of rinse washing the pulse seeds or pulse seeds and seed coats with water or immersing in water for a short period of 30 minutes to 180 minutes a temperature between 2° and 65° C.
a process of homogenizing the pulse mass from the previous steps with a natural oil and water into an emulsion
a process of fermenting the homogenate with an added vegan ferment culture and optionally a vegan culture starter medium.

Statement 2° A method according to statement 1°, of manufacturing an acidic fermented colloidal dispersions or suspensions from a pulse selected from the group consisting of chickpea (C. arietinum), yellow pea (P. sativum), common bean (P. vulgaris) and fava bean (V. faba), or a combination thereof, the method comprising subjecting the pulses to
a process in which dry pulses are stirred for at least 30 minutes in the bicarbonate solution or bicarbonate/carbonate solution at a temperature in the range of 40 to 70° C., preferably 55-65° C. and the solution has a pH lower than 10 and preferably above 7 or for a short period of 15 to 30 minutes at a temperature in the range of 70° C. to 90° C., preferably 80-90° C. and the solution has a pH lower than 10 and preferably above 7.
a process of removing the aqueous bicarbonate salt solution with pulse flavor and off-tones from the pulse seeds or pulse seeds and seed coats
optionally a process in which the pulse seeds or the pulse seeds and seed coats are immersed (are fully stirred) for a short period of 20 minutes to 60 minutes in aqueous solution made of an hydroxide salt (MOH) at a pH above 10, preferably 11 and yet more preferably above 11.5, wherein M is an alkali metal cation and further of removing the aqueous hydroxide salt (MOH) solution.
a process of rinse washing the pulse seeds or pulse seeds and seed coats with water or immersing in water for a short period of 30 minutes to 180 minutes a temperature between 2° and 65° C.
a process of homogenizing the pulse mass from the previous steps with a natural oil and water into an emulsion
a process of fermenting the homogenate with an added vegan ferment culture and optionally a vegan culture starter medium.

Statements 3° A method according to statement 1° or 2° of manufacturing an acidic fermented colloidal dispersions or suspensions from a pulse selected from the group consisting of chickpea (C. arietinum), yellow pea (P. sativum), common bean (P. vulgaris) and fava bean (V. faba), or a combination thereof, the method comprising subjecting the pulses to
a process in which dry pulses are for a period of time of 20 minutes to 3 hours, preferably for a period of 30 minutes to 3 hours and this at a temperature of 55° C. to 65° C., or for a period in the range of 1 to 12 hours at a low temperature between 40° C. and 60° C. immersed or are fully stirred in aqueous bicarbonate solution or bicarbonate/carbonate solution made of bicarbonate salt (MHCO₃), of bicarbonate salt (MHCO₃) and carbonate salt (M₂CO₃), or of bicarbonate salt (MHCO₃) and hydroxide salt (MOH), wherein M is a an alkali metal cation, and with a pH between pH 7 and 10, preferably a pH between 7.5 and 10.
a process of removing the aqueous bicarbonate salt solution with pulse flavor and off-tones from the pulse seeds or pulse seeds and seed coats
optionally a process in which the pulse seeds or the pulse seeds and seed coats are immersed or are fully stirred for a short period of 20 minutes to 60 minutes in aqueous solution made of an hydroxide salt (MOH) at a pH above 10, preferably 11 and yet more preferably above 11.5, wherein M is an alkali metal cation and further of removing the aqueous hydroxide salt (MOH) solution.
a process of rinse washing the pulse seeds or pulse seeds and seed coats with water or immersing in water for a short period of 30 minutes to 180 minutes a temperature between 2° and 65° C.
a process of homogenizing the pulse mass from the previous steps with a natural oil and water into an emulsion
a process of fermenting the homogenate with an added vegan ferment culture and optionally a vegan culture starter medium.

Statement 4° The method according to any one of statements 1° to 3°, wherein aqueous bicarbonate solution or bicarbonate/carbonate solution is provided with a salt or an oxide of anyone of the bivalent ions of the group consisting of Ca++, Fe++, Mg++, Zn++.

Statements 5° The method according to any one of statements 1° to 4°, wherein the pH of the bicarbonate solution or bicarbonate/carbonate solution or the dose of the bivalent ions in the bicarbonate solution or bicarbonate/carbonate solution is used to regulate the texture of the fermented mass.

Statements 6° The method according to any one of statements 1° to 5°, wherein the vegan ferment starter culture is a lactic acid bacteria (LAB) starter culture and optionally any one fermentation starter culture of the groups consisting of a bifidobacteria, a food yeast and a food mold or combination thereof.

Statements 7° The method according to any one of statements 1° to 6°, wherein the lactic acid bacteria (LAB) is of the group consisting of Lactobacillus acidophilus, Lactobacillus bulgaricus, Lactobacillus casei, Lactobacillus delbrueckii subsp. Bulgaricus, Lactobacillus helveticus, Lactobacillus paracasei, Lactobacillus plantarum, Lactobacillus rhamnosus, Lactococcus lactis (and its subspecies, optionally Lactococcus lactis subsp. Cremoris, Lactococcus lactis subsp. Diacetylactis or Lactococcus lactis subsp. Lactis), Leuconostoc mesenteroide and Streptococcus thermophiles, or a combination thereof.

Statement 8° The method according to any one of statements 1° to 7°, wherein the bifidobacteria is of the group consisting of B. animalis spp. Lactis, B. bifidum, B. lactis and B. breve, or a combination thereof.

Statement 9° The method according to any one of statements 1° to 8°, wherein the food yeast is Saccharomyces cerevisiae.

Statement 10° The method according to any one of statements 1° to 9°, wherein the food mold is Aspergillus oryzae.

Statement 11° The method according to any one of statements 1° to 10°, wherein the aqueous bicarbonate solution or bicarbonate/carbonate solution comprising additionally CaCl₂ to prevent or inhibit material loss from the pulses under treatment in the solution.

Statement 12° A fermented vegan food, manufactured by any one of statements 1° to 11°.

In view of the foregoing description, the examples, figures and following description, the disclosure also provides aspects and statements as set forth in the following Statements (1^{#} to 9^{#}) directly below:

Statement 1^{#} A method for eliminating or substantially diminishing off-flavor of Fabaceae pulses, in particular pulses selected from the group consisting of chickpea, yellow pea, common bean, and/or fava bean as whole pulses (hulled or de-hulled pulses), as split pulses or as chopped solids thereof with a Dmax of 1 to 4 mm, or a combination thereof, the method comprising subjecting the pulses to
a process in which dry pulses are stirred for at least 30 minutes, preferably for a period of 1 to 6 hours, more preferably between 1.5 and 4 hours in the bicarbonate solution or bicarbonate/carbonate solution at a temperature in the range of 40 to 70° C., preferably 55-65° C. or for a short period of 15 to 30 minutes at a temperature in the range of 70° C. to 90° C., preferably 80-90° C.
a process of removing the aqueous bicarbonate salt solution with pulse flavor and off-tones from the pulse seeds or from the pulse seeds and seed coats.
optionally a process in which the pulse seeds or the pulse seeds and seed coats are fully stirred for a short period of 20 minutes to 60 minutes in aqueous solution made of an hydroxide salt (MOH) at a pH above 10, preferably 11 and yet more preferably above 11.5, wherein M is an alkali metal cation and further of removing the aqueous hydroxide salt (MOH) solution.
a process of rinse washing the pulse seeds or the pulse seeds and seed coats with water or immersing in water for a short period of 30 minutes to 180 minutes a temperature between 2° and 65° C. or for a short period of 15 to 30 minutes at a temperature in the range of 70° C. to 90° C., preferably 80-90° C.

Statement 2^{#} Method according to statement 1^{#}, wherein aqueous bicarbonate solution or bicarbonate/carbonate solution is provided with a salt or an oxide of anyone of the bivalent ions of the group consisting of Ca⁺⁺, Fe⁺⁺, Mg⁺⁺, Zn⁺⁺.

Statement 3^{#} Method according to any one of statements 1^{#} to 2^{#}, further comprising partial enzymatic digestion of the pulse material, for instance, by an enzyme of the group consisting of a cellulase, an amylase, a protease and/or a peptidase.

Statement 4^{#} Method according to any one of statements 1^{#} to 3^{#}, further comprising a process of homogenizing the pulse mass from the previous steps with a watery solution into a colloidal dispersion.

Statement 5^{#} Method according to any one of statements 1^{#} to 3^{#}, further comprising a process of homogenizing the pulse mass from the previous steps with a natural oil and water into an emulsion.

Statement 6^{#} Method according to any one of statements 1V to 5^{#}, further comprising a process of fermenting the homogenate with an added vegan ferment culture and optionally a vegan culture starter medium.

Statement 7^{#} Method according to any one of statements 1^{#} to 6^{#}, further comprising a process of homogenizing the pulse mass from the previous steps in a beverage, a cheese analogue, a yogurt analogue.

Statement 8^{#} Method according to any one of statements 1^{#} to 5^{#}, further comprising a process of coagulating with a coagulant and separating a protein fraction from the watery solution.

Statement 9^{#} Method according to any one of statements 1^{#} to 3^{#}, further comprising a process of drying the pulse material, a process of dry milling and air classification protein/fiber rich and a starch rich fraction.

Statement 10^{#} Method according to statement 9^{#}, further comprising electrostatic separations of the protein/fiber fraction into a fiber rich and a protein rich fraction.

In view of the foregoing description, the Examples, Figures and following description, the disclosure also provides aspects and statements as set forth in the following Statements (1^{##} to 15^{##}) directly below:

Statement 1^{##} A method for preparing food or feed ingredient with improved properties, the method comprising subjecting Fabaceae pulses, in particular, pulses selected from the group consisting of chickpea, yellow pea, common bean, and/or fava bean as whole pulses (hulled or de-hulled pulses), as split pulses or as chopped solids thereof with a Dmax of 1 to 4 mm, or a combination thereof, to
a process in which dry pulses are stirred for at least 30 minutes, preferably for a period of 1 to 6 hour, more preferably between 1.5 and 4 hours, in the bicarbonate solution or bicarbonate/carbonate solution at a temperature in the range of 40 to 70° C., preferably 55-65° C. or for a short period of 15 to 30 minutes at a temperature in the range of 70° C. to 90° C., preferably 80-90° C.
a process of removing the aqueous bicarbonate salt solution with pulse flavor and off-tones from the pulse seeds or from the pulse seeds and seed coats.
optionally a process in which the pulse seeds or the pulse seeds and seed coats are stirred for a short period of 20 minutes to 60 minutes in aqueous solution made of an hydroxide salt (MOH) at a pH above 10, preferably 11 and yet more preferably above 11.5, wherein M is an alkali metal cation and further of removing the aqueous hydroxide salt (MOH) solution.
a process of rinse washing the pulse seeds or the pulse seeds and seed coats with water or immersing in water for a short period of 30 minutes to 180 minutes a temperature between 2° and 65° C. or for a short period of 15 to 30 minutes at a temperature in the range of 70° C. to 90° C., preferably 80-90° C.

Statement 2^{##} Method according to statement 1^{##}, wherein aqueous bicarbonate solution or bicarbonate/carbonate solution is provided with a salt or an oxide of anyone of the bivalent ions of the group consisting of Ca⁺⁺, Fe⁺⁺, Mg⁺⁺, Zn⁺⁺.

Statement 3^{##} The method according to statement 1^{##} or 2^{##}, further comprising drying the bicarbonate modified pulse material.

Statement 4^{##} The method according to any of statements 1^{##} to 3^{##}, wherein the improved property is elimination off-flavor.

Statement 5^{##} The method according to any of statements 1^{##} to 3^{##}, wherein the improved property is reduced pulse flavor.

Statement 6^{##} The method according to any of statements 1^{##} to 3^{##}, wherein the improved property is stabilization of colloid dispersion in a watery solution of fat globules, solid particles and/or gas in a watery solution.

Statement 7^{##} The method according to any of statements 1^{##} to 3^{##}, wherein the improved property is improving texture, taste, mouthfeel or viscosity.

Statement 8^{##} The method according to any of statements 1^{##} to 3^{##}, wherein the improved property is increasing smoothness.

Statement 9^{##} The method according to any of statements 1^{##} to 3^{##}, wherein the improved property is increased gel-like structure with increased water binding, decreased viscosity, increased creaminess, decreased pulse flavor, decreased syneresis, increased smoothness, decreased astringency or decreased beany taste.

Statement 10^{##} The method according to any of statements 1^{##} to 9^{##}, comprising partial enzymatic digestion of the pulse material, for instance, by an enzyme of the group consisting of a cellulase, an amylase, a protease and/or a peptidase.

Statement 11^{##} The method according to any of statements 1^{##} to 9^{##}, comprising partial enzymatic digestion of the pulse material, for instance, by an enzyme of the group consisting of a cellulose an alpha-amylase, a gluco-amylase, a serine protease, a cysteine protease, sulfhydryl protease, an endopeptidase and exopeptidase or a mixture thereof.

Statement 12^{##} The method according to any of statements 1^{##} to 11^{##}, further comprising mixing the bicarbonate modified pulse material with a lipid, oil or butter and optionally other food or food ingredients into a colloidal dispersion.

Statement 13^{##} The method according to any of statements 1^{##} to 11^{##}, further comprising mixing the bicarbonate modified pulse material with a lipid, oil or butter and optionally other food or food ingredients into an emulsion.

Statement 14^{##} The method according to any of statements 1^{##} to 13^{##}, wherein the improved property is a stable colloidal dispersion, for instance, emulsion, after acidifying.

Statement 15^{##} The method according to any of statements 1^{##} to 13^{##}, further comprising acidifying the composition with an acid.

Statement 16^{##} The method according to any of statements 1^{##} to 15^{##}, further comprising fermenting the composition with a vegan ferment.

Described is a method to remove off-flavors from starch-protein pulses with >20% starch (e.g., pea, chickpea, fava bean, and/or common bean) while preserving native macronutrient structures for high-purity fractionation to produce neutral-tasting macronutrient fractions (starch, protein, fiber) suitable for use as food ingredients. This method concerns bicarbonate treatment with continuous stirring for 1-6 hours at an elevated temperature of 50-70° C. Only mild heat is applied (50-70° C.) during bicarbonate treatment to facilitate off-flavor removal while preserving starch structure. An additional technical effect on the starch is preservation of the native semi-crystalline structure. This is proven by the Maltese cross visualization. The neutral-tasting macronutrient fractions (starch, protein, fiber) are suitable for use as food ingredients. In a specific operational window (50-75° C. for 1-3.3 hours) off-flavors are successfully removed, and the native, semi-crystalline structure of starch granules is preserved. This is confirmed visually by the persistence of the

“Maltese cross” under polarized light microscopy. The process design allows one to remove embedded flavor compounds without disrupting the delicate molecular organization of starch. The results show that exceeding this window (e.g., 80° C. for 3.3 hours) destroys the Maltese cross and prevents proper separation of intact starch bodies. This preserved structure is what allows for the successful and efficient separation of intact starch bodies from the protein matrix, as shown in the wet milling and sieving experiments.

Provided is a method of processing produce selected from the group consisting of chickpea, yellow pea, common bean, and/or fava bean, or tissues or combinations thereof, the method comprising the steps of: a) continuously stirring the produce or produce tissues for a period between 1 to 6 hours at a temperature between 50° C. and 70° C. in an aqueous bicarbonate solution or bicarbonate/carbonate solution containing 0.5% to 10 weight/weight percent bicarbonate salt; b) removing the solution containing off-flavor compounds from the treated produce or produce tissues; and c) washing the treated produce or produce tissues; wherein the method substantially diminishes off-flavor while preserving the semi-crystalline structure of starch bodies within the produce or produce tissues.

Also provided is a method of processing produce selected from the group consisting of chickpea, yellow pea, common bean, and/or fava bean, or tissues thereof, the method comprising the steps of: a) continuously stirring the produce or produce tissues for a period between 1 to 6 hours at a temperature between 50° C. and 70° C. in an aqueous bicarbonate solution or bicarbonate/carbonate solution containing 0.5% to 10 weight/weight percent bicarbonate salt; b) removing the solution containing off-flavor compounds from the treated produce or produce tissues; and c) washing the treated produce or produce tissues, wherein the treated produce or produce tissues have an average off-tone intensity score of 3.0 or less on a 10-point sensory scale.

Also disclosed is a method of processing produce selected from the group consisting of chickpea, yellow pea, common bean, and/or fava bean, or tissues thereof, the method comprising the steps of: a) continuously stirring the produce or produce tissues for a period between 1 to 6 hours at a temperature between 50° C. and 70° C. in an aqueous bicarbonate solution or bicarbonate/carbonate solution containing 0.5% to 10 weight/weight percent bicarbonate salt; b) removing the solution containing off-flavor compounds from the treated produce or produce tissues; and c) washing the treated produce or produce tissues, wherein the treated produce or produce tissues retain a Maltese cross pattern when viewed under cross-polarized light.

Also provided is a method of processing produce selected from the group consisting of chickpea, yellow pea, common bean, and/or fava bean, or tissues thereof, the method comprising the steps of: a) continuously stirring the produce or produce tissues for a period between 1 to 6 hours at a temperature between 50° C. and 70° C. in an aqueous bicarbonate solution or bicarbonate/carbonate solution containing 0.5% to 10 weight/weight percent bicarbonate salt; b) removing the solution containing off-flavor compounds from the treated produce or produce tissues; and c) washing the treated produce or produce tissues, wherein the treated produce or produce tissues is dried and grinded into a dry flour with a hexanal level below 0.05 μM/g, preferably below 0.005 μM/g.

This method of the disclosure can be in conjunction with the aqueous bicarbonate solution or bicarbonate/carbonate solution comprising bicarbonate salt (MHCO₃), or bicarbonate salt (MHCO₃) and carbonate salt (M₂CO₃) or bicarbonate salt (MHCO₃) and hydroxide salt (MOH)), wherein M is an alkali metal cation, and with a pH between pH 7 and 10, preferably a pH between 7.5 and 10.

This method disclosed herein can be also used in conjunction with the aqueous bicarbonate solution or bicarbonate/carbonate solution comprising bicarbonate salt (MHCO₃), or bicarbonate salt (MHCO₃) and carbonate salt (M₂CO₃), or bicarbonate salt (MHCO₃) and hydroxide salt (MOH), wherein M is an alkali metal cation, and with a pH between pH 7 and 10, preferably a pH between 7.5 and 10.

Also provided a method of processing produce selected from the group consisting of chickpea, yellow pea, common bean, and/or fava bean, or tissues or combinations thereof, wherein the aqueous bicarbonate solution or aqueous bicarbonate/carbonate solution comprises 0.5 to 5% bicarbonate salt (MHCO₃) wherein M is an alkali metal cation and optionally pH is adjusted by a hydroxide salt (MOH), wherein M is an alkali metal cation.

Also provided is a method of processing produce selected from the group consisting of chickpea, yellow pea, common bean, and/or fava bean, or tissues thereof, wherein the solution is a carbonic acid-bicarbonate-carbonate system comprising sodium bicarbonate (Na⁺HCO₃⁻) or sodium carbonate (Na₂CO₃) or a combination thereof or comprising KHCO₃ or K₂CO₃ or a combination thereof and when comprising base that this is a hydroxide, of the group consisting of sodium hydroxide, potassium hydroxide, calcium hydroxide and magnesium hydroxide.

Also provided is a method of processing produce selected from the group consisting of chickpea, yellow pea, common bean, and/or fava bean, or tissues thereof, wherein the produce or produce tissue is stirred for at least 30 minutes in the bicarbonate solution or bicarbonate/carbonate solution at a temperature in the range of 55-65° C.

Also provided is a method of processing produce selected from the group consisting of chickpea, yellow pea, common bean, and/or fava bean, or tissues thereof, wherein aqueous bicarbonate solution or bicarbonate/carbonate solution is provided with a salt or an oxide of anyone of the bivalent ions of the group consisting of Ca⁺⁺, Fe⁺⁺, Mg⁺⁺, and Zn⁺⁺.

Also provided is a method of processing produce selected from the group consisting of chickpea, yellow pea, common bean, and/or fava bean, or tissues thereof, wherein the produce are present as whole pulses (hulled or de-hulled pulses), as split pulses or as chopped solids thereof with a Dmax of 1 to 4 mm, or a combination thereof.

Some of the techniques described herein may be embodied as further comprising grinding the washed produce or produce tissues to release starch bodies, protein bodies, and fibers into a wet flour mixture and by further using the described method of treating the protein starch pulses such chickpea, yellow pea, common bean, and/or fava bean, or tissues thereof to release starch bodies, protein bodies, and fibers into a wet flour mixture it is also possible that the released starch bodies, protein bodies, and fibers into a wet flour mixture are further separated in a starch-enriched fraction from a protein-and-fiber-enriched fraction.

Some of the techniques described herein may be embodied as further comprising grinding the washed produce or produce tissues to release starch bodies, protein bodies, and fibers into a wet flour mixture and by further using the method of treating the protein starch pulses such as chickpea, yellow pea, common bean, and/or fava bean, or tissues thereof to release starch bodies, protein bodies, and fibers into a wet flour mixture it is also possible to further separate the released starch bodies, protein bodies, and fibers in a starch-enriched fraction from a protein-and-fiber-enriched fraction.

Some of the techniques described herein may be embodied as further comprising grinding the washed produce or produce tissues to release starch bodies, protein bodies, and fibers into a wet flour mixture and by further using the described method of treating the protein starch pulses such chickpea, yellow pea, common bean, and/or fava bean, or tissues thereof to release starch bodies, protein bodies, and fibers into a wet flour mixture it is also possible to further separate a starch-enriched fraction from a protein-and-fiber-enriched fraction wherein 1) fractions with increased starch and fractions with increased protein and fiber or 2) fractions with increased starch and fractions with increased protein and fractions with increased fiber are separated from wet flour or suspension by collecting particles on different mesh sieves of a sieve shaker or by precipitation, filtration, coagulation, flocculation, centrifugation.

In a further embodiment of the disclosure, the present processed produce selected from the group consisting of chickpea, yellow pea, common bean, and/or fava bean, or tissues thereof is after washing as a wet produce or tissue thereof further grinded to release starch bodies, protein bodies, and fibers into a wet flour mixture and further the starch-enriched fraction is separated from a protein-and-fiber-enriched fraction wherein 1) fractions with increased starch and fractions with increased protein and fiber or 2) fractions with increased starch and fractions with increased protein and fractions with increased fiber are separated from wet flour or suspension by collecting particles on different mesh sieves of a sieve shaker or by precipitation, filtration, coagulation, flocculation, centrifugation and wherein the method further comprising wet milling and/or wet grinding and/or homogenizing the fractions into smaller particle size ingredients (such as by pulverizing starch bodies).

Also provided is a method of processing produce selected from the group consisting of chickpea, yellow pea, common bean, and/or fava bean, or tissues thereof of the disclosure further comprises drying the washed produce/produce tissue and subsequently milling it to release starch bodies, protein bodies, and fibers into a dry flour mixture. These fractions can be furthermore grinded into smaller particle size ingredients (such as by pulverizing starch bodies).

Also provided is a method of processing produce selected from the group consisting of chickpea, yellow pea, common bean, and/or fava bean, or tissues thereof of the disclosure further comprises drying the washed produce or produce tissue and subsequently milling it to release starch bodies, protein bodies, and fibers into a dry flour mixture wherein 1) particle fractions with increased starch and particle fractions with increased protein and fiber or 2) fractions with increased starch and fractions with increased protein and fractions with increased fiber are separated from dry flour. These fractions can be furthermore grinded into smaller particle size ingredients (such as by pulverizing starch bodies).

Also provided is a method of processing produce selected from the group consisting of chickpea, yellow pea, common bean, and/or fava bean, or tissues thereof of the disclosure further comprises drying the washed produce or produce tissue and subsequently milling it to release starch bodies, protein bodies, and fibers into a dry flour mixture wherein the dry flour is flow in an air stream through a series sieve with decreased mesh following larger mesh to capture fractions with different particle sizes and different starch, protein and/or fiber content or wherein particle fractions with increased starch and particle fractions with increased protein and fiber are separated from dry flour by air classification into a protein/fiber rich and a starch rich fraction. These fractions can be furthermore grinded into smaller particle size ingredients (such as by pulverizing starch bodies).

In view of the foregoing description, the Examples, Figures and following description, the disclosure also provides aspects and statements as set forth in the following Statements (1** to 23**) directly below:

Statement 1** A method of producing macronutrients fractions from a non-animal multicellular natural produce or produce tissue while eliminating or substantially diminishing off-flavor accompanying fragrance, flavors and/or contaminants, wherein the method comprises 1) stirring the produce or produce tissues in for at least 30 minutes in an aqueous bicarbonate solution or bicarbonate/carbonate solution at a concentration and temperature to preserve structures formed by cells and intercellular material while removing contaminants and/or off-notes molecules, 2) removing the solutions with off-flavor accompanying fragrance, flavor and/or contaminants, 3) washing the multicellular produce or produce tissue, 4) or i) grounding the cell wall and intercellular material of the produce to release starch bodies, protein bodies and fibers into a wet flour mixture or ii) drying the produce or produce tissue and milling the cell wall and intercellular material of the produce to release starch bodies, protein bodies and fibers into a dry flour mixture 5) or i) removing the starch bodies based on their distinct size, shape, or density or ii) separating the particles of distinct size, shape, or density to concentrate macronutrient.

Statement 2** The method according to statement 1**, wherein fractions with increased starch and fractions with increased protein and fiber or fractions with increased starch, fractions with increased protein and fractions with increased fiber are separated from wet flour by collecting particles on different mesh sieves of a sieve shaker.

Statement 3** The method according to statement 1**, wherein particle fractions with increased starch and particle fractions with increased protein and fiber is separated from dry flour by air classification into a protein/fiber rich and a starch rich fraction.

Statement 4** The method according to statement 1**, wherein the dry flour is flow in an air stream through a series sieves with decreased mesh following lager mesh to capture fractions with different particle sizes and different starch, protein and/or fiber content.

Statement 4** The method of producing macronutrients fractions according to any one of statements 1** to 4**, wherein the method further comprising drying and/or grinding the fractions into smaller particle size ingredients (such as by pulverizing starch bodies)

Statement 5** The method according to any one of statements 1** to 5**, wherein the aqueous bicarbonate solution or bicarbonate/carbonate solution made of bicarbonate salt (MHCO₃), of bicarbonate salt (MHCO₃) and carbonate salt (M₂CO₃), or of bicarbonate salt (MHCO₃) and with a pH between pH 7 and 10, preferably a pH between 7.5 and 10.

Statement 6** The method according to any one of statements 1** to 5**, wherein the aqueous bicarbonate solution or bicarbonate/carbonate solution made of bicarbonate salt (MHCO₃), of bicarbonate salt (MHCO₃) and carbonate salt (M₂CO₃), or of bicarbonate salt (MHCO₃) and hydroxide salt (MOH), wherein M is an alkali metal cation, and with a pH between pH 7 and 10, preferably a pH between 7.5 and 10.

Statement 7** The method according to any one of statements 1** to 7**, wherein the bicarbonate solution or bicarbonate/carbonate solution is formed by aqueous 0.5 to 5% bicarbonate salt (MHCO₃) wherein M is an alkali metal cation and optionally pH is adjusted by a hydroxide salt (MOH), wherein M is a an alkali metal cation.

Statement 9** The method according to any one of statements 1** to 7**, wherein the solution comprising sodium bicarbonate (Na⁺HCO₃⁻) and or sodium carbonate (Na₂CO₃) or a combination thereof or wherein that that the carbonic acid-bicarbonate-carbonate system by a solution comprising potassium bicarbonate (KHCO₃) or potassium carbonate (K₂CO₃) or a combination thereof and when a base is used that this is alkali metal hydroxide, the alkalis being of the group consisting of sodium hydroxide, potassium hydroxide, calcium hydroxide and magnesium hydroxide.

Statement 10** The method according to any one of statements 1** to 9**, wherein non-animal multicellular produce or produce tissue is submersed or immersed for at least 30 minutes in the bicarbonate solution or bicarbonate/carbonate solution at a temperature in the range of 40 to 70° C., preferably 55-65° C. or for a short period of 15 to 30 minutes at a temperature in the range of 70° C. to 90° C., preferably 80-90° C.

Statement 11** The method according to any one of statements 1** to 9**, wherein non-animal multicellular produce or produce tissue is submersed or immersed for a period of time of 20 minutes to 3 hours, preferably for a period of 30 minutes to 3 hours and this at a temperature of 55° C. to 65° C., or for a period in the range of 1 to 12 hours at a low temperature between 40° C. and 60° C. or for a short period of 15 to 30 minutes at a temperature in the range of 70° C. to 90° C.

Statement 12** The method according to any one of statements 1** to 11**, wherein non-animal multicellular produce or produce tissue is additionally immersed or fully submersed for a short period of 20 minutes to 60 minutes in aqueous solution made of an hydroxide salt (MOH) at a pH above 10, preferably 11 and yet more preferably above 11.5, wherein M is an alkali metal cation and further of removing the aqueous hydroxide salt (MOH) solution.

Statement 13** The method according to any one of statements 1* to 12**, wherein the washing is rinse washing with water or immersing in water for a short period of 30 minutes to 180 minutes a temperature between 2° and 65° C. or for a short period of 15 to 30 minutes at a temperature in the range of 70° C. to 90° C., preferably 80-90° C.

Statement 14** The method according to any one of statements 1* to 13**, wherein aqueous bicarbonate solution or bicarbonate/carbonate solution is provided with a salt or an oxide of anyone of the bivalent ions of the group consisting of Ca⁺⁺, Fe⁺⁺, Mg⁺⁺, Zn⁺⁺.

Statement 15** The method according to any one of statements 1* to 14**, wherein the non-animal natural multicellular produce are of the group consisting of mushrooms, rigid cellular structures vegetables, pulses, root vegetables, mushrooms, and brown algae and red algae.

Statement 16** The method according to any one of statements 1* to 14**, wherein the non-animal natural produce are Fabaceae pulses, in particular pulses selected from the group consisting of chickpea (C. arietinum), yellow pea (P. sativum), common bean (P. vulgaris), fava bean (V. faba) as whole pulses (hulled or de-hulled pulses), as split pulses or as chopped solids thereof with a Feret diameter (Dmax) of 1 to 4 mm, or a combination thereof.

Statement 17** The method according to any one of statements 1* to 16**, wherein the stirring is carried out while mixing.

Statement 18** The method according to any one of statements 1* to 17**, for preparing food or feed ingredient with improved properties, wherein the improved property is elimination of off-flavor accompanying fragrance, flavor and small molecule contaminant.

Statement 19** The method according to any one of statements 1* to 17** for preparing food or feed ingredient with improved properties, wherein the improved property is reduced flavor.

Statement 20** The method according to any one of statements 1* to 17**, for preparing food or feed ingredient with improved properties, wherein the improved property is stabilization of colloid dispersion in a watery solution of fat globules, solid particles and/or gas in a watery solution.

Statement 21** The method according to any one of statements 1* to 17**, for preparing food or feed ingredient with improved properties, wherein the improved property is improving texture, taste, mouthfeel or viscosity.

Statement 22** The method according to any one of statements 1* to 17**, for preparing food or feed ingredient with improved properties, wherein the improved property is increasing smoothness.

Statement 23** The method according to any one of statements 1* to 17**, for preparing food or feed ingredient with improved properties, wherein the improved property is increased gel-like structure with increased water binding, decreased viscosity, increased creaminess, decreased flavor, decreased syneresis, increased smoothness, decreased astringency or decreased off taste.

### BRIEF DESCRIPTION OF THE DRAWINGS

This disclosure will become more fully understood from the detailed description given herein below and the accompanying drawings, which are given by way of illustration only, and thus are not limitative of the disclosure, and wherein:

FIG. 1: a graphic scheme of the example 4 treatments

FIG. 2 is a photographic display of whole chickpeas that went through the process of the BC-BivCa medium treatment (Example 2) and consequently the fermentation treatment with the vegan kefir starter culture fermentation treatment (Example 4)

FIG. 3 is a photographic display of whole chickpeas that went through the process of the BC-BivCa medium treatment (Example 2) and consequently the fermentation treatment with the vegan kefir starter culture fermentation treatment (Example 4).

FIG. 4 is a graphic display of whole pulse chickpeas that were subjected to the BC medium process (Example 1) and consequently the fermentation treatment with the vegan yogurt starter culture fermentation treatment (Example 4).

FIG. 5 is a photographic display of whole yellow pea pulse that has been subjected to the process of the BC-BivCa medium treatment (Example 2) and consequently the fermentation treatment with the vegan kefir starter culture fermentation treatment (Example 4).

FIG. 6 is a graphic display of yellow peas that were subjected to the BC medium process (Example 1) and consequently the fermentation treatment with the vegan kefir starter culture fermentation treatment (Example 4).

FIG. 7 is a graphic display of whole pulse common bean that were subjected to the BC medium process (Example 1) and consequently the fermentation treatment with the vegan kefir starter culture fermentation treatment (Example 4).

FIG. 8 is a photographic display of fava beans that were subjected to the BC medium process (Example 1) and consequently the fermentation treatment with the vegan kefir starter culture fermentation treatment (Example 4).

FIG. 9 is a photographic display of a living ferment chickpea yogurt reconstituted with pasteurized water from an instant powder stored under refrigeration (prepared as in Example 7).

FIG. 10 is a photographic display of chickpeas treated with medium 3.5% sodium bicarbonate (Na⁺HCO₃⁻) (75 gram/1.5 L)+10 gram/1.5 L)+calcium chloride (Ca²⁺Cl₂⁻) (5 gram/1.5 L): pH=7.7, according to Example 8. It displays seed coat, chickpea without seed coat (two cotyledons and embryos attached together but without seed coat) and some split chickpea material.

FIGS. 11A-11C are a graphic display that for the dried products 1-10 whereon FIG. 11A shows the in mouth self-disintegration in on a scale 1-9, FIG. 11B shows the taste intensity in a scale 1-5 and FIG. 11C shows the plant taste tone in a scale 1-5 (see Table 2).

FIG. 12 is a graphic display that displays the solid pulse material recovery after the different treatment conditions of Example 8 (Table 3)

FIGS. 13A-13C provide a microscopic image through lens 40×) in FIG. 13A & 40× in FIG. 13C) of a plant protein concentrate (FIG. 13A) of yellow pea processed from an industrial milling and air classification process and with particle size of <20 μm (passed a 20 μm mesh shaking sieve (FIG. 13B) by brushing with a soft painters brush). This powder was dyed with Lugol (starch dyeing) & copper (II) sulphate (protein dyeing). The black dots (about 10 μm) in the photo are retained damaged starch particles (starch bodies debris) that dyed by Lugol and the blue/greenish dispersed matter (in the photo grey) is the protein matter that dyed with Copper (II) sulphate. The powders had a distinct pea flavor profile with earthy and beany aromas and distinct beany and bitter flavors typically for pea.

FIGS. 14A-14C provide images from a slice dry yellow peas that have been treated by incubation in a bicarbonate solution and in portable freshwater (tap water) by a different steps and conditions as described in Example 10. By this treatment surprisingly, the typical yellow pea beany and bitter flavors were removed to an unrecognizable level (by tasting), while also the cellular structure with storage bodies remained intact as can be seen in FIGS. 14A-14C. This was visualized by cutting yellow peas of the preceding described treatment with a sharp scalpel blade in thin slices. And putting this a Bradford Coomassie brilliant blue G-250 protein-binding dye or a Lugol dye. FIG. 14A provides an histological image yellow pea slice (made with Lens 10×) dyed with the Lugol starch dye and FIG. 14C provides a histological image yellow pea slice (made with Lens 4×) dyed with the Lugol starch dye while FIG. 14B provides a histological image yellow pea slice (made with Lens 10) and dyed with Bradford Coomassie brilliant blue G-250 dye for protein. It nicely shows the undamaged starch storage bodies (black) in FIGS. 14A and 14C that are surrounded by intact protein structures (colored blue in real and grey in this image) as demonstrated in FIG. 14B.

FIGS. 15A-15C show in FIG. 15A a photographic display of two powder fraction of the chickpeas that underwent the treatment according to Example 11-a (the bicarbonate treat chickpeas and their seed coats (FIG. 19) and consequently Example 11-b (freeze drying and initially grinding and pulverizing with hand mortar and consequently grinding by an electric blade grinder KG210 (Delonghi) with grind setting fine “fine” in a cup with a single stainless steel blade). As shown on FIG. 15A the fine meal of a lighter color (fine fraction I in FIG. 15A) that had stuck onto the inner surface of the seal that closed the grinding cup during grinding (fine fraction I in FIG. 15A) colored darker by Lugol (starch dye) dyeing than the coarser meal left on the bottom of the grinding cup after the grinding operation (coarse fraction II in FIG. 15A). The fact fine fraction colored darker by Lugol than the coarser meal (shown in FIG. 15A) was a first indication that starch could enrich in fraction during grinding by an electric blade grinder. In FIG. 15B and in FIG. 15C is provided a microscopic image taken through lens 10× of the microscope. It visualized the undamaged starch bodies and starch bodies clusters by Lugol dye and the protein fraction by Bradford Dye of the fine fraction I (FIG. 15B) and coarse fraction II (FIG. 15C). As demonstrated by the microscopic images (lens 10) of FIG. 15B the starch bodies remained intact during the treatment with the sodium bicarbonate solution after the drying and during the initially grinding and pulverizing with hand mortar and consequently grinding by an electric blade grinder KG210 (Delonghi). In the coarse fraction II (panel C—FIG. 15C coarse fraction II (lens 10), most starch bodies were still in starch particle clusters embedded in protein (Bradford color) some as intact cells. In fine fraction I, there were less starch particles clusters and most were individual intact starch bodies. It can be concluded that after the carbonic acid-bicarbonate-carbonate system treatment and the drying and the pulverizing and grinding, the starch bodies remained intact and could be up-concentrated based on their distinct size, shape, or density. Therefor using this dyeing and microscopic visualization on samples, by combined hand mortar and electric blade grinder, the freeze-dried chickpeas and their seed coat matter were further pulverized and grinded up to all starch clusters were transferred in individual undamaged starch bodies. The microscopic image (lens 10×) with the micrometer scale in FIG. 15B also provides a good indication of the sized of the starch bodies (FIG. 15B fine fraction I (lens 10)) for different mesh sieving.

FIG. 16 provides a microscopic image (lens 40×) of a dry powder fraction obtained by shaker sieve separation according to the method of Example 11-c of chickpeas (cotyledon & embryo) and their seed coats that underwent the carbonic acid-bicarbonate-carbonate system treatment according to Example 11-a. Such dry chickpeas/seed coat powder was loaded in the shaker sieves, which were vibrated by the shaker sieve apparatus at an amplitude 90 under normal ambient atmosphere the starch bodies could not totally been separated from the protein and fibers. FIG. 16 shows the fraction in the 300-μm mesh sieve. These Starch bodies were colored with Lugol dye and protein was colored with Bradford dye were to make images with including of the Objective Micrometer MA285×. 1/100 (0.01 mm) of Meiji Techno Japan at a corresponding microscopic enlargement. It can be observed that meanly single undamaged starch bodies (black spheroid in the photographic image in FIG. 16) but still holding some protein bodies on its surface as shown in FIG. 16 (lens 40× and Bradford/Lugol dyeing). The fact that this starch bodies fraction was found on the 300 μm sieve and no powder passed the 20 μm mesh sieve indicates that gravity was not sufficient to separate the starch bodies from protein and fibers (cell wall fragments and seed coat fragments) in the dry bicarbonate processed chickpea (seed coat, embryo & cotyledon) dry powder. The image also provides the sizes of the starch bodies.

FIGS. 17A and 17B concerns fractioning on a shaker sieve of the moistening of the chickpea powders that has been prepared according to Example 11-d. Namely the bicarbonate processed chickpea (seed coat, embryo & cotyledon) powder was mixed with tap water into a milky fluid. The measured pH of this fluid was 9.05. This milky fluid was consequently loaded on the upper test sieve of a tower Retsch test sieve 0 200×50 mm on top such with the largest mesh size from 5 mm, 1 mm, 500 μm, 300 μm to 20 μm with hereunder a collecting reservoir on a Shaker sieve Retsch AS 200 apparatus (Retsch Germany). When such milky dispersion of chickpeas (embryo & cotyledon)/seed coat powder in the shaker sieves was vibrated by the shaker sieve apparatus at an amplitude 90 under normal ambient atmosphere the protein bodies and fibers (cell wall fragments and seed coat fragments) separated from the starch bodies and these protein bodies and fibers (cell wall fragments and seed coat fragments) was collected on the reservoir under the 20 μm mesh sieve. FIGS. 17A and 17B provide a photographic view of the shaker sieve starch bodies were intercepted on the 20 μm mesh sieve ((X)—FIG. 17A) and protein bodies, protein and fibers were intercepted in the reservoir ((Y)— FIG. 17A). The collected fraction were mixed with Lugol dye. Hereby Lugol in the fraction intercepted on the 20 μm mesh sieve colored the starch bodies (FIG. 17B panel I) but not in the fraction collected in the reservoir under the 20 μm mesh (FIG. 17B panel II). This fraction colored for protein by the Bradford dye (FIG. 17B panel III). This demonstrates that, when the meal is wet or in aqueous fluid, intact starch bodies can be separated from fibers (cell wall fragments and seed coat fragments) and proteins from meals of carbonic acid-bicarbonate-carbonate system processed chickpeas (even with seed coats), by shaker sieving under gravity force and under ambient atmosphere. Evidently, if one want to avoid that protein and starch enriching by this method is affected by the seed coats, one can start with dehulled pulses.

FIGS. 18A and 18B also concern fractioning on a shaker sieve of the moistening of the chickpea powders that has bene prepared according to Example 11-d. FIG. 18A provides a microscopic image (lens 40×) of the fraction that is intercepted on the 20-μm mesh sieve and is colored by Bradford dye and Lugol dye. And in FIG. 18B a microscopic image (lens 40×) is provided of the fraction that passed the 20-μm mesh. There are no starch bodies in this fraction and the protein bodies are shown. They are considerable smaller than starch bodies. Using the microscopic imaging of samples one can optimize the crushing, milling and mesh size of the sieves to optimize the separation.

FIG. 19 shows a photograph of chickpeas (cotyledon & embryo) and their seed coat after the bicarbonate system treatment according to Example 11-a.

FIGS. 20A-20D show a photograph of microscopic images of thin slices of fava beans that were treated with NaHCO₃ solution according to Example 12. These slices were put into Bradford dye or in Lugol dye or in a mixture of Bradford dye+Lugol dye. This images of FIGS. 22A-22C also demonstrate that treatment of fava beans with the sodium bicarbonate solution according to the conditions of Example 12 did not destroy the cellular structure with cell was surrounding the starch bodies and protein bodies. Moreover, based on this observation with a measuring scale, sieves mesh range of the tower of sieves in the sieve shaker apparatus can be adapted.

FIGS. 21A-21D show a photograph of microscopic images of thin slices of chickpeas that were treated with NaHCO₃ solution according to Example 12. These slices were put into Bradford dye or in Lugol dye or in a mixture of Bradford dye+Lugol dye. This images of FIGS. 22A-22C also demonstrate that treatment of chickpeas with the sodium bicarbonate solution according to the conditions of Example 12 did not destroy the cellular structure with cell was surrounding the starch bodies and protein bodies. Moreover, based on this observation with a measuring scale, sieves mesh range of the tower of sieves in the sieve shaker apparatus can be adapted.

FIGS. 22A-22C show a photograph of microscopic images of thin slices of common bean that were treated with NaHCO₃ solution according to Example 12. These slices were put into Bradford dye or in Lugol dye or in a mixture of Bradford dye+Lugol dye. FIG. 22A shows a microscopic image through a lens 10× of a slice of common bean that has been colored with Lugol dye for starch. FIG. 22B shows a microscopic image through a lens 10× of a slice of common bean that has been colored by Bradford dye for protein. And FIG. 22C shows a microscopic image through a lens 40× of a slice of common bean that has been colored with Lugol dye for starch. The images of FIGS. 22A-22C also demonstrate that treatment of common bean with the sodium bicarbonate solution according to the conditions of Example 12 did not destroy the cellular structure with cell was surrounding the starch bodies and protein bodies. Moreover, based on this observation with a measuring scale, sieves mesh range of the tower of sieves in the sieve shaker apparatus can be adapted.

FIG. 23 shows a photograph of microscopic images of thin slices of yellow pea that were treated with NaHCO₃ solution according to Example 12. These slices were put into Bradford dye or in Lugol dye or in a mixture of Bradford dye+Lugol dye. The images of FIGS. 22A-22C also demonstrate that treatment of yellow peas with the sodium bicarbonate solution according to the conditions of Example 12 did not destroy the cellular structure with cell was surrounding the starch bodies and protein bodies. Moreover, based on this observation with a measuring scale, sieves mesh range of the tower of sieves in the sieve shaker apparatus can be adapted.

FIGS. 24A and 24B show a photograph of microscopic images of the according to Example 11-a treated chickpeas that were dried in a drying chamber at 60° C. for 4 hours with heated air circulation within the chamber and air flow according to Example 11-b & Example 11-e. This dried chickpeas and their seed coat matter were directly grinded by an electric blade grinder KG210 (Delonghi) with grind setting “fine” in a cup with a single stainless-steel blade. In FIG. 24A are the starch bodies and some starch bodies clusters microscopically visualized by Lugol dye and the protein fraction that surrenders the starch bodies yet in the clusters are microscopically visualized by Bradford Dye. The image actually demonstrates that whole dry chickpeas (cotyledon and embryo) with seed coat even after treatment sodium bicarbonate solution according to the conditions and method of Example 11-a and after being further dried in a heated air circulation chamber (convection oven), as described in Example 11-a & 11-b, maintain and intact cellular structure with starch bodies and cell bodies, that further can be separated as intact bodies. One can reasonably expect that this will also be the case after the gentler drying condition of fluidized bed drying. FIG. 24A provided a microscopic image through lens 10× and after an intermediate grinding a coloring with Bradford dye for protein. FIG. 24B In contrast is taking of the same sample after further grinding. It is a microscopic image also taken through lens 10× but dyed with Lugol dye for starch. It clearly show more undamaged starch bodies freed from initially surrounding cells wall and protein. Some show signs of damage. They have a size that makes them separable from smaller protein bodies and cell wall debris and seed coat debris. Starting from de-hulled chickpeas one does not have to remove seed coat debris.

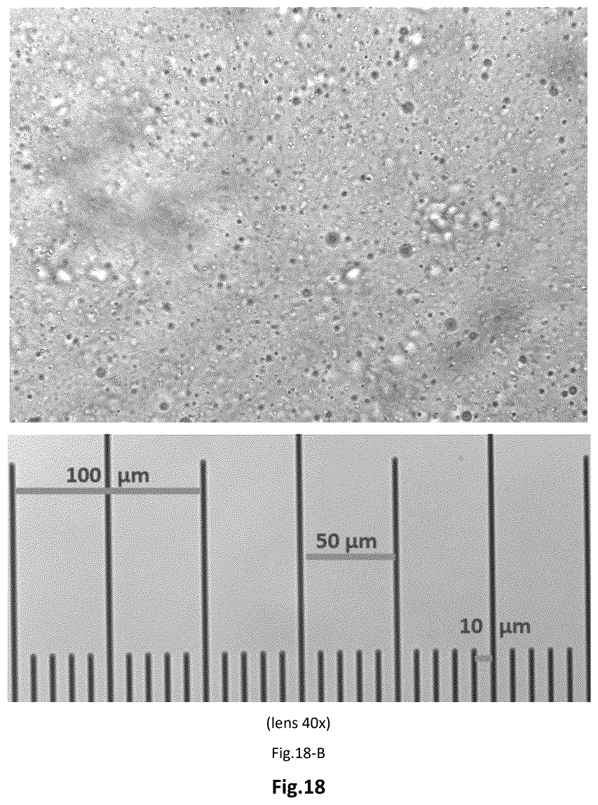

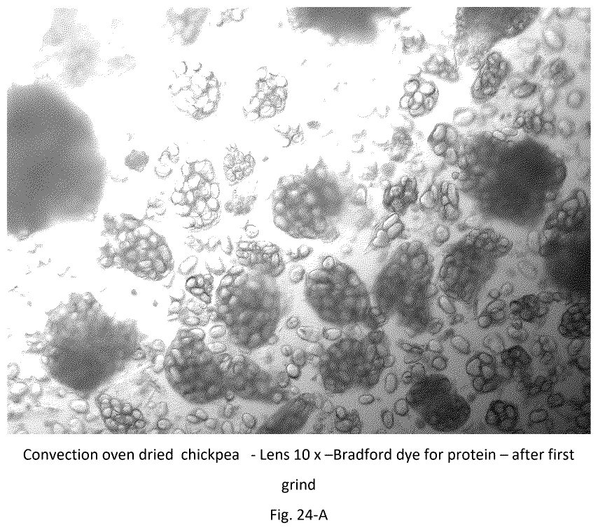

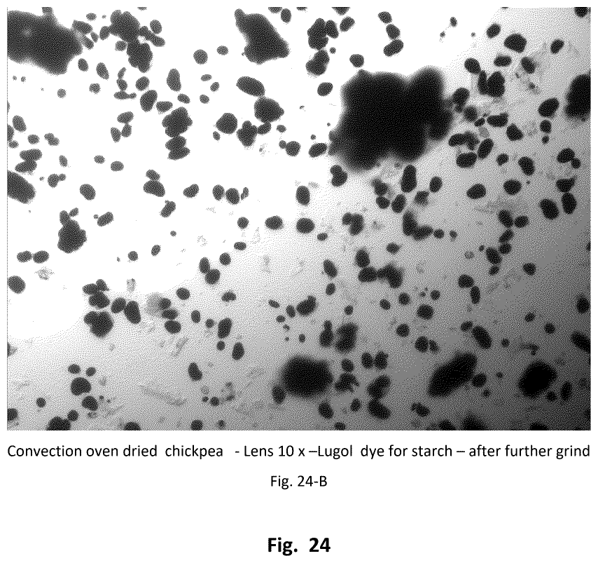

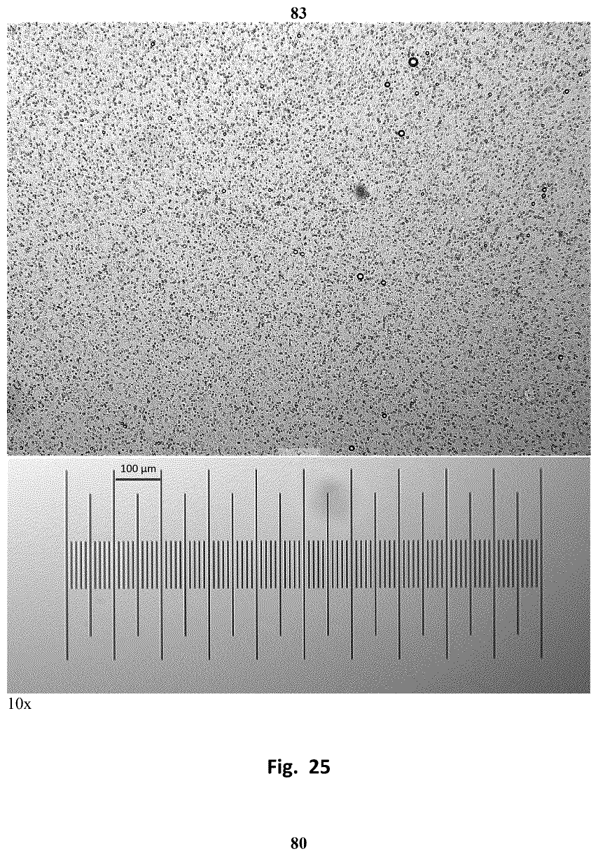

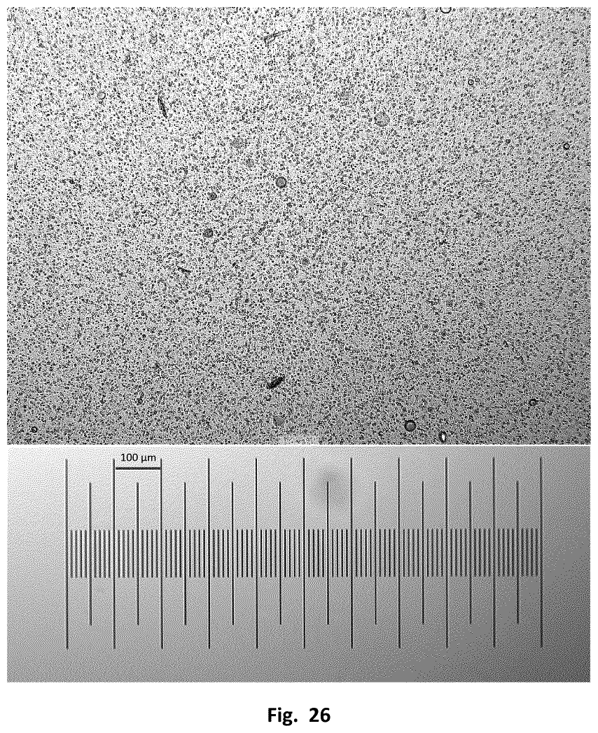

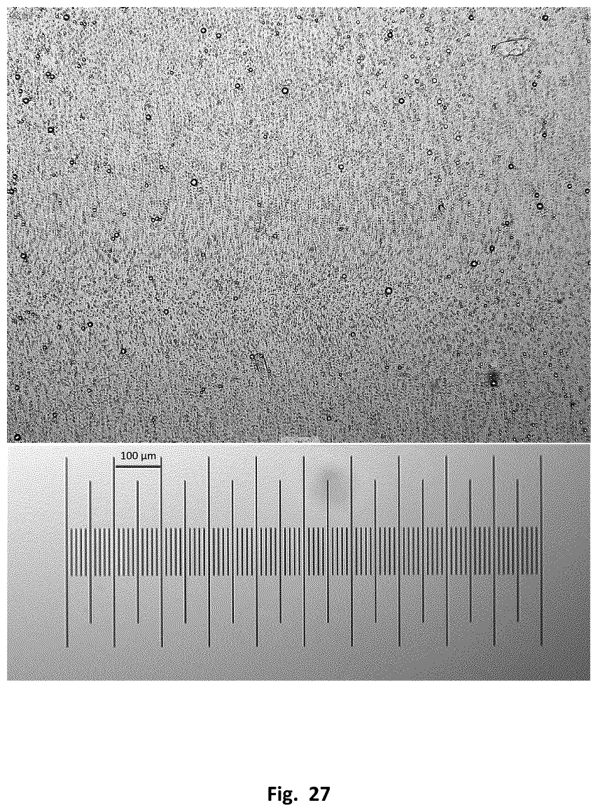

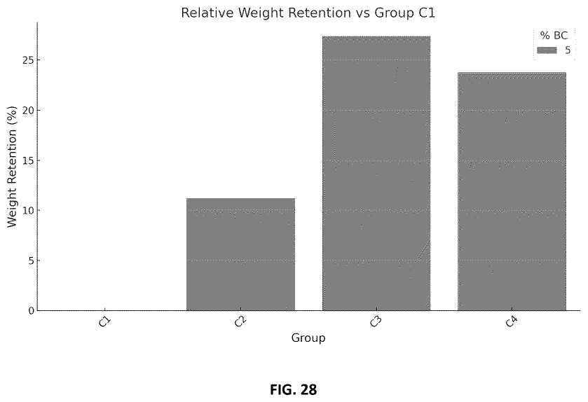

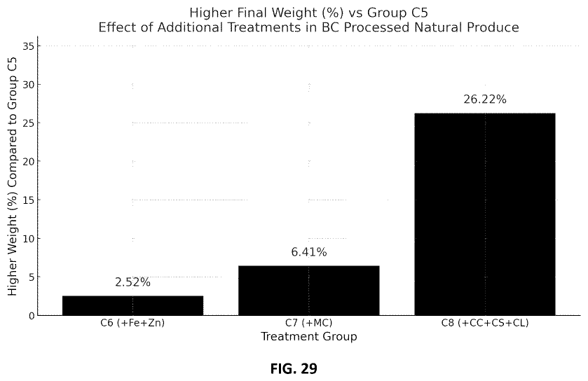

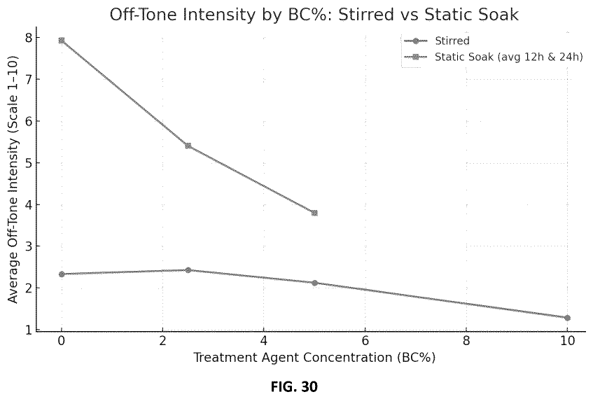

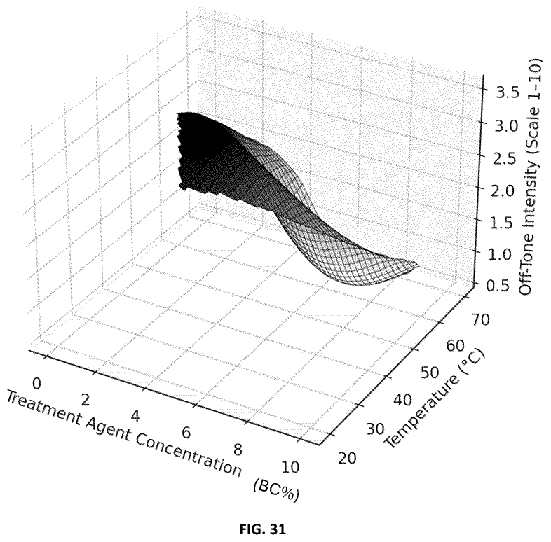

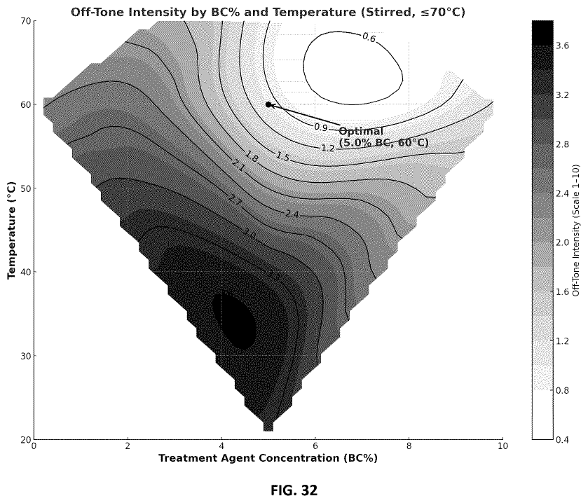

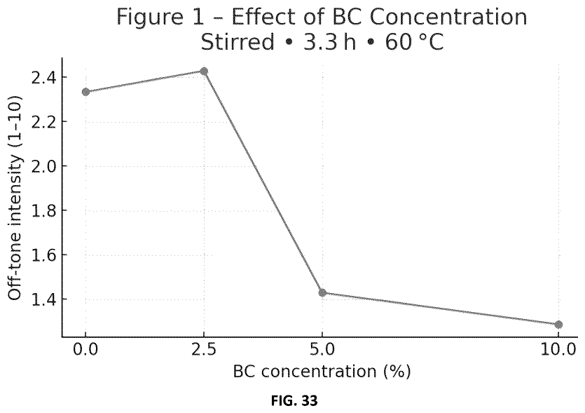

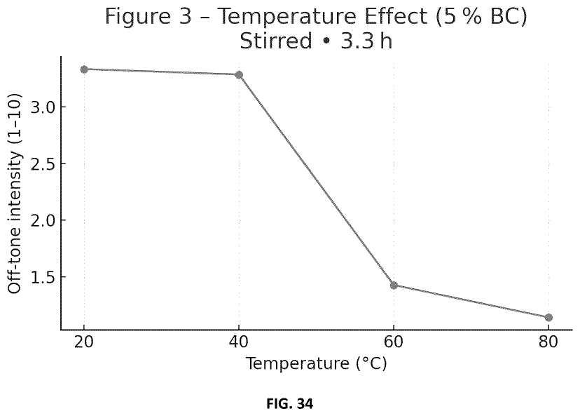

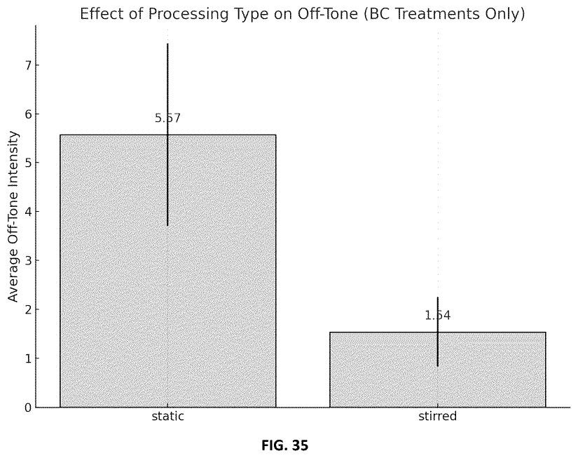

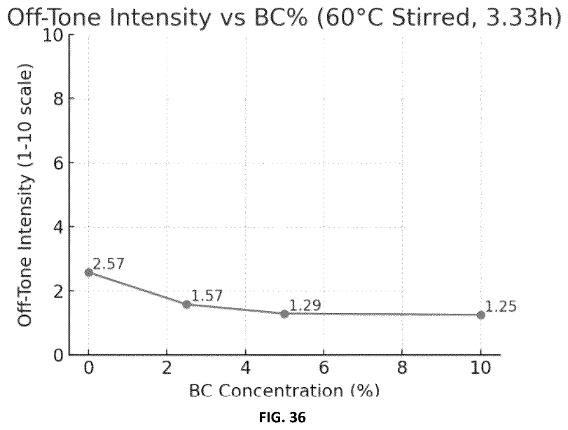

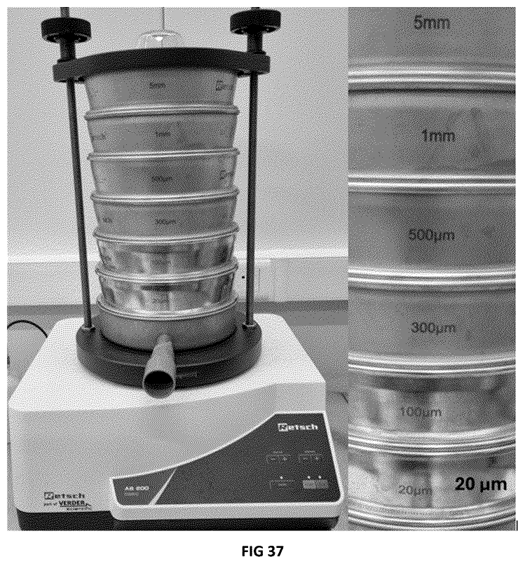

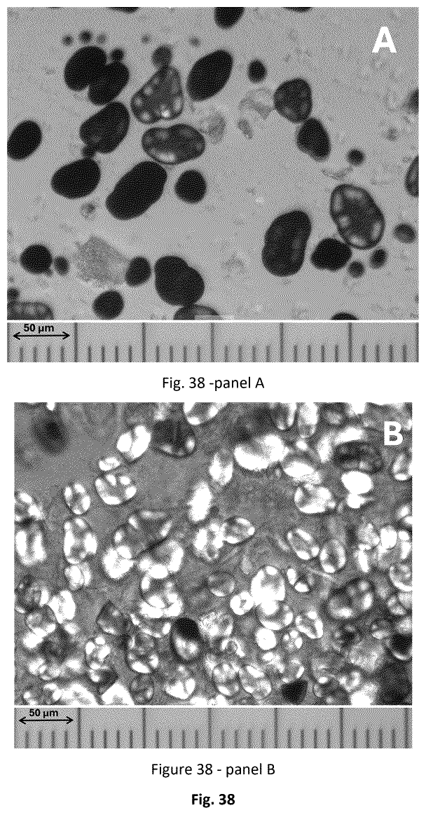

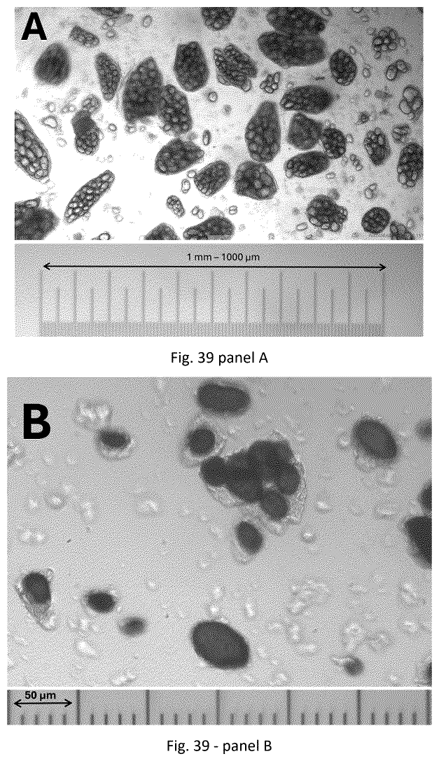

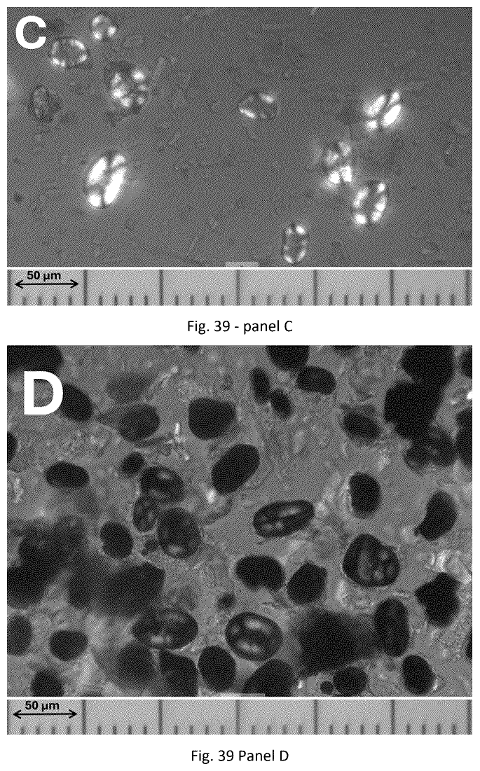

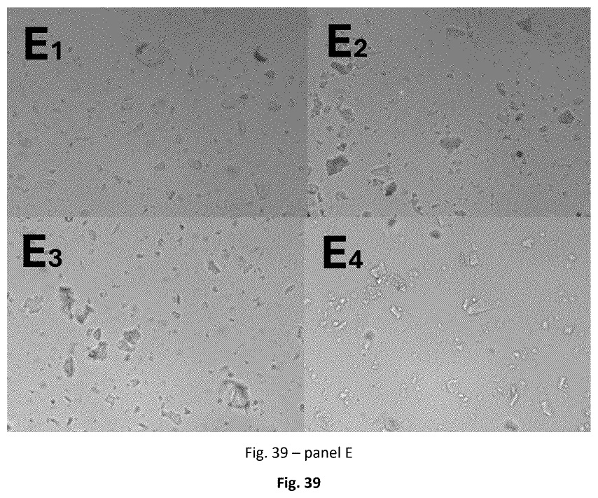

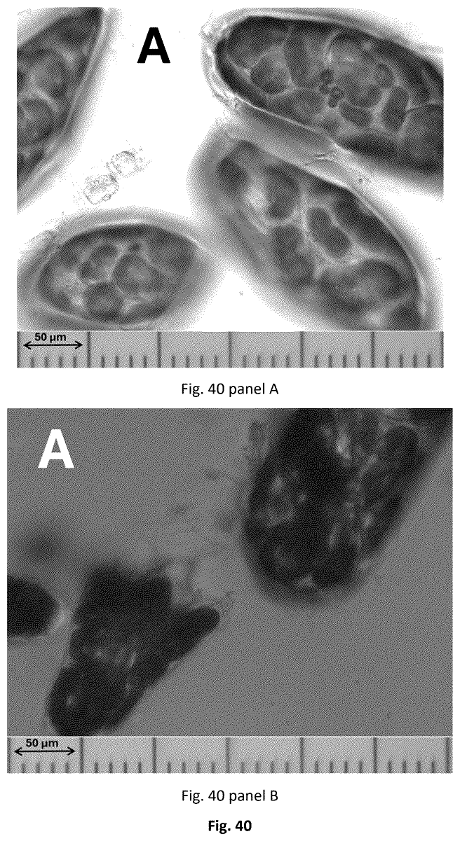

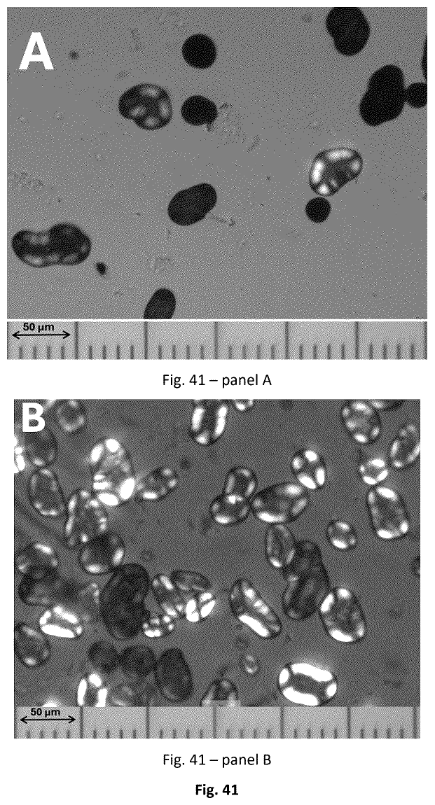

The microscopic images in FIGS. 24A and 24B (convection oven dried chickpea—Lens 10×—Bradford dye for protein—after first grind) demonstrate the heated air circulation dried chickpeas from the aqueous sodium bicarbonate solution treatment according to Example 11-a, have a majority of intact cells and therein starch and protein bodies and can yet be subjected to a grinding process that releases undamaged storage bodies from the cells. In FIGS. 24A and 24B (convention oven dried chickpea—Lens 10×—Lugol dye for starch) after further grind) is shown that the majority of the starch bodies during the grinding process release from the cells and mix with well wall debris and protein bodies. Individual protein bodies are not visible at this enlargement but are shown in FIG. 18B.

FIG. 25 is microscopic image (lens 10×) of an emulsion made from the 83-pea sample (see table 11 A, B & C and example 17) condition (T steam) and where of a droplet was sampled after 24 hour incubation at 20° C.

FIG. 26 is microscopic image (lens 10×) of an emulsion made from the 80-pea sample (see table 11 A, B & C and example 17) condition (T steam) and where of a droplet was sampled after 24-hour incubation at 20° C.

FIG. 27 is microscopic image (lens 10×) of an emulsion made from peas that have been incubated in water as described in example 17 and whereof a droplet was sampled after 24-hour incubation at 20° C.

FIG. 28 referring to table 12, is a graphic display of the weight retention of yellow pea material after the different treatments explained in Example 18. Each treatment group compares to Group C1 in terms of relative weight retention after BC treatment at 80° C. and subsequent washing. Group C1 (baseline) had no added calcium chloride (CC) or calcium sulfate (CS) or calcium chloride (CL). The groups with additional CC or CS or CL (C2 and C3 and C4) show a marked increase in retained weight compared to C1. The salts of the bivalent cation calcium have a protective effect against leaching or material loss during a BC treatment. C3, which had 2% CS, and C4, which had 2% CL, both exhibited significantly higher weight retention. It demonstrates that adding to the sodium bicarbonate (BC) treatment a calcium salts or calcium cation (Ca 2+) bonded to different anions will enhance protection against material loss during heat and stirring treatment. This is particularly suitable if one wants to carry out sodium bicarbonate BC treatment of pea pulses at a higher temperature and under dynamic conditions (continuous stirring of the pea material in the aqueous treatment water).

FIG. 29 referring to table 13, is a graphic display of the weight retention of yellow pea material after the different treatments explained in Example 19. In FIG. 29 and Table 13, Group C8 shows the highest protection against weight loss, demonstrating that salt of the bivalent cation calcium such as calcium sulfate (CaSO₄ (calcium sulfate), calcium lactate, Ca(C₃H₅O₃)₂ (calcium lactate) and calcium chloride, CaCl₂ (calcium chloride) have stabilizing effect that they protect yellow peas against leaching of material in a sodium bicarbonate treatment of the yellow peas in a watery medium at a high temperature of 80°. This with the observation that these against did not have a negative effect on the off-tone removal with sodium bicarbonate makes this an interesting synergistic combination. In group C7, addition of 1% magnesium chloride does also show a meaning full benefit is protecting yellow peas against leaching of material in a sodium bicarbonate treatment of the yellow peas in a watery medium at a high temperature of 80°. In the group C6 addition iron and zinc shows a smaller effect, but at about 30 times dose than the calcium salts. It demonstrates that bivalent ions or salts of bivalent ions are a useful additive in water based off-tone removal in the stirred process with sodium bicarbonate and heating of the watery medium. In the current set up the addition of CC+CS+CL each at 1% (weight/weight percent (w/w %)) offers the strongest protection against material loss during BC treatment and washing. MC also helps, but to a lesser extent. Iron and Zinc offer only mild benefits in terms of weight retention. But these together were added at a dose that was about 30 times less than the 1% dose.

FIG. 30 (referring to Table 14) concerns the off-tone taste panel testing on the dried pea pulse material. It is a graphic that illustrates that the stirred treatments consistently result in lower off-tone intensity across all BC % levels tested. Static soak treatments reduce off-tones as BC % increases, but not as effectively as stirred treatments. The gap between the two processes narrows at higher BC % but remains substantial. This data supports using stirring during treatment for more effective off-tone suppression, especially when cost or sensory quality is critical. Stirred treatments consistently outperform static soak at all tested BC % levels.

FIG. 31 (referring to Table 14) concerns the treated and thereafter dried pea material. It is a graphic that provides a 2D surface of the BC treatment concentration in relation with the temperature on the off-tone intensity scale (1-10). And showing how off-tone intensity changes with BC % and temperature (only (≤70° C. for preventing material loss without use of bivalent cation calcium or a salt thereof) for stirred treatments. Darker areas indicate lower off-tone values. The best BC %-temperature combination under the 70° C. material-loss threshold is a BC %: 5.0% at a temperature: 60° C. as this provides a very low off-tone intensity of 1.0 (neglectable or under the observation threshold). This is an effective zone where treatment is both efficient and within safe temperature limits of preventing material loss.

FIG. 32 (referring to Table 14) is a graphic that provides a grayscale 2D contour plot showing off-tone intensity as a function of BC % and temperature (≤70° C.) under stirred conditions. The darker regions are lower off-tone intensity. The contour lines mark intensity levels to help visually pinpoint optimal zones. The graph and data show a clear inverse relationship between treatment temperature and off-tone intensity in the stirred group. At lower temperatures (20-40° C.), the off-tone intensity remains high (˜3.2-3.3). As temperature increases to 60° C. and 80° C., the off-tone intensity drops sharply to a neglectable level ˜1.78 at 60° C. Raising the treatment temperature in a stirred system significantly improves off-tone reduction. Stirring alone is not sufficient at lower temperatures. Heat enhances the effectiveness of the treatment. A 5.0% BC treatment provided a noticeable benefit on the panel tested dry pulses. While the 10.0% BC treated group provide the optimal tested concentration—best off-tone suppression under stirred conditions. Each 1% increase in BC within this range steadily reduces off-tones. By 9%, the predicted off-tone is close to 1.45, approaching the 1.29 value observed at 10%. This suggests that a 8-9% BC could potentially offer near-optimal performance while saving on ingredient use compared to 10%.

FIG. 33 (referring to table 14) concerns off-tone intensity vs. BC concentration under a constant stirred treatment (3.33 h at 60° C.) on the dry tested pea pulse material. Higher BC doses clearly reduce off-flavor intensity in the dried product. The average off-tone score (on a 1-10 scale) drops from about 2.33 with no BC to ˜1.86 at 5% BC, and further down to ˜1.29 at 10% BC. This trend demonstrates that adding BC during treatment markedly diminishes the perceived off-tone intensity, even when starting from an already low baseline (stirring+heat alone gives a slight off-tone around 2.3). In other words, BC has a strong suppressing effect on off-flavors, with higher concentrations yielding progressively milder off-tones. To quantify the impact: under identical stirring and heating conditions (60° C. for ˜3.3 h), no BC resulted in a moderate-slight off-tone intensity (˜2.3/10, with some panelists scoring higher). Adding 5% BC brought the average off-tone down to ˜1.9 (a ˜20% reduction), and at 10% BC the off-tone was about ˜1.3 (nearly half the intensity of the no-BC sample). This indicates a dose-dependent improvement: more BC correlates with lower off-tone intensity. The panel data show that with sufficient BC, off-flavors can be minimized to the “nil-slight” range (scores ˜1-2), whereas without BC the off-tone remained slightly higher (in the “slight” intensity range). In summary, BC treatment is effective in reducing off-notes, and higher BC levels produce a stronger reduction in off-tone intensity. This is very important if the dry material will be fractionated, which concentrates or isolates the separate macronutrients for further processing in diverse food forms, and these may not have the usual pulse tastes or off-tones.

FIG. 34 (referring to Table 14): Effect of treatment temperature on off-tone intensity for a fixed BC dose (5% BC, stirred, ˜3.3 h). Off-tone scores are dramatically lower at elevated temperatures around 60° C., while little additional benefit is seen at higher temps. At 20-40° C., the BC treatment had only a modest effect (off-tone ˜3.3, still in the slight-moderate range). Once the temperature reached ˜60° C., the off-tone intensity dropped sharply to ˜1.0 (essentially no off-flavor). Increasing to 80° C. did not significantly improve this (off-tone ˜1.14, very similar to 60° C.). This indicates that about 60° C. is sufficient to activate the BC treatment to its full potential—higher temperatures (up to 75-80° C.) yield no major additional reduction in off-tone intensity.

FIG. 35 (referring to Table 15 and Example 20) concerns the wet pea material (samples A-V— Example 20) that were not dried before off tone testing. The bar chart shows the impact of processing type on off-tone intensity for BC-treated samples. Stirred treatments result in a much lower off tone (avg. ˜1.54). Static soak treatments show significantly higher off-tone (avg. ˜5.57). Error bars reflect variability: stirring also produces more consistent results. Continuous stirring during BC treatment yields a substantially better off-tone profile compared to static soaking-both in terms of average intensity and consistency.

FIG. 36 (referring to Table 15—Example 20) concerns the wet pea material off tone testing. It is a graphic that shows the off-tone intensity vs. BC concentration for a fixed treatment (stirred, 60° C. for 3.33 h). Off-tone intensity drops markedly when BC is added, leveling off at higher BC doses. Of-tones of ˜1.57 to ˜1.35 level from barely detectable to not detectable.

The dataset (FIG. 36, Table 15 of Example 20 treatments) shows a clear reduction in off-tone intensity (rated on a 1-10 scale) when BC is present, compared to when no BC is used. In a controlled series of experiments at 60° C. with stirring for 3.33 h (and no other additives), increasing the BC concentration from 0% to 10% lowered the average off-tone score from about 2.57 (no BC) down to 1.25 (10% BC), as illustrated above. In fact, any addition of BC tended to reduce off-flavor intensity. Across all trials, runs without BC had much higher off-tone ratings on average (median ˜8.3) than runs with BC (median ˜1.3). This indicates that incorporating BC into the treatment greatly diminishes off-tone intensity, suggesting BC is effective at suppressing the undesirable off-taste.

FIG. 37 shows the Retsch AS 2000 shaker sieve installation (Verder Scientific, BE) on which the wet grinded pea material of a treatment condition (Table 16) is loaded on its sieve tower shown in the photograph. The bottom shaker sieve has a mesh size of 20 μm. This shaker sieve was for every wet grinded pea material sample operated for 5 minutes at an amplitude of 90. For the microscopic evaluation to the fraction on top of the 20 μm mesh sieve and under the 20 μm mesh sieve was collected.

FIGS. 38A and 38B (referring to Example 21 and Table 16) are a microscopic photo made through the lens 40×/0.65 IOS N-Plan filter Pea material treated according to Group 1 (table 16). This concerns the treatment group of a low temperature of 20° C. treatment with 5% BC in water (weight/weight percent (w/w %)) for 3.3-hour. After a rinse wash, a sample thereof was subjected to the wet milling in Thermomix for 10 seconds (see Example 21). This also provided intact single starch bodies. This also allow by examination under crossed polarizers to microscopically show the Maltese cross on the starch bodies. FIG. 38A demonstrates that the wet milling under the conditions of Example 21 allowed within 10 seconds to separate individual starch bodies from their cluster (individual starch granules densely packed or embedded within a complex and continuous protein matrix). A low temperature of 20° C. treatment with 5% BC in water (weight/weight percent (w/w %)) for 3.3 hour was considered a mild condition, wherein was expected that possible under crossed polarizers to microscopically it should be possible to let appear the Maltese cross on the starch bodies, which was the case. FIG. 38B is a photographic of starch bodies concentrating on the 20 μm mesh sieve.

FIGS. 39A-39E (referring to Example 21 and Table 16) are microscopic images of wet grinded pea material from treatment group 2. Field dried yellow pea (100 gram/liter) were with 5% sodium bicarbonate (weight/weight percent (w/w %) for 3.3 hours at a temperature of 60° C. and during continuous stirring (in Thermomix bowl at “Soft/Stir” (speed 1 or 100 rpm) and continuously stirring the yellow peas in “left turn” stir function), thereafter a rinse wash on a 400 mesh (38 μm opening size (μm)) sieve under a tap water stream at 22° C. for 5 minutes and 50 gram of this pea matter is subjected to wet milling as described in Example 21. After loading 50 gram the treated pea material in the bowl of a Vorwerk Thermomix TM6 with 650 gram tap water and wet grinded it by operating the Thermomix's mixing knife in “right turn” cut function at a 10,200 revolutions per minute (set to its highest speed, level 10). The size measure scale is a Meiji techno (0.01 mm (10 micrometers (μm))) Japan X 1/100.

FIG. 39A shows a microscopic photograph of a Lugol and Bradford dyed sample after only 4 seconds of wet milling. The cell wall structural support in which enclosing the individual storage cell is removed, but the starch bodies are yet packed within the cell's cytoplasm, in a continuous protein matrix. FIG. 39B is a microscopic photo made through the lens 40×/0.65 IOS N-Plan filter of the same pea matter but with the same treatment but wet milled for 8 seconds. The matter is stained with Lugol (starch dye) and Bradford (protein dye). The image shows that starch bodies are being released from the clusters and the continuous protein matrix that surrounds such clusters. FIG. 39C is a microscopic photo made through the lens 40×/0.65 IOS N-Plan and polaroid filter of the same pea matter but with the same treatment but wet milled for 16 seconds. The starch bodies separate in individual bodies and show the Maltese cross indicating that the starch bodies remained highly organized and kept the semi-crystalline nature of a native starch granule. The photographic image thus shows individual pea starch bodies that from pea that underwent an off-tone compound removal process of the disclosure (Example 21 and Table 16) and whereof the starch bodies are yet in their native, uncooked state with the structural characteristics semi-crystalline structure, radial molecular arrangement and birefringence. Also demonstrated was that such individual starch bodies can be separated from a protein concentrate (the pea cell wall material and protein bodies) into fractions with negligible or barely perceptible off tone. This confirms that also other separation methods such as by air jet sieving mesh sizes ≤20 μm and other mechanical separation or classification such air classification, centrifugation, hydro-cycloning or centrifugation can be used to separate the pea starch bodies with remained characteristics semi-crystalline structure, radial molecular arrangement and birefringence from other macronutrient matter such as protein matrix debris, protein bodies and cell wall debris into faction with neglectable off-tone burden. Hereby the starch bodies concentrated while the pea cell walls (made predominantly of pectin (mainly rhamnogalacturonan I) and hemicellulose (mainly xyloglucan)) and protein bodies and the protein matrix debris are mainly in the fraction under the 20 μm sieve. Hereby two fractions are generated a pea starch concentrate with removed off tones flavors and a protein concentrate with removed of removed off tone's flavors. FIG. 39D shows a microscopic photo made through the lens 40×/0.65 IOS N-Plan filter and polaroid filter and Lugol and Bradford staining. Starch bodies concentrate on the 20 μm mesh shaker sieve. FIG. 39E, panels E 1-2, shows microscopic photo made through the lens 40×/0.65 IOS N-Plan filter and polaroid filter in panels E 1-2 the Lugol dyed non starch pea material fraction that passed the 20 μm sieve separated by the Retsch shaker sieves (FIG. 37) and in panels E 2-3 the Bradford dyed non starch pea material the fraction that passes the 20 μm sieve separated by the Retsch shaker sieves. It shows removal of the starch bodies and thus a concentration of protein bodies and debris of continuous protein matrix (cytoplasm of the storage cells (rich in dissolved and aggregated proteins)) and fibrous debris of cell wall.

FIGS. 40A and 40B (referring to Example 21 and Table 16) are microscopic photos made through the lens 40×/0.65 IOS N-Plan filter and polaroid filter and Lugol and Bradford staining of the treated and wet milled yellow peas materials of treatment group 3 (Table 16). These field dried yellow peas were subjected for 3.3 hours to the higher temperature of 80° C. and a sodium bicarbonate (BC) 5% concentration (weight/weight percent (w/w %)) in the treatment water while continuously stirring the yellow peas with stir speed setting on “Soft/Stir” (speed 1 or 100 rpm) in “left turn” stir function. Thereafter this pea matter was rinsed washed on a 400 mesh (38 μm opening size (μm)) sieve under a tap water stream at 22° C. for 5 minutes and thereafter 50 gram the pea material is put in the bowl of a Vorwerk Thermomix TM6 with 650 gram tap water and wet grinded by operating the Thermomix's mixing knife in “right turn” cut function at a 10,200 revolutions per minute (set to its highest speed, level 10) for 10 seconds. The starch body clusters did not release separate starch bodies (FIG. 40A). It is not possible under crossed polarizers to microscopically show the Maltese cross on the starch bodies. A 50-gram pea material from the group 3 treatment was wet grinded in the bowl of a Vorwerk Thermomix TM6 with 650 gram tap water it grinded wet by operating the Thermomix's mixing knife in “right turn” cut function at a 10,200 revolutions per minute (set to its highest speed, level 10) for 5 minutes. Even with these 5 minutes high speed wet grinding, these starch body clusters did not release separate starch bodies. Instead, the clusters and starch bodies are fragmented (FIG. 40B)

FIGS. 41A and 41B (referring to Example 21 and Table 16) microscopic photo made through the lens 40×/0.65 IOS N-Plan filter and polaroid filter and Lugol and Bradford staining of the yellow peas of treatment group 4 that were subjected for 1.7 hours to the temperature of 75° C. and a sodium bicarbonate (BC) 2.5% concentration (weight/weight percent (w/w %)) in the treatment water while continuously stirring the yellow peas with stir speed setting on “Soft/Stir” (speed 1 or 100 rpm) in “left turn” stir function. Thereafter this pea matter was in the same a bowl of the Vorwerk Thermomix TM6 subjected to rinse wash under a tap water stream at 22° C. for 5 minutes and thereafter it was collected on a 400 mesh (38 μm opening size (μm)) stainless steel sieve. After loading 50 gram the pea material in the bowl of a Vorwerk Thermomix TM6 with 650 gram tap water it grinded wet by operating the Thermomix's mixing knife in “right turn” cut function at a 10,200 revolutions per minute (set to its highest speed, level 10) for 10 seconds. The parenchyma cells are disintegrated while intact starch bodies are separated from their clusters embedded in the protein matrix. The ability under crossed polarizers to microscopically visualize the Maltese cross on the starch bodies indicates that the starch granules retained their native semi-crystalline structure (FIG. 41A). When subjected to shaker sieving (Example 21—FIG. 37) the starch bodies concentrate on the 20 μm sieve (FIG. 41B).

FIGS. 25 and 26 display the microscopic image (lens 10×) of the 83 and 80 treatment Table (see table 11 A, B & C) condition (T steam) of this example. Dry microwave dry roasting, however, significantly reduced foaming capacity.

FIG. 27 is the microscopic image of an emulsion made with freeze-dried yellow peas that were subject to a 24 hour incubation in water only (in refrigerator) and subsequently have been freeze-dried. A 15 gram fraction thereof was subjected to the same emulsification protocol The microscopic visualization is with a VisiScope series 200 (VRW Avantor (Belgium) Optika microscope (hereinafter called microscope) with 4 lenses (10S N-Plan 100×/1.25 OII/water ∞/0.17 (hereafter called lens 100×), 10SN—Plan 40×/0.65 ∞/0.17 (hereafter called lens 40×), 10SN—Plan 10×/0.25 ∞/0.17 (hereafter called lens 10×) and 10 SN—Plan 4×/0.10 ∞/− (hereafter called lens 4×)) and with Image Focus plus software of Euromex, The Netherlands. As microscopic measuring scale, Objective Micrometer MA285×. 1/100 (0.01 mm) of Meiji Techno Japan was used.

### DETAILED DESCRIPTION

“Bicarbonate modified pulse” means hulled whole pulses or de-hulled whole pulses, as split pulses or as chopped solids thereof with a Feret diameter (Dmax) of 1 to 4 mm) that have been modified by heating at temperatures within the range of 40° C. to 70° C., preferably within the range of 55° C. to 65° C. or for a short period of 15 to 30 minutes at a temperature in the range of 70° C. to 90° C., preferably 80-90° C., in a watery bicarbonate solution (an aqueous solution of a carbonic acid-bicarbonate-carbonate system). Such aqueous bicarbonate solution thus forms a carbonic acid-bicarbonate-carbonate equilibrium and can be made by solving a carbonate, for instance, a bicarbonate salt in water. In this disclosure, bicarbonate modified pulse have been made from starchy Fabaceae pulses selected from the group consisting of chickpea, yellow pea, common bean, and fava bean. Such pulse matter as hulled or de-hulled whole pulses, as split pulses or as chopped solids thereof with a Dmax of 1 to 4 mm) have been fermented. Or they are (for fermentation) first mashed and homogenized in water or a watery fermentation starter medium.

“Bicarbonate water slow cooked pulse” as used herein means pulses hulled or de-hulled pulses as whole pulses, as split pulses or as chopped solids thereof with a Dmax of 1 to 4 mm) that have been heated in an aqueous bicarbonate solution at a low temperature between 40° C. and 60° C. for an extended period in the range of 1 to 12 hours so preserving some cell structure integrity of the pulse cotyledon matter or for a short period of 15 to 30 minutes at a temperature in the range of 70° C. to 90° C., preferably 80-90° C. so preserving some cell structure integrity of the pulse cotyledon matter. Such aqueous bicarbonate solution thus forms a carbonic acid-bicarbonate-carbonate equilibrium and can be made by solving a carbonate, for instance, a bicarbonate salt in water. In this disclosure, bicarbonate water slow cooked pulse have been made from starchy Fabaceae pulses selected from the group consisting of chickpea, yellow pea, common bean and fava bean.

A “water-continuous dairy product” refers to a product where water is the continuous phase, and other components are dispersed within it. In the context of dairy products, this would include products like yogurt, where water forms the continuous phase, and milk proteins, fats, and other components are dispersed within this aqueous phase. The colloidal nature of dairy products like yogurt, with casein aggregates suspended in the liquid phase, further supports the classification of such products as water-continuous colloidal dispersions. In the context of the disclosure, this includes yogurt like or yogurt analogue products, where water forms the continuous phase, and fermented pulse components are dispersed within this aqueous phase.

A “water-continuous non-dairy product” refers also to a product where water is the continuous phase, and other plant-based components are dispersed within it, and wherein water forms the continuous phase, and plant proteins, fats, and other plant components are dispersed within this aqueous phase. In particular, in the disclosure the fermented pulse components are dispersed within this aqueous phase wherein water forms the continuous phase.

A natural oil as used herein can be a vegetable oil, a microbial oil, a plant-based oil, a seed oil, an algal oil, a fungal oil, an invertebrate oil and/or a vertebrate oil and can be a food oil or a body oil.

An “off-tone” or “off-flavor” or “off tone flavor” refers to an undesirable taste or aroma that is not characteristic of a particular food's expected profile. These unwelcome notes can arise from the natural deterioration of the food itself or because of external contamination. For starch-protein pulse seed like peas, chickpeas, common beans and fava beans, off-tones are a significant factor influencing consumer acceptance. In the context of further processing starch-protein pulse seed like peas, chickpeas, common beans and fava beans into food forms or food products such as meat analogues, bakery products and vegan dairy (also called non-dairy) a typical pulse based taste like “grassy,” “beany,” “bitter,” and “earthy.” Is considered an “off-tone” or “off-flavor” or “off tone flavor”

“Food product” as used herein refers to any article or entity that can be consumed (e.g., eaten, drunk, ingested, transported, diffused, injected) by an organism (e.g., animal, human, plant, microbe) as a source of food.

The term “lipid” as used herein refers to a class of organic compounds that are characterized by having limited or no solubility in water. Non-limiting examples of lipids include fats, oils, fatty acids, fatty acid derivatives, fatty acid esters, four-carbon and longer organic alcohols (e.g., butanol, butenol, pentanol, hexanol, etc.), four-carbon and longer organic aldehydes (e.g., butanal, butenal, pentanal, hexanal, etc.), natural oils, waxes, steroids, sterols, phytosterols, glycerides, monoglycerides, diglycerides, triglycerides, phospholipids, phosphatides, choline derived lipids, cerebrosides, hydrocarbons, and some fat-soluble vitamins (e.g., vitamins A, D, E and K). As used herein, a lipid may refer to either a single organic compound or to a mixture of organic compounds that are lipids as commonly observed in sources of lipids used in foods (e.g., canola oil is a lipid that comprises linoleic acid lipid, linolenic acid lipid, oleic acid lipid, etc.).

Non-limiting examples of organic acids suitable for are acetic acid, citric acid, lactic acid, malic acid, propionic acid, sorbic acid, tartaric acid, ascorbic acid, fumaric acid and benzoic acid. Such acids have a preservation activity such as by killing harmful bacteria and to control or prevent the growth of bacteria and mold or as antioxidant (vitamin C). Such acid are available in encapsulated form in capsules formed by substance of the group consisting of chitosan, alginate, maltodextrin, polyacrylates and gelatine.

Non-limiting examples of lipids include algae oil, almond oil, aloe vera oil, apricot oil, avocado oil, baobab oil, calendula oil, canola oil, coconut oil, corn oil, cottonseed oil, evening primrose oil, flaxseed oil, grape seed oil, hazelnut oil, jojoba oil, linseed oil, macadamia oil, neem oil, olive oil, palm oil, peanut oil, rapeseed oil, rice bran oil, safflower oil, sesame oil, soybean oil, sunflower oil, synthetic oils, walnut oil, vegetable oil, high oleic oils, high oleic sunflower oil, high oleic safflower oil, berry wax, candelilla wax, carnauba wax, cocoa butter, illipe nut butter, Japan wax, jasmine wax, kokum butter, lemon peel wax, sal butter, mango butter, myrica fruit wax, murumuru butter, orange peel wax, ouricury wax, rapeseed wax, rice bran wax, rose wax, shea butter, sumac wax, sunflower wax, sunflower seed wax, ucuuba butter, fractionated candelilla wax, fractionated carnauba wax, fractionated cocoa butter, fractionated coconut oil, fractionated mango butter, fractionated palm oil, fractionated rice bran oil, fractionated rice bran wax, fractionated shea butter, palm stearin, shea stearin, rice bran stearin, cocoa stearin, hydrogenated canola oil, hydrogenated corn oil, hydrogenated cottonseed oil, hydrogenated flaxseed oil, hydrogenated grape seed oil, hydrogenated palm oil, hydrogenated peanut oil, hydrogenated rapeseed oil, hydrogenated rice bran oil, hydrogenated safflower oil, hydrogenated sesame oil, hydrogenated soybean oil, hydrogenated sunflower oil, hydrogenated vegetable oil fish oil, Atlantic fish oil, Pacific fish oil, Mediterranean fish oil, bonito oil, pilchard oil, tuna oil, sea bass oil, halibut oil, spearfish oil, barracuda oil, cod oil, menhaden oil, sardine oil, anchovy oil, capelin oil, Atlantic cod oil, Atlantic herring oil, Atlantic mackerel oil, Atlantic menhaden oil, salmon oil, shark oil, squid oil, cuttle fish oil, octopus oil, krill oil, seal oil, and whale oil. In preferred embodiments, the lipid may be selected from the group of algae oil, aloe vera oil, avocado oil, canola oil, coconut oil, corn oil, cottonseed oil, flaxseed oil, grape seed oil, olive oil, palm oil, peanut oil, rapeseed oil, rice bran oil, safflower oil, sesame oil, soybean oil, sunflower oil, high oleic sunflower oil, high oleic safflower oil, berry wax, candelilla wax, carnauba wax, cocoa butter, sal butter, illipe nut butter, Japan wax, jasmine wax, kokum butter, lemon peel wax, mango butter, Myrica fruit wax, Ouricury wax, rapeseed wax, rice bran wax, shea butter, sumac wax, sunflower wax, fractionated coconut oil, fractionated palm oil, fractionated rice bran oil, palm stearin, shea stearin, rice bran stearin, cocoa stearin, animal fat, beef fat, tallow, pork fat, lard, or fish oil.

Lipids can be classified into two main groups: simple lipids and complex lipids. Simple lipids are made up of only one type of molecule, while complex lipids are made up of two or more types of molecules. Simple lipids such as fats, oils and waxes. Fats are the most common type of lipid. They are made up of a glycerol molecule bonded to three fatty acid molecules. Oils are similar to fats, but they have a lower melting point. This is because they have fatty acids with shorter chain. Waxes are made up of a long-chain fatty acid bonded to a long-chain alcohol. They are often found on the surface of plants and animals. Complex lipids comprise phospholipids, glycolipids and steroids: Steroids are a type of lipid that is made up of four fused rings of carbon atoms. They include hormones such as testosterone and estrogen, as well as cholesterol. Phospholipids are the main component of cell membranes. They are made up of a glycerol molecule bonded to two fatty acid molecules and a phosphate group. Glycolipids are a type of lipid that contains a carbohydrate molecule. They are often found on the surface of cells, where they help to identify the cell and its function. Steroids are a type of lipid that is made up of four fused rings of carbon atoms. They include hormones such as testosterone and estrogen, as well as cholesterol.

The term “dry” or “dried” referring to a food component or food ingredient means that the water content has been significantly reduced from the original form of the food. This is typically achieved through processes like dehydration, which remove water from the food by evaporation or other methods. The amount of moisture left in a dry food powder can vary depending on the specific type of food and the drying method used. It has to be interpreted to have a moist content under 12%, preferably under 10% and 7% and even having a moisture content of around 5% or even having have a moisture content of around 3%.

The term “butter” as used herein is understood to be synonymous with the term “lipid” and may refer in general terms to a lipid or a composition comprising a lipid as a main constituent that retains solid, semi-solid, biphasic, or paste-like properties at ordinary temperatures of use.

“Vegetable oil” refers to oil extracted from a vegetable material or any non-animal organism. The method of oil extraction is not particularly limited and is selected according to the plant material. The type of vegetable oil is not limited, but Examples thereof include safflower oil, coconut oil, palm oil, palm kernel oil, soybean oil, rapeseed oil, olive oil, corn oil, processed oil and fat (obtained by processing vegetable oil), and the like. Safflower oil, coconut oil, and palm oil are preferable, and safflower oil is particularly preferable from the perspective of making it difficult to detect off tastes. As used herein, it is understood to comprise oil from plant, algae, yeast, and non-animal organisms and such may comprise edible oils or may comprise body oils, oil that may contact human body are commonly called body oils including coconut oil, jojoba oil, avocado oil, argan oil and sweet almond oil.

“Animal oil” refers to oil extracted from an animal material. The method of oil extraction is not particularly limited and is selected according to the animal material.

The term “additive” as used herein means “a compound,” the intended use of which results or may reasonably be expected to result, directly or indirectly, in affecting the characteristics of any composition.

“Colloidal” is a type of colloid made from finely ground solid material. The solid material ground into a very fine powder, which is then suspended in the liquid. The particles of the solid are so small that they cannot be seen with the naked eye in the colloidal mixture of the ground solid in the fluid. In contrast if a solid is in suspension but not considered colloidal (“coarse suspension” or “non-colloidal suspension”), it implies that the particles are larger than those typically found in colloids are. Colloids are characterized by finely divided particles, often on the nanometer scale that remain dispersed in a medium (such as a liquid or gas) for an extended period. In contrast, if the solid particles in suspension are larger and do not exhibit the stable, long-term dispersion associated with colloids, it would be described as a suspension of larger particles.

The terms “protein isolate” and “protein concentrate” differ in terms of protein quantity. Protein isolates as used herein refer to any plant-based protein isolate, or a partial hydrolysate thereof, commercially. Protein isolates have higher protein content than protein concentrates. The protein content is generally 70% by weight or more, preferably 80% by weight or more, more preferably 85% by weight or more, most preferably 90% by weight or more in the solid content. In the present specification, the isolated vegetable protein provided by the disclosure may be referred to as “isolated vegetable protein,” in particular. In the context of the disclosure, when it is obtained from the starchy-protein and low-fat Fabaceae pulses selected from the group consisting of chickpea, yellow pea, common bean, and fava bean, the remaining percentage of the protein isolate contains starch and/or fibers. “Protein concentrate” as used herein refers to any plant-based protein isolate, or a partial hydrolysate thereof, commercially. Protein concentrates are with lower protein content than protein isolate. The protein content is generally 50% by weight or more, preferably 55% by weight or more, more preferably 60% by weight or more, most preferably 65% by weight or more up to 70% in the solid content. In the present specification, the concentrated vegetable protein provided by the disclosure may be referred to as “concentrated vegetable protein,” in particular. In the context of the disclosure, when it is obtained from the starchy-protein and low-fat Fabaceae pulses selected from the group consisting of chickpea, yellow pea, common bean, and fava bean, the remaining percent of the protein concentrate contains starch and/or fibers.

Advanced oxidation processes (AOPs) utilize highly reactive oxidizing agents to decompose and mineralize organic contaminants. Hydroxyl radicals (OH·) are the primary oxidizing species in AOPs, known for their exceptional reactivity and ability to break down even the most complex organic molecules. They are generated through the synergistic combination of different oxidizing agents, including hydrogen peroxide (H₂O₂), ozone (O₃), and ultraviolet (UV) radiation. Hydrogen peroxide (H₂O₂) is a powerful oxidizing agent that can directly attack organic compounds, breaking down their chemical bonds. It is a non-selective oxidant, meaning it can oxidize a wide range of organic molecules. However, H₂O₂ alone is not as effective in mineralizing organic compounds as AOPs involving other oxidizing agents. Ozone (O₃) is a highly reactive gas with a strong oxidative capacity. It can break down organic compounds through direct oxidation reactions, but it is also known to generate hydroxyl radicals through a process called photolysis. Photolysis occurs when UV radiation interacts with ozone molecules, breaking them down into oxygen molecules and highly reactive oxygen atoms. These oxygen atoms then combine with water molecules to form hydroxyl radicals. UV radiation (UV), specifically UV-A and UV-B wavelengths, can directly excite water molecules, causing them to emit hydroxyl radicals. These radicals can then attack organic compounds, leading to their decomposition. The synergistic combination of H₂O₂, ozone, and UV radiation in AOPs leads to the production of a large number of hydroxyl radicals. These highly reactive radicals attack organic compounds, breaking down their chemical bonds and converting them into simpler, more stable products. The mineralization process ultimately leads to the formation of carbon dioxide (CO₂), water (H₂O), and inorganic salts, essentially transforming organic contaminants into harmless by-products. Advanced oxidation of salt solutions (AOASS) effective degrades a wide range of organic plant aromas and off tones, by a salt solution through a series of reactors where it is exposed to a combination of H₂O₂, ozone, and UV radiation. The hydroxyl radicals (OH·) produced by these reactions attack the organic contaminants, breaking them down into smaller molecules and ultimately to carbon dioxide (CO₂) and water. The clean salts can then be recovered from the treated solution by evaporation or crystallization.

This disclosure solves a long-felt need to make all meals or separate ingredients of non-animal multicellular natural produce (plant-based or fungal) available with considerably removed tones, off tones, and of neutral tone (bland or flat in flavor or taste like nothing). By using methods disclosed herein to remove considerable tones and off tones, basically a neutral tone can be achieved. A skilled person may perceive an undistinctive taste so that by taste alone, the origin of the product is no longer recognizable. The taster will not pick up on sweet, salty, sour, bitter, or umami (savory) any longer and the product does not have any flavors that grab their attention. Even after being treated in accordance with the disclosed method, this multicellular natural produce could be further ground into meal and fractioned in storage carbohydrate isolates and protein concentrates or protein concentrate isolates and fibers each with considerable removed tones and off tones.

For instance, plant-based distinctive taste is a problem in the vegan food processing where beans or pulses are used to produce food with various textures. Current attempts to suppress plant-based tones or off tones are masked with additives, by fermentation or enzymatically. By present technology such pulse meals or pulse-derived ingredients are of neutral taste and that will not disrupt the desired taste of the food form, can be used in various food forms such as beverages, meat analogues, fish analogues non-diary cheeses, non-diary yogurts, non-diary kefirs, etc.

The neutral tasting ingredients can be further functionalized by physicochemical or enzymatic methods. This disclosure thus solves a long-felt need of the food industry. Because companies bring pulse meal ingredients or pulse derived ingredients, starches, protein and fibers as ingredients to the food industry that need to be free of plant tones or of tones. It is currently a major challenge. Since the food industry shifts to more sustainable ingredient separation technologies such as air classification to separate ingredients of a different class on a way that less water and energy is used that wet separation. However, there is a trade-off that more of the plant aroma or off tones are present in the separated ingredients.

The cell wall of pulses provides structural support and protection to the cells. It is composed of complex carbohydrates, such as cellulose, hemicellulose, and pectin, which contribute to the seed's overall fiber content. Protein bodies are specialized organelles within the cells of pulses that store proteins. These protein bodies are essential for providing amino acids and proteins, which are important for human nutrition. Starch bodies are storage granules found in the cells of multicellular plants such as pulses. They primarily comprise starch, which serves as a source of energy for the seed during germination and growth. Fiber in pulses, such as legumes, is predominantly found in the cell walls. Dietary fiber in pulses, including soluble and insoluble fiber, plays a significant role in digestive health, satiety, and overall well-being.

Provided is a method to remove (small molecule) off tone or flavors from that multicellular produce or its tissue while preserving cell structures comprising the cells and their intercellular matrix.

An example of multicellular produce suitable for processing by the methods of the disclosure is a mushroom of the group consisting of Agaricus bisporus (White button, cremini, Portobello) Pleurotus ostreatus (Oyster mushroom) Lentinula edodes (Shiitake), Flammulina velutipes (Enoki), Hypsizygus marmoreus (Shimeji), and Agaricus blazei (Brazilian mushroom).

The disclosed method is suitable for multicellular natural produce that contains starch granules such as mushrooms, starch containing pulses such as Fabaceae pulses, in particular pulses selected from the group consisting of chickpea, yellow pea, common bean, and fava bean, cereal seed, and potato.

The disclosed method is suitable for root vegetables, pulses, cereals and pseudocereals wherein the diameter size range of its starch granules has a higher upper bound than that of its protein bodies such as potato, sweet potato, cassava (Yuca), carrot, beetroot, taro, peas, chickpeas, fava beans, common bean, lentils, maize (corn), wheat, rice, oats, yam, parsnip, rutabaga, sorghum, and quinoa.

An example of rigid cellular structures vegetables suitable for processing by the methods of the disclosure are vegetables of the group consisting of carrots, celery, broccoli, asparagus, Brussels sprouts, beetroot, cabbage, kale, and the Fabaceae pulses, in particular pulses selected from the group consisting of chickpea, yellow pea, common bean, fava bean as whole pulses (hulled or de-hulled pulses) which all are with rigid cellular structures contribute to their texture, which is why they maintain their shape and firmness. Preferred multicellular natural produce for the disclosure are Fabaceae pulses, in particular pulses selected from the group consisting of chickpea, yellow pea, common bean, fava bean as whole pulses (hulled or de-hulled pulses).

An example of root vegetables suitable for processing by the disclosed methods are vegetables of the group consisting of potato, sweet potato, carrot, beetroot, turnip, parsnip, radish, rutabaga, cassava (yuca), and taro.

Water used for the multicellular natural produce treatment or the washing step is preferably in origin water free from undesirable taste, odor, color, and other impurities it may, for instance, distilled water or potable water quality, which can come from a variety of sources including cleaned surface water (e.g., streams, rivers, and lakes), groundwater (e.g., natural springs, wells), cleaned rainwater and seawater (treated at a desalination plant).

An aspect of the disclosure relates to removing the plant tone of starchy Fabaceae pulses consisting of chickpea, yellow pea, common bean, and/or fava bean as hulled or de-hulled pulses whole pulses, as split pulses or as chopped solids thereof with a Dmax of 1 to 4 mm while transforming these in an emulsifying and emulsion stabilizing matter suitable for 1) fermentation the emulsion thereof in fermented milk derivatives with a desired texture or 2) for fermenting such hulled or de-hulled pulses whole pulses or split pulses into melt-in-mouth or self-disintegrating-in mouth snacks or breakfast cereal analogues.

Dry processes are able to produce particles optimized for molecule extraction, mixing with other ingredients, enriching the product in a compound (e.g., proteins, starch). The particle size is the main parameter to adjust and 3 categories are generally described: Coarse milling (>500 μm), fine milling (50 to 500 μm) and ultrafine milling (<50 μm). The particle size and shape are therefore important parameters to be adjusted specifically considering the application, the resources concerned and the economical balance of the process. A suitable system for dry milling of the bicarbonate treated and dried legume seeds is, for instance, milled into grits with a pin mill (LV 15 M Condux-Werk, Wolfgang bei Hanau, Germany) and subsequently the coarse grits can further be milled into flour with a ZPS50 impact mill (Hosokawa-Alpine, Augsburg, DE) at ambient temperature. An ATP50 air-classifier (Hosokawa-Alpine, Augsburg, DE) at ambient temperature can be used to separate protein-rich fine fractions. For instance, with the classifier wheel speed of the ATP50 air-classifier set at 10,000 rpm and the airflow kept constant at 52 m3/h and the feed rate was ˜0.5 kg/h. The powder generated can be treated by air classifying that provides a cut point of a few micrometers or by electrostatic separation that separate particle according to their electrostatic charges and consequently their composition. Electrostatic separators can be classified by the method of charging employed. The three basic types of electrostatic separators include (1) high tension roll (HTR) ionized field separators, (2) electrostatic plate (ESP) and screen static (ESS) field separators and (3) triboelectric separators, including belt separator systems (BSS).

A “Firm/Set” firmness is comparable with a yogurt with a solid structure that holds its shape well. One can easily cut through it with a knife without it crumbling apart.

By “continuous” is meant herein concerning the stirring process that there is no interruption in the process or at least in 50%, preferably 80% and most preferably more than 90% of the process time.

A “Soupy/Runny” texture is drinking yogurt like. It is very loose and flows freely. One can easily drink it straight from the container like a kefir or buttermilk for a good comparison.

A “Thick/Creamy” texture is comparable to that of yogurt that has a thicker consistency and moves slowly when poured. It is spoonable, but the spoon will not necessarily stand upright on its own in such yogurt. A heavy cream or Greek yogurt is a good reference point for comparison.

A “Set/Wobbly but Spoonable” texture is comparable with that of a custard yogurt or quark. It finds a middle ground between firm and runny. It holds its shape somewhat like a mold but wobbles if jiggled. One can easily spoon it.

A food item that self-disintegrates in the mouth without the need for chewing can be described as “melt-in-your-mouth” or “in mouth self-disintegrating” or “melt-in-mouth” or “self-disintegrating-in-mouth.” These terms convey the idea that the food dissolves or breaks or decompose into constituent elements, parts, or small particles effortlessly upon contact with saliva and body temperature, offering a smooth, delicate texture or a sensation of immediate dissolution.

Non-animal multicellularity is commonly associated with plants, fungi, and multicellular algae, including brown algae and red algae.

This disclosure solves the problems of the related art on how obtaining the stable water-continuous non-dairy product that have any or all of these desirable technical effects a) they are stable at an acidic pH, for instance, between 3 and 4.8, b) they remain stable during heat pasteurization, for instance, at temperatures between 8° and 95° C. or even shortly during boiling, c) that are obtainable after fermentation by a vegan ferment starter, d) that can be free of animal derived ingredient or free of any stabilizer compound or viscosity increasing additive compound of the group consisting of xanthan gum, carob gum, guar gum, methylcellulose, carrageenan and carboxymethylcellulose and 5) that can be dried and reconstituted in a water-continuous non-dairy product.

This disclosure is predicated on the discovery that all these additives can be avoided by processing hulled or de-hulled starchy Fabaceae pulses selected from the group consisting of chickpea, yellow pea, common bean, and fava bean pulses as whole, split or chopped solids into emulsion stabilizing compositions. Provided is a method for making water-continuous non-dairy product that, for instance, are free of animal derived ingredient and do not comprise stabilizer compound or viscosity increasing additive compound of the group consisting of xanthan gum, carob gum, guar gum, methylcellulose, carrageenan and carboxymethylcellulose based on this processed starchy Fabaceae pulses selected from the group consisting of chickpea (C. arietinum), yellow pea (P. sativum), common bean (P. vulgaris) and fava bean (V. faba) material.

Also provided is a method of converting whole starchy Fabaceae pulses selected from the group consisting of chickpea, yellow pea, common bean, and fava bean pulses into emulsifying or emulsion stabilizing compositions used to make an emulsion with a natural oil, to inoculate this with a vegan ferment culture for fermentation in a water-continuous non-dairy product, the method comprising a) immersing hulled or de-hulled pulses as whole, split or chopped solids in an aqueous solution of a carbonic acid-bicarbonate-carbonate system, b) providing thermal energy into the system and maintaining the pH above 7 to shift the equilibrium in the carbonic acid-bicarbonate-carbonate system toward carbonate ions and this at a temperature and pH keeping the starchy Fabaceae pulses selected from the group consisting of chickpea, yellow pea, common bean, and fava bean seed material solid and using this processed pulse matter as a feedstock for fermentation by a vegan ferment culture. Provided herein is a way to have such carbonic acid-bicarbonate-carbonate systems made by alkali metal salt. It is also desirable to have the total dissolved solids (TDS) of in the aqueous solution of the carbonic acid-bicarbonate-carbonate system in a range 10 to 100 gram per liter. The pulse product from this processing is substantially freed of the typical plant flavors and can easily be converted by mixing under a proper force with water and oil into a stable emulsion. It was observed that fermentation of emulsion with a vegan ferment culture converts the emulsified mass in a stable water-continuous non-dairy product with a yogurt feel.

These embodiments of the disclosure advantageously use a carbonic acid-bicarbonate-carbonate system. This can be a solution comprising sodium bicarbonate (NaHCO₃) and or sodium carbonate (Na₂CO₃) or a combination thereof or that the carbonic acid-bicarbonate-carbonate system by a solution comprising potassium bicarbonate (KHCO₃) or potassium carbonate (K₂CO₃) or a combination thereof and when a base is used that this is alkali metal hydroxide, for instance, wherein the alkali metal is sodium or wherein the alkali metal is potassium. The added base can be alkalis is of the group consisting of sodium hydroxide, potassium hydroxide, calcium hydroxide and magnesium hydroxide.

It was found that the moist pulses treated with BC-BvCa medium of a water solution of sodium bicarbonate (comprising also zinc and iron catalyst and bivalent ions such as Ca++ or Mg++) were (see table 4) firmer texture after the same heating and time that the pulses treated by the BC medium (a water solution of only sodium bicarbonate). However, when these pulse matters were subjected to fermentation by a vegan ferment, it was observed that the fermented BC-BvCa medium treated pulses became softer than fermented BC-medium treated pulses and this for the same fermentation conditions. Some of the techniques described herein may be embodied as the transformation of the starchy Fabaceae pulses selected from the group consisting of chickpea (C. arietinum), yellow pea (P. sativum), common bean (P. vulgaris) and fava bean (V. faba) in an emulsifying or emulsion stabilizing composition according to the methods described here above is with a carbonic acid-bicarbonate-carbonate system comprising a zinc and/or iron catalyst or bivalent ions such as Ca++ or Mg++ to speed up the reaction and to lower activation energy.

Some of the techniques described herein may be embodied as the transformation of the starchy Fabaceae pulses selected from the group consisting of chickpea, yellow pea, common bean, and fava bean in an emulsifying or emulsion stabilizing composition according to the described methods is with a carbonic acid-bicarbonate-carbonate system comprising a zinc and/or iron catalyst and bivalent ions such as Ca++ and Mg++ to speed up the reaction and to lower activation energy.

Furthermore it was observed that the dried pulses treated with BC-BvCa medium of a water solution of sodium bicarbonate (comprising also zinc and iron catalyst and bivalent ions such as Ca++ or Mg++) and subjected with fermentation by a vegan ferment were more self-disintegrating-in-mouth than dried pulses that were treated the same way in terms of heat input and treatment time but with the BC medium (a water solution of only sodium bicarbonate). Some of the techniques described herein may be embodied as the transformation of dried starchy Fabaceae pulses selected from the group consisting of chickpea (C. arietinum), yellow pea (P. sativum), common bean (P. vulgaris) and fava bean (V. faba) into a snack of pulses or cereal analogues according to the methods described here above with a carbonic acid-bicarbonate-carbonate system or with a carbonic acid-bicarbonate-carbonate system comprising a zinc and/or iron catalyst or bivalent ions such as Ca++ or Mg++ to speed up the reaction and to lower activation energy.

Surprisingly, while the treatment BC-BvCa medium (a water solution of sodium bicarbonate (comprising also zinc and iron catalyst and bivalent ions such as Ca++ or Mg++) resulted in softer moist pulses (and this is obtained after a substantial washing step), when these pulses were homogenized with a natural oil (canola oil) and stored for 24 h in a refrigerator this resulted in a running drinking yogurt like texture, while the BC medium (a water solution of only sodium bicarbonate) with further the same physical treatment resulted in tick/creamy Greek or Bulgarian yogurt like texture. And, for instance, a BC medium+magnesium chloride with further the same physical treatment resulted in set/wobbly but spoonable texture comparable with that of a custard yogurt or quark.

Yet further surprisingly, when these homogenized and emulsified masses were subjected to a vegan ferment culture fermentation, the BC-BvCa medium (a water solution of sodium bicarbonate (comprising also zinc and iron catalyst and bivalent ions such as Ca++ or Mg++) treated pulse, independent of the vegan ferment resulted into a set/wobbly texture and custard yogurt/quark/cottage cheese like vegan fermented product. The general tendency was that pre-treatment of the pulse with a BC medium+a bivalent ion (Ca++, Mg++ or Fe++ and Zn++) resulted after fermentation in a firmer yogurt or cheese-like structure that the pre-treatment by a BC medium alone.

In one embodiment of the disclosure, this pre-treatment processing of the starchy Fabaceae pulses selected from the group consisting of chickpea, yellow pea, common bean, and fava bean is carried out in an airtight reaction vessel. In another embodiment of the disclosure, the processing of the starchy Fabaceae pulses selected from the group consisting of chickpea, yellow pea, common bean, and fava bean is carried out in an open reaction vessel.

In a practical embodiment, the process comprises discharging the aqueous solution of the carbonic acid-bicarbonate-carbonate system or the starchy Fabaceae pulses selected from the group consisting of chickpea, yellow pea, common bean, and fava bean material from the reaction vessel, and treating the starchy Fabaceae pulses with a wash step and optionally thereby regenerating carbonic acid-bicarbonate-carbonate system.

By using the system described herein, it is possible to obtain as reaction product an emulsifying or emulsion stabilizing starchy Fabaceae pulse selected from the group consisting of chickpea, yellow pea, common bean, and fava bean composition and to have this in a homogenized paste form.

Another embodiment of the disclosure is an emulsifying or emulsion stabilizing starchy Fabaceae pulses selected from the group consisting of chickpea (C. arietinum), yellow pea (P. sativum), common bean (P. vulgaris) and fava bean (V. faba) composition obtained by the process of the disclosure but that is dried and grinded in a micronized dry form.

Yet another embodiment of the disclosure is emulsifying or emulsion stabilizing with a natural oil of the starchy Fabaceae pulses selected from the group consisting of chickpea (C. arietinum), yellow pea (P. sativum), common bean (P. vulgaris) and fava bean (V. faba) composition obtained by the process of the disclosure and consequently fermented and consequently dried and grinded in a micronized dry form. It has surprisingly been observed that such dry micronized powder of the can instantly be reconstituted with water in a non-dairy or vegan-type yogurt analogue.

This disclosure concerns a method for preparing food or feed ingredient with improved properties, where either eliminated or substantially diminished off-flavor, accompanying fragrance, flavors contaminants or antinutritional factors, from non-animal multicellular natural produce or produce tissue with starch storage bodies and protein storage bodies, in particular, Fabaceae pulses selected from the group consisting of chickpea (C. arietinum), yellow pea (P. sativum), common bean (P. vulgaris) and fava bean (V. faba) as whole pulses (hulled or de-hulled pulses), as split pulses or as chopped solids thereof with a Feret diameter (Dmax) of 1 to 4 mm, or a combination thereof, wherein the method comprises 1) stirring the produce or produce tissues in for at least 30 minutes in an aqueous bicarbonate solution or bicarbonate/carbonate solution at a concentration and temperature to preserve structures formed by cells and intercellular material while removing contaminants and/or off-notes molecules, 2) removing the bicarbonate solution or bicarbonate/carbonate solution with off-flavor, accompanying fragrance, flavor contaminants or antinutritional factors, 3) washing the multicellular produce or produce tissue, for instance, by rinse washing with water or immersing in water for a short period of 30 minutes to 180 minutes a temperature between 2° and 65° C.

An improved property is that washed the multicellular produce or produce tissue with intact cellular structure with starch storage bodies and protein storage bodies allowed to produce macronutrient concentrates and isolates with eliminated or substantially diminished off-flavor, accompanying fragrance, flavors contaminants or antinutritional factors by i) further grounding the cell wall and intercellular material of the produce to release starch bodies, protein bodies and fibers into a wet flour mixture or suspension mixture or ii) further drying the produce or produce tissue and milling the cell wall and intercellular material of the produce to release starch bodies, protein bodies and fibers into a dry flour mixture and further separating the particles of distinct size, shape, or density to concentrate macronutrient.

Another improved property is that washed the multicellular produce or produce tissue with intact cellular structure manufacturing is processable in a stable acidic fermented colloidal dispersions or suspensions with eliminated or substantially diminished off-flavor, accompanying fragrance, flavors contaminants or antinutritional factors by homogenizing the multicellular produce or produce tissue mass from the previous steps with a natural oil and water into a homogenate and fermenting the homogenate with an added vegan ferment culture and optionally a vegan culture starter medium. By this process a stable fermented dairy substitute is manufactured that, comprises or consisting essential of a fermented mixture of 1) from 1 to 50 wt %, from 5 to 40 wt %, or from 10 to 30 wt % of a natural oil and 2) from 3 to 60 wt %, from 4 to 59%, from 5 to 40%, from 6 to 30% or from 7 to 20% by dry weight of bicarbonate modified pulse selected from the group of the starchy Fabaceae pulses consisting of chickpea (C. arietinum), yellow pea (P. sativum), common bean (P. vulgaris) and fava bean (V. faba) and 3) wherein the composition has a pH of between 2.5 and 5.5 eliminated or substantially diminished off-flavor, flavors contaminants or antinutritional factors and of which were demonstrated accompanying functionalities that these fermented dairy substitutes and water-continuous non-dairy foodstuff have a desired texture, are heat pasteurizable, are stable when acidic and can be dried an instant powder that can be easily reconstituted in the dairy substitutes of desired textures.

Another improved property is that washed the multicellular produce or produce tissue with intact cellular structure manufacturing is processable in dry pulses that are in mouth self-disintegrating by fermenting the washed pulse material with a lactic acid bacteria (LAB) starter culture and optionally any one fermentation starter culture of the groups consisting of a bifidobacteria, a food yeast and a food mold or combination thereof and drying the pulse material.

In accordance with a certain aspect, the disclosed method can comprise subjecting the pulses to a process in which dry pulses are stirred for at least 30 minutes in the bicarbonate solution or bicarbonate/carbonate solution at a temperature in the range of 40 to 70° C., preferably 55-65° C. or for a short period of 15 to 30 minutes at a temperature in the range of 70° C. to 90° C., preferably 80-90° C. —a process of removing the aqueous bicarbonate salt solution with pulse flavor and off-tones from the pulse seeds or from the pulse seeds and seed coats—optionally a process in which the pulse seeds or the pulse seeds and seed coats are stirred for a short period of 20 minutes to 60 minutes in aqueous solution made of an hydroxide salt (MOH) at a pH above 10, preferably 11 and yet more preferably above 11.5, wherein M is an alkali metal cation and further of removing the aqueous hydroxide salt (MOH) solution—a process of rinse washing the pulse seeds or the pulse seeds and seed coats with water or immersing in water for a short period of 30 minutes to 180 minutes a temperature between 2° and 65° C. or for a short period of 15 to 30 minutes at a temperature in the range of 70° C. to 90° C., preferably 80-90° C.

This disclosure relates generally to a method of producing macronutrients fractions from a non-animal multicellular natural produce or produce tissue while eliminating or substantially diminishing off-flavor, flavors contaminants or antinutritional factors. The non-animal multicellular natural produce or produce tissue have a rigid cellular structures with starch storage bodies and protein storage bodies and are preferably Fabaceae pulses consisting of chickpea, yellow pea, common bean, and/or fava bean as hulled or de-hulled pulses whole pulses, as split pulses or as chopped solids thereof with a Feret diameter (Dmax) of 1 to 4 mm.

More particularly, the disclosure concerns a method of 1) stirring and optionally mixing such non-animal multicellular natural produce or produce tissue in for at least 30 minutes in an aqueous bicarbonate solution or bicarbonate/carbonate solution at a concentration and temperature to preserve structures formed by cells and intercellular material while removing contaminants and/or off-notes molecules, 2) removing the solutions with off-flavor, flavor contaminants or antinutritional factors, 3) washing the multicellular produce or produce tissue, 4) or i) grounding the cell wall and intercellular material of the produce to release starch bodies, protein bodies and fibers into a wet flour mixture or suspension mixture or ii) drying the produce or produce tissue and milling the cell wall and intercellular material of the produce to release starch bodies, protein bodies and fibers into a dry flour mixture 5) separating the particles of distinct size, shape, or density to concentrate macronutrient. For instance, when the starch bodies are separated based on their distinct size, shape, or density (which is the case for these de-hulled pulses) from the other macronutrient a protein concentrate faction can be obtained and if protein bodies are separated from the fibers a protein isolate fraction from 56-68% protein on dry weight (DW) can be obtained. The aqueous bicarbonate solution can be an aqueous bicarbonate solution or bicarbonate/carbonate solution made of 1) bicarbonate salt (MHCO₃), or 2) of bicarbonate salt (MHCO₃) and carbonate salt (M₂CO₃), or 3) of bicarbonate salt (MHCO₃) and hydroxide salt (MOH), wherein M is a an alkali metal cation.

This disclosure also relates to removing the plant tone of rigid cellular structures such as starchy Fabaceae pulses consisting of chickpea (C. arietinum), yellow pea (P. sativum), common bean (P. vulgaris) and fava bean (V. faba) as hulled or de-hulled pulses whole pulses, as split pulses or as chopped solids thereof with a Feret diameter (Dmax) of 1 to 4 mm while keeping cellular structure and organized macronutrient bodies (starch bodies and protein bodies) of seed tissue (cotyledon and embryo) intact and thereafter separating macronutrient groups into plant protein, starch and/or fiber of neutral taste.

To achieve these technical effects the pulses have been pre-treated with an aqueous bicarbonate solution or bicarbonate/carbonate solution made of 1) bicarbonate salt (MHCO₃), or 2) of bicarbonate salt (MHCO₃) and carbonate salt (M₂CO₃), or 3) of bicarbonate salt (MHCO₃) and hydroxide salt (MOH), wherein M is a an alkali metal cation, and with a pH between pH 7 and 10, preferably a pH between 7.5 and 10 and temperature in the range of 40 to 70° C., preferably 55-65° C.

Air classification is a crucial process in the production of protein concentrates, with its settings playing a vital role in determining the quality of the separated protein (Pulivarthi, 2023). This technique, based on particle size and density, is utilized to separate pulse flours into protein and starch concentrates (Fenn et al., 2021). The process involves segregating flour particles based on their size and density by introducing air into a classifier chamber, which induces centrifugal and gravitational forces to separate the light, fine fraction (typically protein) from the heavy, coarse fraction (typically starch) (Grasso et al., 2021).

One advantage of air classification is its efficiency in producing protein-enriched samples without causing structural modifications that may occur with chemical extraction methods (Lefèvre et al., 2022). Additionally, air classification has been successful in generating protein- and starch-enriched fractions from various cereals, legumes, and rapeseed (Rempel et al., 2019). It has also been observed that the maximum protein content achievable through air classification corresponds to the actual protein content of the protein bodies, leaving room for further increasing the protein content in the obtained fractions (Pelgrom et al., 2015). Nevertheless, there are drawbacks associated with air classification. For example, air classification typically leads to lower protein purity compared to aqueous extraction methods (Vogelsang-O'Dwyer et al., 2020). Furthermore, antinutritional factors like soya saponin can be concentrated into the protein-rich fraction during air classification, impacting the taste and palatability of the final product (Thiessen et al., 2003).

In addition to removing disturbing contaminants, such as plant tones and off tones, from starchy protein pulses such as the Fabaceae of the group consisting of chickpea, yellow pea, common bean, and fava bean, disclosed is a method to transform such pulses functionalities with natural oils into stable non-dairy emulsions with a desired texture.

In a particular embodiment the bicarbonate modified chickpea (C. arietinum) processed according the to the bicarbonate of the disclosure were transferred into a pulse product that was substantially freed of the typical plant flavors and that can easily be converted by mixing under a proper force with water and oil into a stable emulsion even without addition of extra food oil, lipid or fat. In contrast, the starchy Fabaceae pulses consisting of yellow pea (P. sativum), common bean (P. vulgaris) and fava bean (V. faba) were transferred into a pulse product that was substantially freed of the typical plant flavors and that can easily be converted by mixing under a proper force with water and oil into a stable emulsion, if extra food oil, lipid or fat was add. A certain aspect of the disclosure thus involves a dairy substitute, comprising or consisting essentially of a fermented mixture of 1) from 1 to 50 wt %, from 5 to 40 wt %, or from 10 to 30 wt % of a natural oil and 2) from 3 to 60 wt %, from 4 to 59%, from 5 to 40%, from 6 to 30% or from 7 to 20% by dry weight of bicarbonate modified pulse selected from the group of the starchy Fabaceae pulses consisting of chickpea (C. arietinum), yellow pea (P. sativum), common bean (P. vulgaris) and fava bean (V. faba).

By the disclosure, it was found out that from the hulled or de-hulled pulses whole pulses, as split pulses or as chopped solids the protein bodies and starch bodies could be separated and that these or the protein and starch isolated thereof had a very neutral taste.

### EXAMPLES

### Example 1

Whole pulse seeds: Whole pulse seeds were used. Whole pulse seed in this application means the complete pulse seed with the two cotyledons and embryos inside the protecting seed coat. Of such whole pulse seed processes had been carried out on chickpea (C. arietinum), yellow pea (P. sativum), common bean (P. vulgaris) and fava bean (V. faba), which all belong to the family of the Fabaceae. A general practice to prepare such dry whole pulse seeds with seed coat is by mechanical harvesting once in the field the pods have matured and dried on the plant and by threshing to release the whole pulse seeds. Thereafter the whole pulse seeds can be further dried to reduce their moisture content to ensure better storage stability and they will be cleaned to remove any debris, dirt, or impurities, for instance, by passing the whole pulse seeds through screens and air blowers to remove foreign materials. And finally, they are packed.

BC medium treatment: On a further processing step for the disclosure is a treatment with an aqueous 5% (Na⁺HCO₃⁻) sodium bicarbonate (hereinafter BC medium). Each time a 350 gram amount of such dry whole pulse seed (complete pulse seed with the two cotyledons and embryos and the protecting seed coat) was after a water rinse, subjected the dry whole pulse seed to a stirrion treatment in an aqueous 5% (Na⁺HCO₃⁻) sodium bicarbonate (hereinafter BC medium) at 60° C. At this temperature a carbonic acid-bicarbonate-carbonate equilibrium can be expected of which the pK1 and pK2 values of carbonic acid typically at 60° C. of about 6.47 and 9.87, respectively, (H₂CO₃ (aq)+H₂O (l) [symbol] HCO₃⁻ (aq)+H₃O⁺ (aq) (K1) HCO₃⁻ (aq)+H₂O (l) [symbol] CO₃²⁻ (aq)+H₃O⁺ (aq) (K2)). Therefor a 350 gram amount of such dry whole dry whole pulse seeds were weighed in the mixing bowl of a Vorwerk Thermomix TM6 (with intelligent heating and mixing system) and this was filled with the 5% sodium bicarbonate solution to about the max. fill line (2.2 liters). Thereafter this mass was stirred during 99 minutes at temperature of 60° C. at low speed (initially at a TM6 Thermomix speed setting 2 (200 rpm) to prevent blocking, consequently at a TM6 Thermomix speed 1.5 and a little later at TM6 Thermomix speed 1 (100 rpm). After a second rinse pulse matter under a water stream, this 5% sodium bicarbonate (BC medium) treatment mixing operation (99 minutes at a temperature of 60° C.) has been repeated by subjecting the pulse matter for a second time with fresh aqueous BC medium at the same speed and temperature.

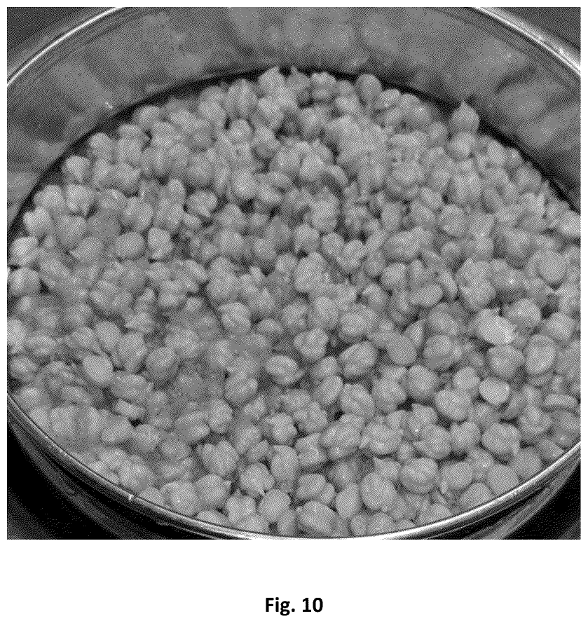

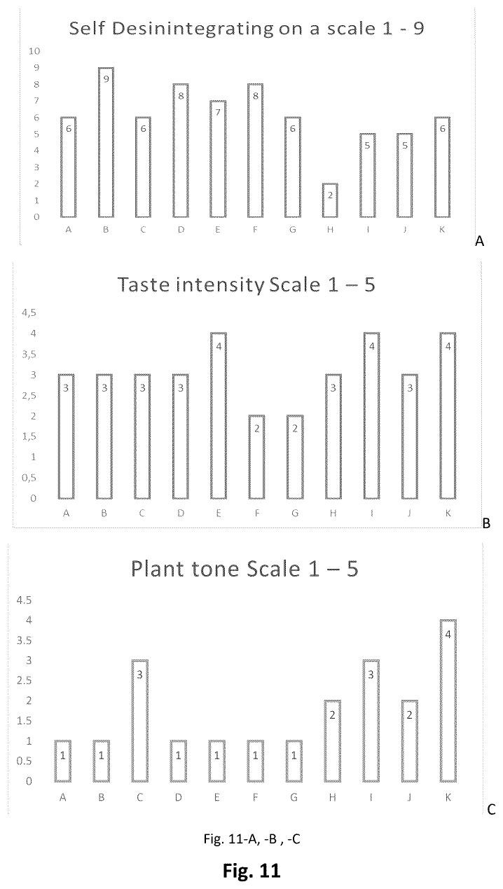

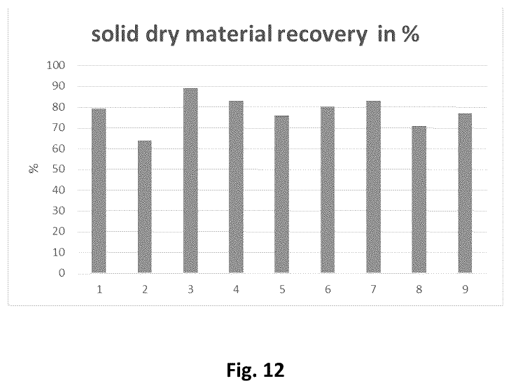

The BC medium has been separated from the pulse matter and each time the pulse matter had been subjected to a washing step by rinsing. Consequently, the same treatment has been repeated as with the BC medium (2×99 minutes at 60° C.) but only in water without sodium bicarbonate. Finally to guarantee full pasteurization the pulse material was stirred in mixing bowl of a Vorwerk Thermomix TM6 for 20 minutes at 90° C. at low speed first at a TM6 Thermomix speed setting 1 (100 rpm). The collected pulse matter is seed coat, the pulse without seed coat (two cotyledons and embryos attached together but without seed coat) and some split pulse material (FIG. 10 for the NaHCO₃+CaCl₂ treatment).

### Example 2

BC-BivCa medium treatment: For further processing by an adapted carbonate medium in by the disclosure each time a 350 gram amount of such dry whole pulses with seed coat were after a water rinse, subjected to a aqueous treatment with an aqueous solution of 5% sodium bicarbonate (Na⁺HCO₃⁻) and comprising the bivalent cations as 0.5% calcium carbonate (Ca⁺⁺CO₃⁻⁻), 0.1% magnesium chloride (Mg²⁺Cl₂⁻⁻), 20 mg ferrous lactate (iron(II) lactate), Fe⁺⁺(C₃H₅O₃)⁻₂ and 20 mg zinc oxide (Zn⁺⁺O⁻⁻), hereinafter the called bivalent cation treatment medium or the BC-BivCa medium. Therefor 350-gram amount of such dry whole pulses were weighed in the mixing bowl of a Vorwerk Thermomix TM6 with intelligent heating and mixing system and further filled with the BC-BivCa medium to about the max. fill line (2.2 liters) and mixed for 99 minutes at 60° C. at low speed first at the TM6 Thermomix speed 2 (200 rpm), consequently at the TM6 Thermomix speed 1.5, and a little later at the TM6 Thermomix speed 1 (100 rpm).

After a second rinse of the pulse matter under a water stream, this BC-BivCa medium treatment mixing operation has been repeated by stirring the pulse matter for a second time in the same volume of fresh the BC-BivCa medium and for 99 minutes stirring this at TM6 Thermomix speed 1 (100 rpm) and at same temperature of 60° C. Each time the BC-BivCa medium has been separated from the pulse matter and each time the pulse matter had been subjected to a washing step by a water rinse. Consequently the same treatment has been repeated as with the BC-BivCa medium (2×99 minutes at 60° C.) at the TM6 Thermomix speed 1 (100 rpm) but with water without the BC-BivCa medium.

And finally the pulse material was stirred in mixing bowl of a Vorwerk Thermomix TM6 for 20 minutes at 90° C. at low speed first at TM6 Thermomix speed setting 1 (100 rpm). The collected pulse matter is seed coat, the pulse without seed coat (two cotyledons and embryos attached together but without seed coat) and some split pulse material (FIG. 10 for the NaHCO₃+CaCl₂ treatment).

### Example 3

### Fermentation of Whole Pulse Matter:

Batches of some of the pulse material of the BC medium treatment (Example 1) and of the BC-BivCa medium treatment (Example 2) have as a mixed matter of de-hulled pulses and separated seed coat (without grinding or homogenizing) been suspended into a pasteurized 5% cane sugar watery solution in a sterile and sealable glass jars. Once at room temperature these have inoculated with by 1) vegan yogurt starter culture (Aspergillus oryzae, Saccharomyces cerevisiae, Lactobacillus bulgaricus, Streptococcus thermophiles, Lactobacillus plantarum, Lactobacillus casei and Lactococcus lactis), 2) vegan kefir starter culture (Lactococcus lactis subsp. lactis, Lactococcus lactis subsp. cremoris, Lactococcus lactis subsp. diacetylactis, Lactobacillus delbrueckii subsp. bulgaricus, Lactobacillus helveticus, Lactobacillus rhamnosus, Lactobacillus paracasei, Lactobacillus acidophilus, Streptococcus thermophilus, Bifidobacterium bifidum and Leuconostoc mesenteroides) and as well by 3) sauerkraut starter culture (wild bacteria and yeasts). Consequently, the pulse matter had been anaerobically fermented at 22° C. The fermentation with vegan yogurt starter culture was 14 days and the fermentation with vegan kefir starter culture and with sauerkraut starter culture was 7 days.

### Example 4

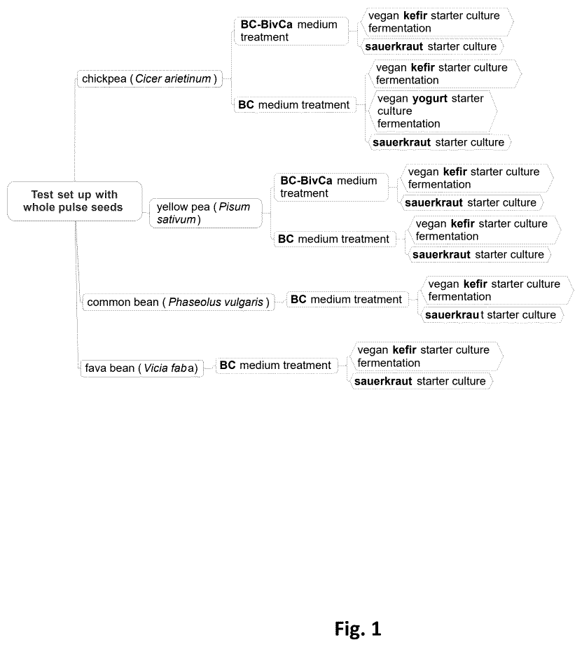

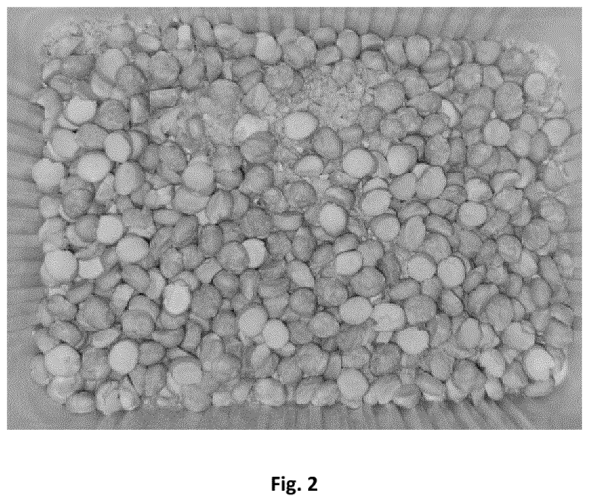

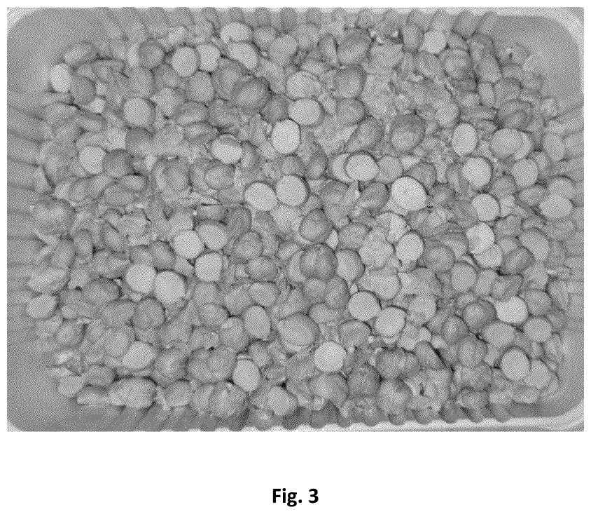

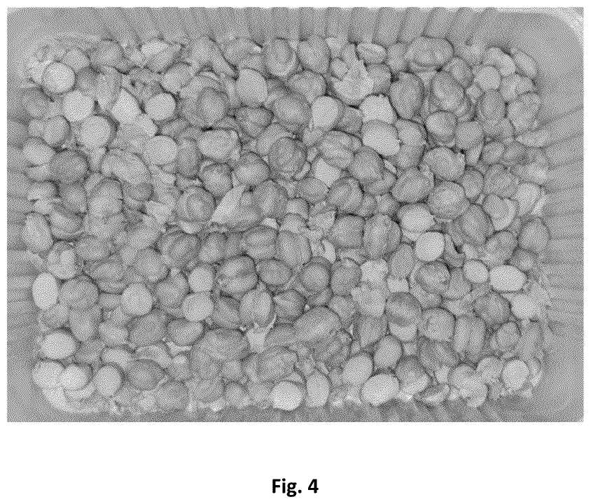

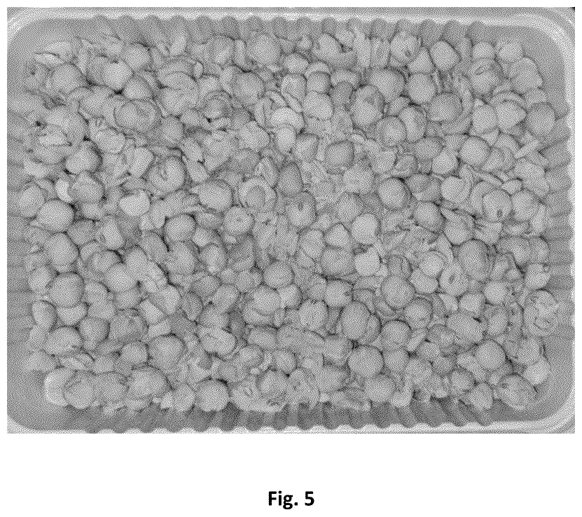

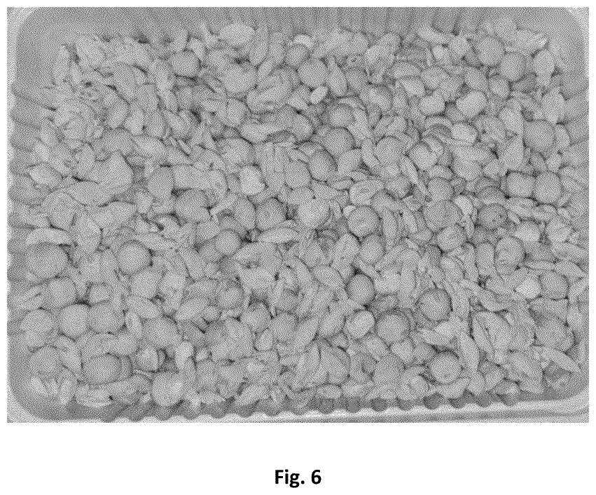

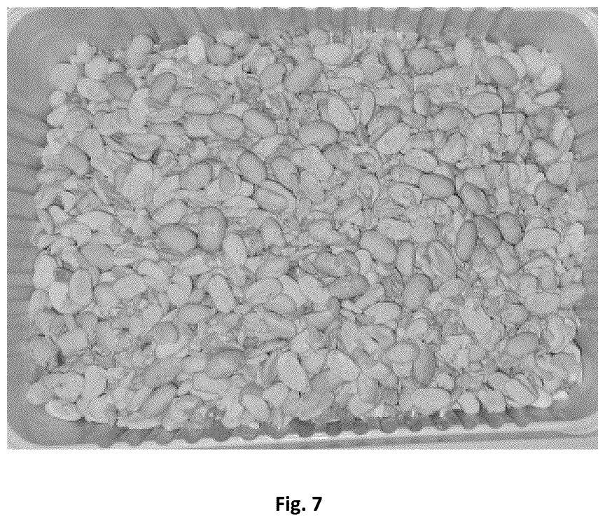

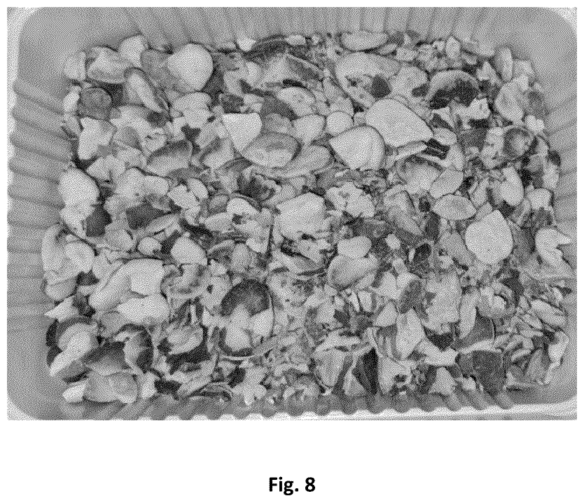

A whole pulse-processing test was organized as displayed in FIG. 1:
1. whole chickpeas—BC-BivCa medium treatment—vegan kefir starter culture fermentation
2. whole chickpeas—BC medium process—vegan kefir starter culture fermentation
3. whole chickpeas—BC medium—vegan yogurt starter culture fermentation
4. whole yellow pea pulse—BC-BivCa medium—vegan kefir starter culture fermentation
5. whole yellow peas BC medium—vegan kefir starter culture fermentation
6. whole common bean—BC medium—vegan kefir starter culture fermentation
7. whole fava beans—BC medium process—vegan kefir starter culture fermentation
8. whole chickpeas—BC-BivCa medium treatment—sauerkraut starter culture (wild bacteria and yeasts)
9. whole chickpeas—BC medium process—sauerkraut starter culture (wild bacteria and yeasts)
10. whole yellow pea pulse—BC-BivCa medium—sauerkraut starter culture (wild bacteria and yeasts)
11. whole yellow peas BC medium—sauerkraut starter culture (wild bacteria and yeasts)
12. whole common bean—BC medium—sauerkraut starter culture (wild bacteria and yeasts)
13. whole fava beans—BC medium process—sauerkraut starter culture (wild bacteria and yeasts)

### Example 5

### Effect of the BC Medium Re-Treatment and the BC-BivCa Medium Treatment

The whole pulse matter was collected from the BC medium re-treatment and the BC-BivCa medium treatment and compared on consistency and mouthfeel.

BC medium re-treatment removed the plants tones and bitterness and earthiness tones of fava beans and common beans and rendered them a neutral taste. Both the BC medium re-treatment and the BC-BivCa medium treatment substantially removed the plant flavors and bitterness and earthiness tones from yellow peas and chickpeas.

Although the physical treatment conditions and treatment time were the same, a surprising observation is a difference in technical effect in that the chickpeas and the yellow peas treated with the BC medium (aqueous 5% Na⁺HCO₃⁻) had a remarkably more tender texture (Table 4) than the chickpeas or the yellow peas, respectively, that were treated with the BC-BivCa medium (an aqueous solution of 5% Na⁺HCO₃⁻and the bivalent cations as 0.5% Ca⁺⁺CO₃⁻⁻, 0.1% Mg²⁺Cl₂⁻⁻, 20 mg ferrous lactate (iron(II) lactate), Fe⁺⁺(C₃H₅O₃)⁻₂ and 20 mg Zn⁺⁺O⁻⁻))

From a BC-BivCa medium (an aqueous solution of 5% sodium bicarbonate and the bivalent cations as 0.5% calcium carbonate, 0.1% magnesium chloride treatment and of a BC medium (aqueous 5% (Na⁺HCO₃⁻) sodium bicarbonate) treatment pulse material had been freeze-dried. The resulting dry product provides nice neutral tasting pieces that can be consumed as pulse based dry snack light pieces with a soft bite and agreeable mouthfeel that can be eaten as such or as a breakfast cereal analogue or a pulse based instant cereal analogue, typically eaten for breakfast, often with milk or yogurt. Examples include corn flakes, oat bran flakes, puffed cereals, and muesli. The pieces can be fortified by any savory or sweet taste aroma and flavor. These dry products are particularly suitable as crunchy toppings for yogurt, ice cream, or desserts or to crunchy texture for salads or soups.

### Example 6

Batches of chickpea pulse material of the BC medium treatment (Example 1) and of the BC-BivCa medium treatment (Example 2) have as a mixed matter of de-hulled pulses and separated seed coat (without grinding or homogenizing) been suspended into a pasteurized 5% cane sugar watery solution in a sterile and sealable glass jars. Once at room temperature these have inoculated with 1) vegan yogurt starter culture, 2) vegan kefir starter culture and 2) sauerkraut starter culture. Consequently, the whole chickpea pulse matter had been anaerobically fermented at 22° C. for two weeks.

Both BC medium pre-treated and also the BC-BivCa medium pre-treated pulse material were fermented. Surprisingly while the pulse texture of chickpeas after the BC-BivCa medium treatment (Example 2) was firmer than for the BC medium treatment (Example 1, Table 4)), after fermentation of this intact pulse subject matter by 1) vegan yogurt starter culture (Aspergillus oryzae, Saccharomyces cerevisiae, Lactobacillus bulgaricus, Streptococcus thermophiles, Lactobacillus plantarum, Lactobacillus casei and Lactococcus lactis), 2) vegan kefir starter culture (Lactococcus lactis subsp. lactis, Lactococcus lactis subsp. cremoris, Lactococcus lactis subsp. diacetylactis, Lactobacillus delbrueckii subsp. bulgaricus, Lactobacillus helveticus, Lactobacillus rhamnosus, Lactobacillus paracasei, Lactobacillus acidophilus, Streptococcus thermophilus, Bifidobacterium bifidum and Leuconostoc mesenteroides) and as well by 3) sauerkraut starter culture (wild bacteria and yeasts) the pulse texture was substantially firmer for the chickpea pulse matter that was pre-treated by BC medium treatment (Example 1) than for the BC-BivCa medium pre-treated chickpea pulse matter (Example 2).

This fermented pulse chickpea subject matter was separated from the liquid medium over a mesh sieve and consisted of pulse seed and separated seed coats. This subject matter had been freeze-dried.

Both BC medium pre-treated and the BC-BivCa medium pre-treated pulse material that was fermented by the sauerkraut starter tasted too sharp tart and tangy, funky with a wide range of flavors resembling sauerkraut flavor. These unfamiliar notes were not appreciated.

The BC medium pre-treated pulse material that by the vegan yogurt starter had been dried and as a dry matter with tender bite been subjected to panel tasting. The overall impression was a product with a light, airy, and crispy texture with a balanced combination of lactic acid tanginess and subtle sweetness and furthermore versatile with a neutral taste profile allowing it render it with savory, sweet as well as fruity flavors.

Both BC medium pre-treated and the BC-BivCa medium pre-treated pulse material fermented by the vegan kefir starter had been freeze-dried. The dry material was subjected to panel testing for mouthfeel and taste. Both groups had a light, airy, and crispy texture and the overall taste impression was a product that was only slightly sour with a mild and refreshing tart (milder than for the vegan yogurt culture fermentation) and a pleasant tanginess.

### Example 7

One batch of chickpea pulse material of the BC medium treatment (Example 1) had been homogenized in pasteurized water 5% cane sugar water and was inoculated at room temperature with the vegan kefir starter culture (A. oryzae, S. cerevisiae, L. bulgaricus, S. thermophiles, L. plantarum, L. casei and L. lactis) and was consequently anaerobically fermented for two weeks at 22° C. reaching a pH of 3.55. This mass was and homogenous “spoon (spoonable)” fermentation plant base product, with a yogurt texture and without plant flavor of plant off tone. The fermentation did not result in coagulation (FIG. 1).

Part of the fermented product in the Thermomix had been pasteurized by subjecting it in the mixing bowl of a Vorwerk Thermomix TM6 for 30 minutes to a temperature 90° C. while mixing. This delivered a white homogenous mass that after refrigeration at 4° C. for 7 days remained homogenies did not show any signs of separation of liquid by product.

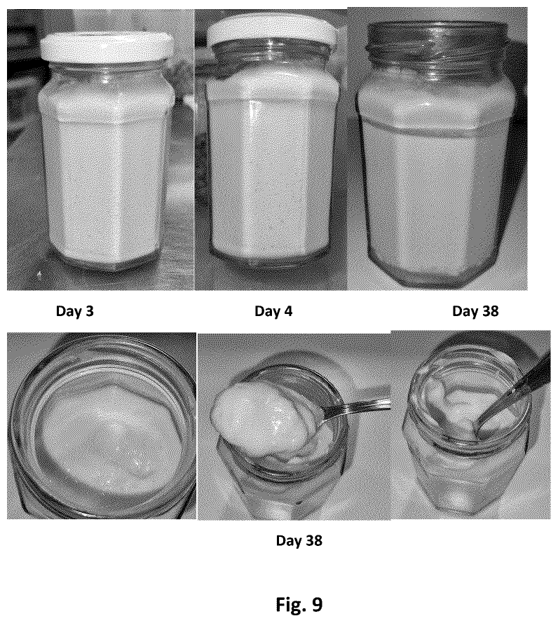

Part of the fermented product mixed with a 10% canola oil and a 5% rice syrup was homogenized in a sterile mixing bowl of the Vorwerk Thermomix TM6 at a speed setting 10 (10200) for 5 minutes and at a speed 6 (3,100 rpm) for 5 minutes. In particular, since the typical chickpea plant taste tones were well removed, the product resembled a smooth dairy yogurt with smooth mouthfeel and similar lactic acid feel. This product was stored for 4 days at 4° C. without any signs of separation of liquid by product and further for 38 days at 4° C. remained a homogenous spoonable soft gelled like solid with only some limited separation of liquid at the bottom of the jar (FIG. 9). Part of this product (fermented product mixed with a 10% canola oil and a 5% rice syrup) had been freeze-dried and the dry product was consequently as dry product (the pulses and separate seed coats) been dry grinded or micronized in the mixing bowl of a Vorwerk Thermomix TM6 for 10 minutes at speed setting 10 (10200 rpm).

By adding water and mixing in the mixing bowl of a Vorwerk Thermomix TM6 at a speed 6 (3,100 rpm) for 5 minutes this could be reconstituted instantly in a yogurt analogue with the same mouthfeel and lactic acid/citric acid tanginess as a dairy yogurt (FIG. 9). The texture after 38 days was firm/set like a like Greek yogurt strained for a longer time, the taste was fruity and smooth without mouth feel of fibers or particles and taste was moderately sour (lactic and citric acid like), tasty and with nice aroma providing a dairy feel. The plant flavor and off tones are totally absent.

### Example 8

This test on chickpea involved two fermentation conditions: group A, a vegan yogurt starter culture (A. oryzae, S. cerevisiae, L. bulgaricus, S. thermophiles, L. plantarum, L. casei and L. lactis) and group B, vegan kefir starter culture+a vegan yogurt starter with (L. lactis subsp. lactis, L. lactis subsp. cremoris, L. lactis subsp. diacetylactis, L. delbrueckii subsp. bulgaricus, L. helveticus, L. rhamnosus, L. paracasei, L. acidophilus, S. thermophilus, B. bifidum, L. mesenteroides and B. animalis spp. Lactis).

Before fermentation, a pre-processing whole pulse seed had been carried out on chickpea (C. arietinum), which all belong to the family of the Fabaceae. A general practice to prepare such dry whole pulse seeds with seed coat is by mechanical harvesting once in the field the pods have matured and dried on the plant and by threshing to release the whole pulse seeds. Thereafter the whole pulse seeds can be further dried to reduce their moisture content to ensure better storage stability and they will be cleaned to remove any debris, dirt, or impurities, for instance, by passing the whole pulse seeds through screens and air blowers to remove foreign materials. Finally they are packed. For these dry chickpea, each time 350 gram had been subjected by immersion to a different solution (numbered 1-9) and with washing steps.

The different solutions tested are

$$5 \% sodium bicarbonate ( {Na}^{+} {HCO}_{3}^{-} ) ( 75 gram / 1.5 L ) + 15 gram / 1.5 L calcium lactate ( {C}_{6} \cdot {H}_{10} \cdot Ca \cdot {O}_{6} ) : pH = 7.8 \qquad 1 )$$

$$5 \% sodium bicarbonate ( {Na}^{+} {HCO}_{3}^{-} ) ( 75 gram / 1.5 L ) + 15 gram / 1.5 L {Na}^{+} {OH}^{-} : pH = 9.5 \qquad 2 )$$

$$5 \% sodium bicarbonate ( {Na}^{+} {HCO}_{3}^{-} ) ( 75 gram / 1.5 L ) + 10 gram / 1.5 L ) + calcium chloride ( {Ca}^{2 +} {Cl}_{2}^{-} ) ( 5 gram / 1.5 L ) \text{:} pH = 7.7 \qquad 3 )$$

$$5 \% sodium bicarbonate ( {Na}^{+} {HCO}_{3}^{-} ) ( 75 gram / 1.5 L ) + 15 gram / 1.5 L calcium sulphate ( {Ca}^{2 +} {SO}_{4}^{2 -} ) : pH = 7.6 \qquad 4 )$$

$$5 \% sodium bicarbonate ( {Na}^{+} {HCO}_{3}^{-} ) ( 75 gram / 1.5 L ) + 15 gram / 1.5 L calcium carbonate ( {Ca}^{++} {CO}_{3}^{--} ) : pH = 8.1 \qquad 5 )$$

$$5 \% sodium bicarbonate ( {Na}^{+} {HCO}_{3}^{-} ) ( 75 gram / 1.5 L ) + 15 gram / 1.5 L additional 5 \% sodium bicarbonate ( {Na}^{+} {HCO}_{3}^{-} ) : pH = 8.1 \qquad 6 )$$

$$5 \% sodium bicarbonate ( {Na}^{+} {HCO}_{3}^{-} ) ( 75 gram / 1.5 L ) + 15 gram / 1.5 L magnesium chloride ( {Mg}^{2 +} {Cl}_{2}^{--} ) : pH = 8.2 \qquad 7 )$$

$$5 \% sodium bicarbonate ( {Na}^{+} {HCO}_{3}^{-} ) ( 75 gram / 1.5 L ) + 20 mg ferrous lactate ( iron ( II ) lactate ) , \& 20 mg zinc oxide ( {Zn}^{++} + {O}^{--} ) \text{:} pH = 8.2 \qquad 8 )$$

$$5 \% sodium bicarbonate ( {Na}^{+} {HCO}_{3}^{-} ) ( 75 gram / 1.5 L ) + 4.5 gram / 1.5 L calcium carbonate ( {Ca}^{++} {CO}_{3}^{--} ) + 4.5 gram / 1.5 L calcium sulphate + 4.5 gram / 1.5 L {Mg}^{2 +} {Cl}_{2}^{--} + 20 mg ferrous lactate ( iron ( II ) lactate ) , \& 20 mg zinc oxide ( {Zn}^{++} + {O}^{-} ) \text{:} pH = 7.7 \qquad 9 )$$

The processing step was a treatment with an aqueous solution. Each time, a 350 gram amount of such dry whole pulse seed (complete pulse with the two cotyledons and embryos and the protecting seed coat) was after a water rinse, subjected the dry whole chickpeas to a treatment of stirring in 1.5 L of the aqueous solution (medium 1, 2, 3, 4, 5, 6, 7, 8 or 9)) at 60° C. Therefor a 350-gram amount of such dry whole dry whole chickpeas was weighed in the mixing bowl of a Vorwerk Thermomix TM6 (with intelligent heating and mixing system) and this was filled with the solution. Thereafter this mass was stirred during 99 minutes at temperature of 60° C. at low speed (initially at a TM6 Thermomix speed setting 2 (200 rpm) to prevent blocking, consequently at a TM6 Thermomix speed 1.5 and a little later at TM6 Thermomix speed 1 (100 rpm). After a second rinse pulse matter under a water stream, such aqueous solution treatment mixing operation (99 minutes at a temperature of 60° C.) has been repeated by subjecting the chickpea matter for a second time with a fresh same aqueous solution at the same speed and temp.

The aqueous solution had been separated from the chickpea matter and each time the chickpea matter had been subjected to a washing step by rinsing. Consequently, the same treatment has been repeated as with the same aqueous solution (2×99 minutes at 60° C.) but only in water without the solutions. Finally the chickpea material was stirred in mixing bowl of a Vorwerk Thermomix TM6 in water for 20 minutes at 90° C. at low speed first at a TM6 Thermomix speed setting 1 (100 rpm). The collected chickpea matter is seed coat, the chickpea without seed coat (two cotyledons and embryos attached together but without seed coat) and some split chickpea material (FIG. 10).

### Example 9

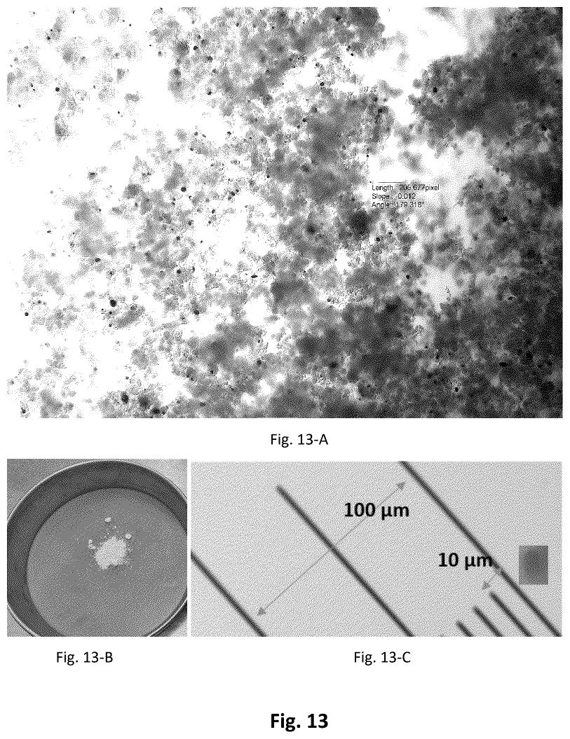

A plant protein concentrate of yellow pea from an industrial process of milling and air classification was dyed by a Lugol solution (BCCK7440 62650-IL-F—Sigma-Aldrich (hereinafter called Lugol or Lugol Dye)) for coloring starch and copper (II) sulphate (84845230-AnalaR NormaPur (hereinafter called copper (II) sulphate dye)) for coloring protein and microscopic visualized with VisiScope series 200 (VRW Avantor (BE) Optika Microscope (microscope) with 4 lenses (10S N-Plan 100×/1.25 OII/water ∞/0.17 (hereafter called lens 100×), 10SN—Plan 40×/0.65 ∞/0.17 (hereafter called lens 40×), 10SN—Plan 10×/0.25 ∞/0.17 (hereafter called lens 10×) and 10 SN—Plan 4×/0.10 ∞/− (hereafter called lens 4×)) and with Image Focus plus software of Euromex, NL. As microscopic measuring scale, Objective Micrometer MA285×. 1/100 (0.01 mm) of Meiji Techno Japan was used. This dry matter yellow pea protein concentrate of was moved by a soft painter's brush and then passed as dry mater and under normal ambient atmosphere a 20 μm mesh shaking sieve (FIG. 13B) and thus had particles sizes of <20 μm. The powder had a distinct pea flavor profile with earthy and beany aromas and distinct beany and bitter flavors typically for pea. The powder was dyed with Lugol (starch dyeing) & Copper (II) sulphate (protein dyeing). FIG. 13A provides a microscopic image (in FIG. 13A & lens 40×) and in FIG. 13C the measuring scale. The black dots (about 10 μm or less) in the photo show some starch particles (that dyed by Lugol) were retained in this protein concentrate. They blue/greenish dispersed matter (in the photo grey), is the non-starch matter of protein dyed with Copper (II) sulphate and with other substances such as cell wall debris.

### Example 10

### Bicarbonate Solution Immersion (2 Times):

First: Whole dry yellow peas with seed (300 gram) were added to 1500 ml 5% sodium bicarbonate solution in a Thermomix and gently stirred (speed 1.5) for 2 hours at a temperature of 60° C. Consequently, these yellow peas and seed coats were collected on a sieve (test sieve (mesh S-steel, ISO 3310/1 body Ø200×50 mm) of Retsch Germany with a mesh size of 300 μm) and the solution removed. Consequently, the solution had been removed and the yellow peas and seed coats were washed with freshwater (tap water).

Second: This treatment was repeated for a second time (collected yellow peas and seed coats add to the Thermomix bowl with 1500 ml 5% sodium bicarbonate solution in the Thermomix bowl and gently stirred (speed 1.5) for 2 hours and at 60° C.). Consequently, the solution was removed and the yellow peas and seed coats were washed with freshwater (tap water).

### Freshwater Immersion (2 Times):

First: The collected yellow peas and seed coats were add again to the Thermomix bowl but this time with 1500 ml freshwater (tap water) and or a next 2 hours these were gently stirred therein for 2 hours and at 60° C. In addition, this wash step had been repeated by rinsing the on the sieve collected yellow peas and seed coats.

### Second:

The collected yellow peas and seed coats were add again to the Thermomix bowl but this time with 1500 ml freshwater (tap water) and or a next 2 hours these were gently stirred therein for 2 hours and at 60° C. In addition, this wash step had been repeated by rinsing the on the sieve collected yellow peas and seed coats.

Thus, after each treatment in the Thermomix, the yellow peas and seed coats have been collected on a 300-μm mesh stainless sieve and were rinse washed under a tap with tap water.

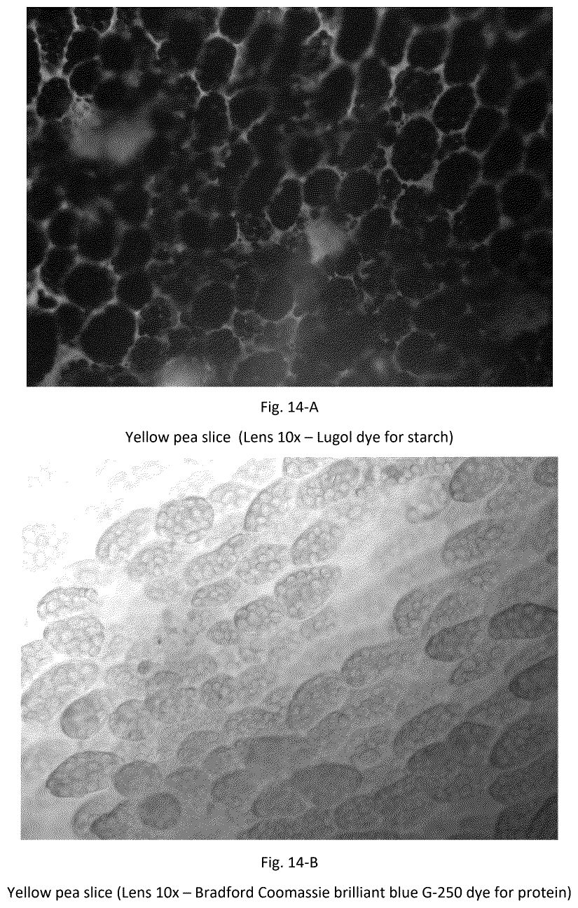

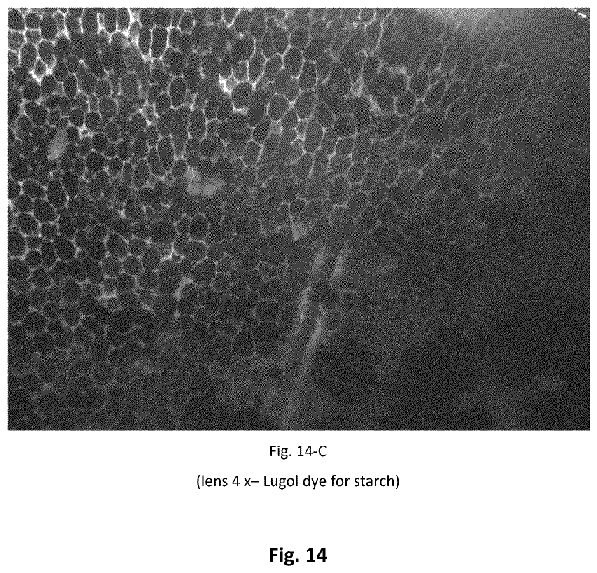

Surprisingly by these treatments, the typical yellow pea beany and bitter flavors were removed to an unrecognizable level (by tasting), while In contrast cellular structure with storage bodies remained intact keeping the macronutrients therein (as can be seen in FIGS. 14A, 14B, 14C). This was visualized by cutting yellow peas of the preceding described treatment with a sharp scalpel blade in thin slices. And putting this in a Bradford Coomassie brilliant blue G-250 dye (Bradford Dye Reagent liquid Cat. No: J61522.AP of Thermoscientific Germany (hereinafter called Bradford Dye)) protein-binding dye or a Lugol solution (BCCK7440 62650-IL-F—Sigma-Aldrich (hereinafter called Lugol or Lugol Dye)). As shown in FIGS. 14A-14C. Despite this pre-treatment, the cellular structure with storage bodies and protein bodies remained intact. FIG. 14A provides a histological image yellow pea slice (made with Lens 10) dyed with the Lugol starch dye and FIG. 14C provides an histological image yellow pea slice (made with Lens 4) dyed with the Lugol starch dye. While FIG. 14B provides an histological image yellow pea slice (made with Lens 10) and dyed with Bradford Coomassie brilliant blue G-250 dye (Bradford Dye Reagent liquid Cat. No: J61522.AP of Thermoscientific Germany (hereinafter called Bradford Dye)) for protein. It nicely shows the starch storage bodies (black) in FIGS. 14A and 14C that are surrounded by intact protein structures (colored blue in real and grey in this image) as demonstrated in FIG. 14B.

### Example 11

Example 11-a Chickpea treatments: Whole chickpeas with seed coat were treated in a 5% sodium bicarbonate solution according to the following manner.

1) 300 gram dry chickpeas with seed coat were added to 1500 ml of a 5% sodium bicarbonate in portable tap water solution in a Thermomix TM6 bowl and at a temperature of 60° C. gently stirred (speed 1.5) for 2 hours. The solution was removed and the chickpeas and their seed coat were collected on a test sieve (mesh S-steel, ISO 3310/1 body Ø200×50 mm) of Retsch Germany with a mesh size of 300 μm. Consequently, these chickpeas and their seed coats in the sieve were rinsed under a stream of tap water.

2) These chickpeas and their seed coats were replaced in a 1500 ml of a 5% sodium bicarbonate in portable tap water solution in a Thermomix TM6 bowl and stirred at a temperature of 60° C. gently stirred (speed 1.5) for an additional 2 hours. The solution was removed again and the chickpeas and their seed coat were collected on a test sieve (mesh S-steel, ISO 3310/1 body Ø200×50 mm) of Retsch Germany with a mesh size of 300 μm. Consequently, these chickpeas and their seed coats in the sieve were rinsed under a stream of tap water.

3) These chickpeas and their seed coats were replaced in a 1500 ml of portable tap water in a Thermomix TM6 bowl and at a temperature of 60° C. gently stirred (speed 1.5) for additional 2 hours. These chickpeas and their seed coat were collected on a test sieve (mesh S-steel, ISO 3310/1 body Ø200×50 mm) of Retsch Germany with a mesh size of 300 μm and wee rinsed under a tap water stream.

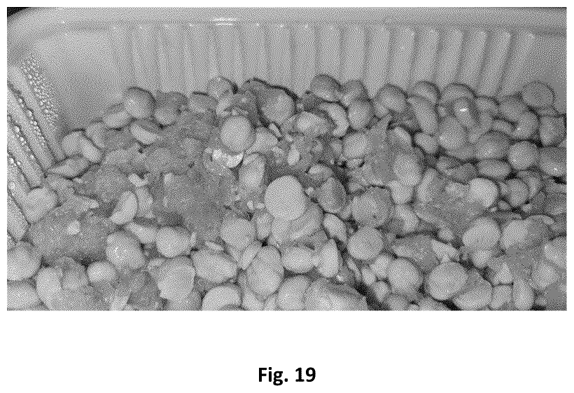

4) These chickpeas and their seed coats were replaced again in a 1500 ml of portable tap water in a Thermomix TM6 bowl and at a temperature of 60° C. gently stirred (speed 1.5) for an additional 2 hours. These chickpeas (cotyledon & embryo) and their seed coat after the bicarbonate treatment were collected on a test sieve (mesh S-steel, ISO 3310/1 body Ø200×50 mm) of Retsch Germany with a mesh size of 300 μm and were rinsed under a tap water stream to obtain mainly split chickpeas halves and seed coat matter as shown in FIG. 19. Thin slides cut with a scalpel blade of the cotyledon/embryo colored with Lugol and with Bradford.

### Example 11-b Drying, Pulverizing and Grinding

i) Part of these chickpeas and their seed coat (FIG. 19) of the process of Example 11-a were freeze-dried in a tray food freeze dryer (Harvestright USA) and part was dried in a drying chamber (convection oven of LG Electronics of South Korea) at 60° C. with heated air circulation within the chamber and air flow over the chickpeas and their seed coat to facilitate moisture evaporation.

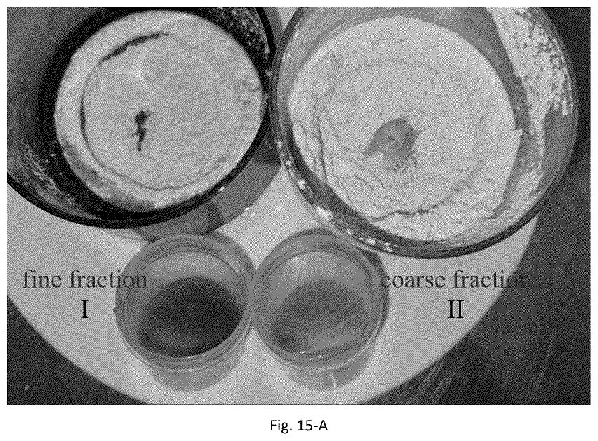

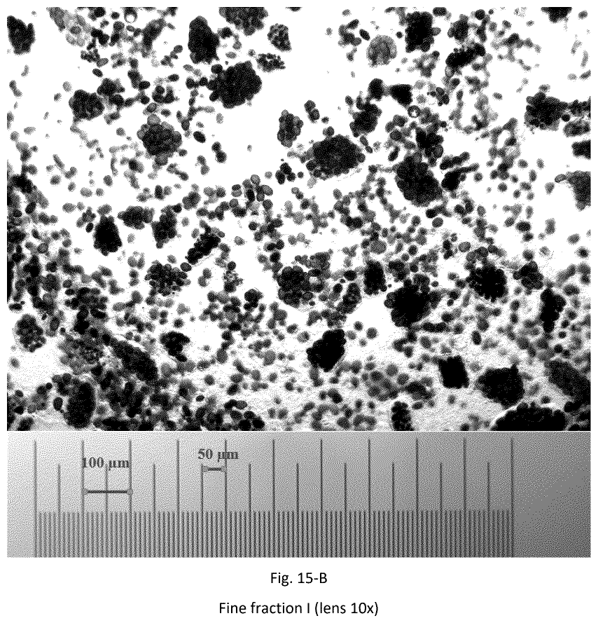

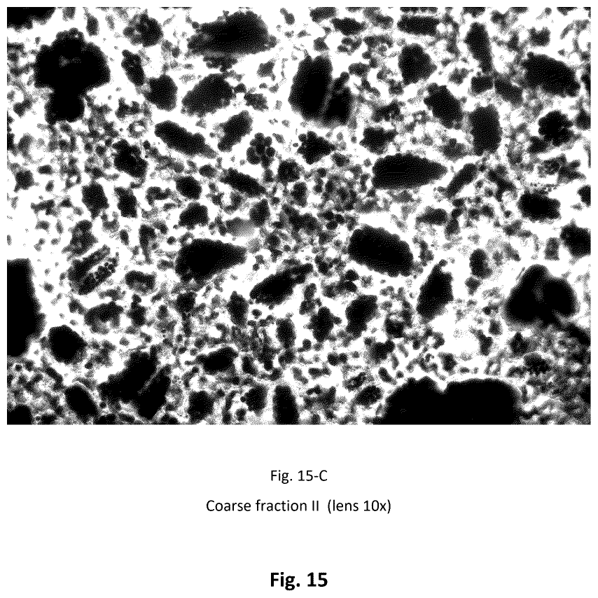

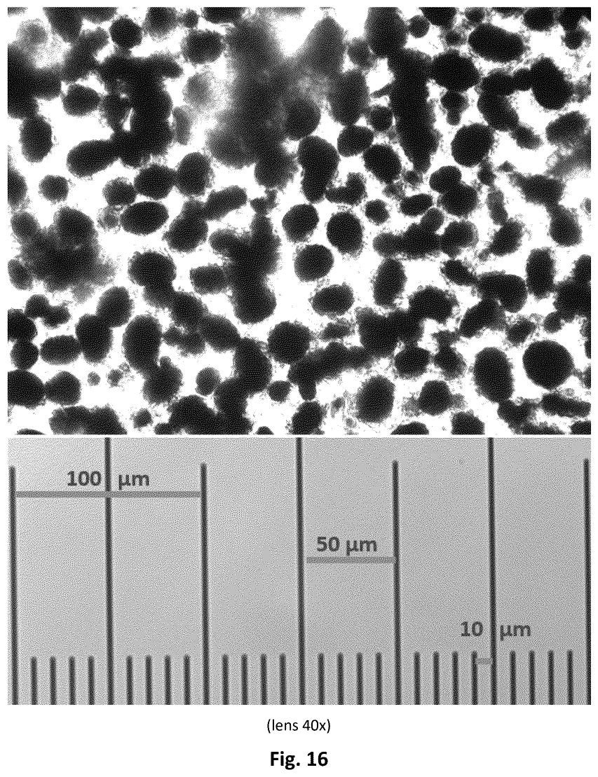

ii) The freeze-dried chickpeas and their seed coat matter was initially grinding and pulverizing with hand mortar and consequently grinded by an electric blade grinder KG210 (Delonghi) with grind setting fine “fine” in a cup with a single stainless-steel blade. This grinder separated 1) a fine meal of a lighter color (fine fraction I in FIG. 15A) that stuck onto the inner surface of the seal that closed the grinding cup during grinding and 2) a darker and coarser meal left on the bottom of the grinding cup after the grinding operation (coarse fraction II in FIG. 15A). The starch bodies and starch bodies clusters were visualized by Lugol dye and the protein fraction by Bradford Dye in the fine fraction I (FIG. 15B) and in the coarse fraction II (FIG. 15C). As demonstrated by the microscopic images (lens 10×) of FIG. 15B and FIG. 15C the starch bodies remained intact during the treatment with the sodium bicarbonate solution after the drying and during the griding. In the coarse fraction II (FIG. 15C) most starch bodies were yet in starch particles clusters and some with as inact cells. In fine fraction I (FIG. 15B) there were less starch particles clusters and there were individual intact starch bodies. Using this dyeing and microscopic visualization on samples, by combined hand mortar and electric blade grinder, the freeze-dried chickpeas and their seed coat matter were further pulverized and grinded so that most clusters were transferred in individual starch bodies and used for making enriched protein and enriched starch fractions according to Example 11-c.

### Example 11-c Dry Powders Fractioning on a Shaker Sieve

This powder from the process here above was consequently loaded on the upper test sieve of a tower of Retsch test sieves each Ø 200×50 mm that tightly fit together in the Retsch shaker sieve apparatus (Shaker sieve Retsch AS 200 apparatus (Retsch Germany). On top of the tower is the sieve with the largest mesh size from 5 mm and hereunder in series, the sieves with a mesh size 1 mm, mesh size 500 μm, mesh size 300 μm to mesh size 20 μm, respectively, and this is tightly fitted on top of a reservoir collector.

When such dry chickpeas/seed coat powder in the shaker sieves were vibrated by the shaker sieve apparatus at an amplitude 90 under normal ambient atmosphere for about 10 minutes the starch bodies could not totally been separated from the protein and fibers. Not any powder passed the 20-μm mesh sieve. The fraction in the 300-μm mesh sieve comprised mainly single starch bodies (black spheroid in the photographic image in FIG. 16). However, these starch bodies (Lugol colored) were still holding some protein (Bradford colored) on its surface as shown in FIG. 16 (lens 10× and Bradford/Lugol dyeing). The fact that not any powder passed the 20-μm mesh sieve and mixed starch bodies and protein bodies were found in the 20 μm mesh sieve, indicated that gravity was not sufficient to separate the starch bodies from protein and fibers in the dry bicarbonate processed chickpea (seed coat, embryo & cotyledon) powder.

To solve that technical problem when the Shaker sieve Retsch AS 200 apparatus (Retsch Germany) was operational, an airflow passed through the tower of Retsch test sieves 0 200×50 mm that tightly fit on each other with a rubber seal such to form a tube with declining mesh sieve sizes. The airflow passed through this tube from the largest mesh sized through the declining mesh sizes and finally into the collection reservoir. In fact, the outer wall of each test sieve form a passage tube. In this tube formed by sieves of different mesh the upper sieve has a mesh of 5 mm and is followed in this tube channel by a sieve of 1 mm, 500 μm, 300 μm to 20 μm and hereunder, respectively, a collection reservoir (a pan) that fits onto the last test sieve by a rubber seal. On top of the upper test sieve, a cover is sealed. The cover has an input channel. So that the upper test sieve is foreseen of an input. Furthermore, the sealed collection reservoir (pan) is foreseen of an output tubing. The output tubing is functionally connected with the air inlet (entry point) of the vacuum cleaner (when operational) to direct the air and particles that passed the 20 μm mesh sieve into the cyclonic chamber for the further separation process by pushing larger particles to the outer walls of the chamber, where they lose energy and fall to the bottom. When operational, this collects particles down to around 1.0 micron (μm) or smaller (down to 0.5 μm). Moreover, with the filter system (Hepa filter) it captures the finest particles (especially those below 1.0 μm) that have not been separated in the cyclonic chamber. Optionally the input in the cover is functionally connected with an in-line pipe air heater so that when operational airflow passes over an enclosed heated body. This way heated air enters via the input in the cover into the tower formed by the Retsch test sieves and in the inside of this tower it passes over the enclosed sieves so that air before passing through the inside of the tower formed by the Retsch test sieves is heated by the in-line pipe air heater.

### Example 11-d Moistening of Chickpea Powders and Fractioning on a Shaker Sieve

Another portion of the bicarbonate of Example 11-a and 11-b processed chickpea (seed coat, embryo & cotyledon) powder was mixed with tap water into a milky fluid. The measured pH of this fluid was 9.05.

This milky fluid was consequently loaded on the upper test sieve of a tower Retsch test sieve Ø 200×50 mm on top such with the largest mesh size from 5 mm, 1 mm, 500 μm and 300 μm to 20 μm with hereunder a collecting reservoir on a Shaker sieve Retsch AS 200 apparatus (Retsch Germany). When such milky dispersion of chickpeas (embryo & cotyledon)/seed coat powder in the shaker sieves was vibrated by the shaker sieve apparatus at an amplitude 90 under normal ambient atmosphere for about 10 minutes the protein bodies and fibers separated from the starch bodies and these protein bodies and fibers was collected on the reservoir under the 20 μm mesh sieve.

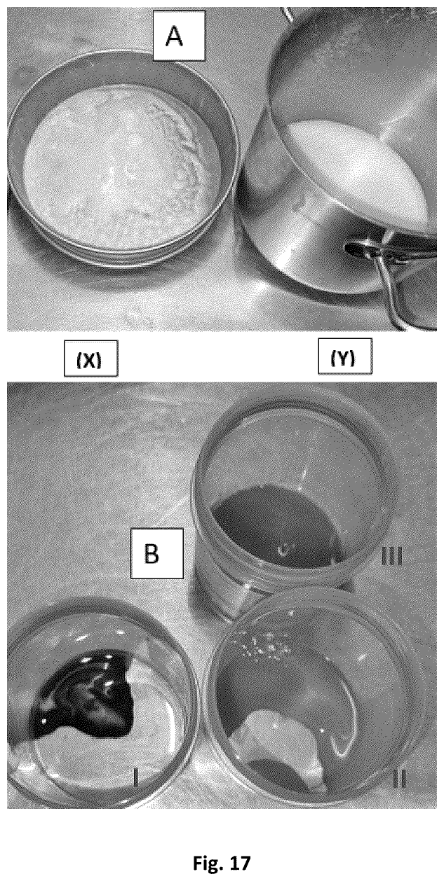

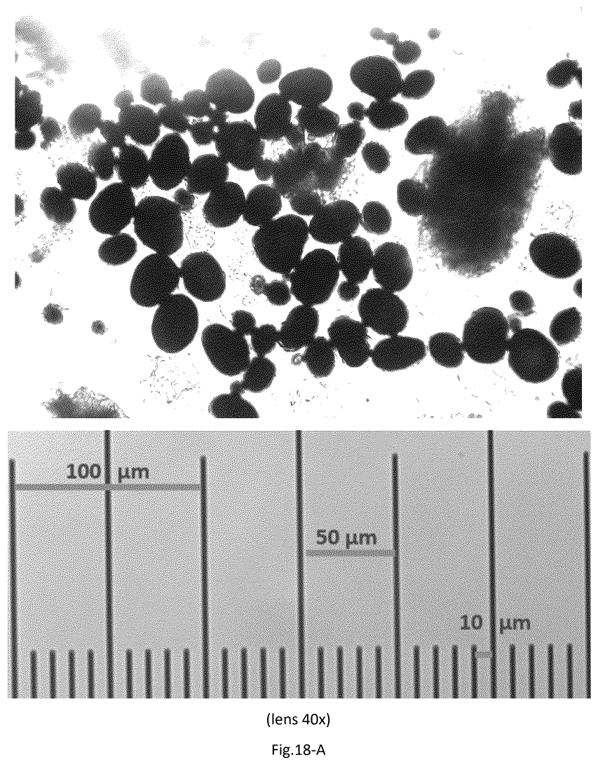

During this operation by the shaker sieve starch bodies were intercepted on the 20 μm mesh sieve ((X)—FIG. 17A) and protein bodies, protein and fibers were intercepted in the reservoir ((Y)—FIG. 17A). The collected fraction were mixed with Lugol dye (starch coloring) wherein Lugol in the fraction intercepted on the 20 μm mesh sieve colored the starch bodies (FIG. 17B panel I) but not in the fraction collected in the reservoir under the 20 μm mesh (FIG. 17B panel II). This fraction colored for protein by the Bradford dye (FIG. 17B panel III).

Dry hulled chickpeas have a starch concentration of about 42-44% and a protein concentration of about 19-23% and de-hulled chickpeas have starch concentration of about 45-50% and a protein concentration of about 25-28%. When from the de-hulled chickpeas only the starch bodies are removed according to the above-described process a protein concentrate is obtained of about 56% protein.

Based the microscopic images with microscopic measuring scale of the chickpea slices and the separated starch bodies and protein bodies is for these chickpeas An estimated starch granule size range (μm) and protein body size range (μm), is respectively 20-50 and 1.5-3.0.

Also the microscopic imaging with dye coloring confirmed the macroscopic imaging that the moistening method allows one to enrich starch bodies in a fraction and to enrich protein in another fraction. In FIG. 18A is provides a microscopic image (lens 40×) of the fraction that is intercepted on the 20-μm mesh sieve and is colored by Bradford dye and Lugol dye. And in FIG. 18B a microscopic image (lens 40×) is provided of the fraction that passed the 20-μm mesh. There are no starch bodies in this fraction and the protein bodies are show. They are considerable smaller than starch bodies. Using the microscopic imaging of samples one can optimize the crushing, milling and mesh size of the sieves to optimize the separation.

Example 11-e pulverizing and grinding of the chickpeas that were dried with heated air circulation and airflow over the chickpeas and their seed coat facilitate moisture evaporation in a drying chamber (convection oven of LG Electronics of South Korea) at 60° C. for 4 hours. This dried chickpeas and their seed coat matter were directly grinded by an electric blade grinder KG210 (Delonghi) with grind setting fine “fine” in a cup with a single stainless-steel blade. The starch bodies and starch bodies clusters were visualized by Lugol dye and the protein fraction by Bradford Dye.

As demonstrated by the microscopic images in FIG. 24A (oven dried chickpea—Lens 10×—Bradford dye for protein—after first grind) when the heated air circulation dried chickpeas from the aqueous sodium bicarbonate solution treatment were grinded according to Example 11-a and Example 11-e, cells and proteins bodies surrounding the starch bodies gradually will release undamaged starch bodies from the cells. In FIG. 24B (convection oven dried chickpea—Lens 10×—Lugol dye for starch—after further grind) is shown that the majority of the starch bodies are released from the cells and mixed with well wall debris and protein bodies (individual starch bodies are not visible at this enlargement).

### Example 12

Each apart, different whole pulse with seed coat (chickpeas, fava beans, common beans, and yellow peas) were treated in a 5% sodium bicarbonate solution according to the following manner.

1-300 gram dry pulses with seed coat were added to 1500 ml of a 5% sodium bicarbonate in portable tap water solution in a Thermomix TM6 bowl and at a temperature of 60° C. gently stirred (speed 1.5) for 2 hours. The solution was removed and the pulses and their seed coat were collected on a test sieve (mesh S-steel, ISO 3310/1 body Ø200×50 mm) of Retsch Germany with a mesh size of 300 μm. Consequently, these pulses and their seed coats in the sieve was rinsed under a stream of tap water.

2—These pulses and their seed coats were replaced in a 1500 ml of a 5% sodium bicarbonate in portable tap water solution in a Thermomix TM6 bowl and at a temperature of 60° C. gently stirred (speed 1.5) for additional 2 hours. The solution was removed again, and the pulses and their seed coat were collected on a test sieve (mesh S-steel, ISO 3310/1 body Ø200×50 mm) of Retsch Germany with a mesh size of 300 μm. Consequently, these pulses and their seed coats in the sieve was rinsed under a stream of tap water.

3—And these pulses and their seed coats were replaced in a 1500 ml of portable tap water in a Thermomix TM6 bowl and at a temperature of 60° C. gently stirred (speed 1.5) for an additional 2 hours. These pulses and their seed coat were collected on a test sieve (mesh S-steel, ISO 3310/1 body Ø200×50 mm) of Retsch Germany with a mesh size of 300 μm and were rinsed under a tap water stream.

4—These pulses and their seed coats were replaced again in a 1500 ml of portable tap water in a Thermomix TM6 bowl and at a temperature of 60° C. gently stirred (speed 1.5) for an additional 2 hours. These pulses (cotyledon & embryo) and their seed coat after the bicarbonate treatment were collected on a test sieve (mesh S-steel, ISO 3310/1 body Ø200×50 mm) of Retsch Germany with a mesh size of 300 μm and were rinsed under a tap water stream to obtain (see FIG. 19).

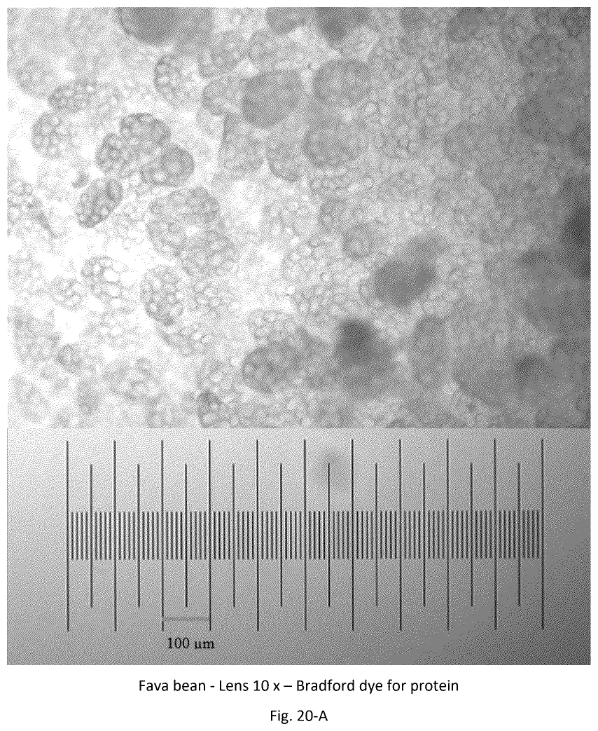

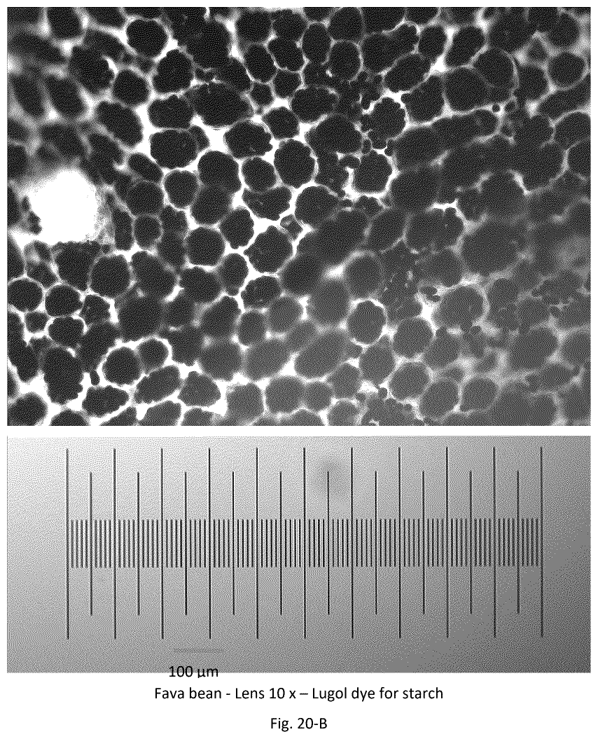

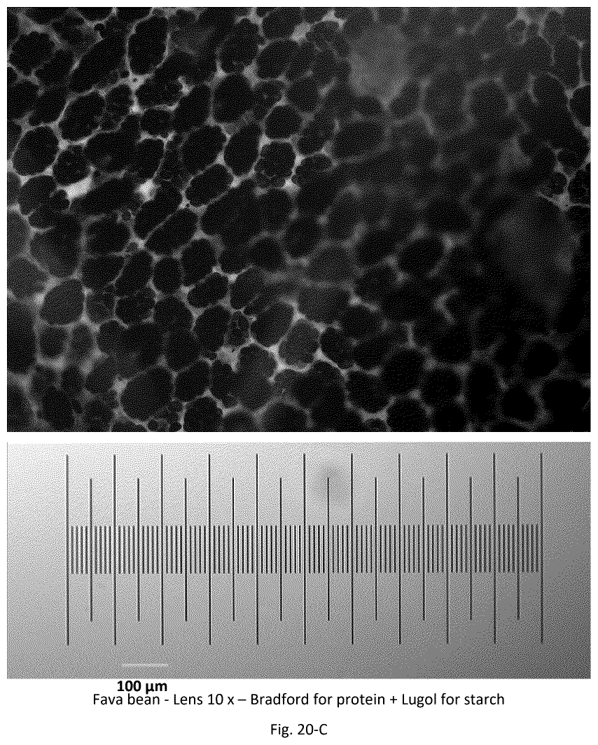

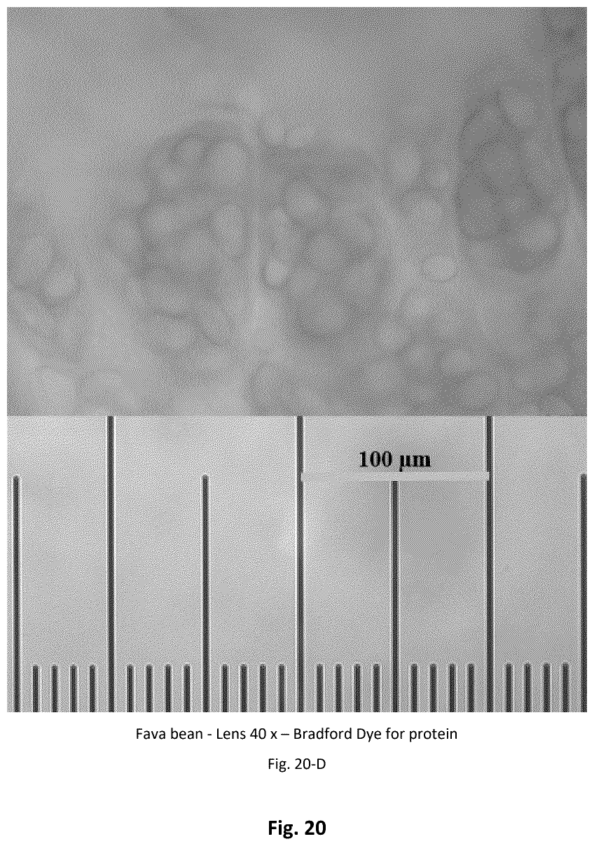

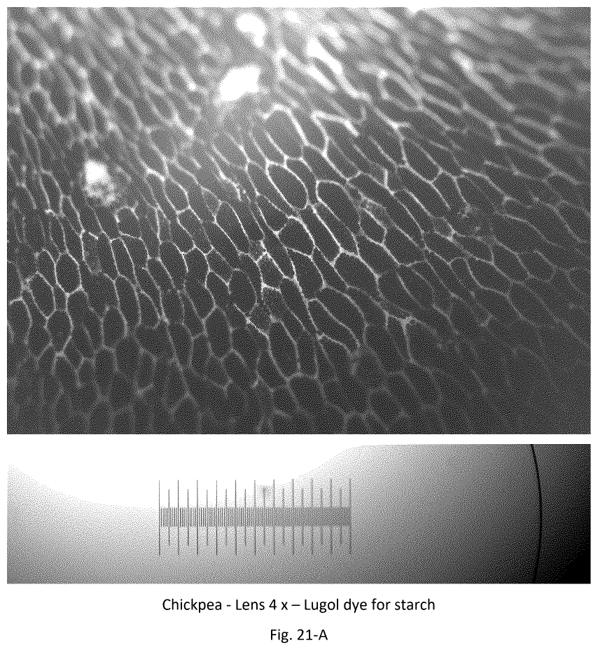

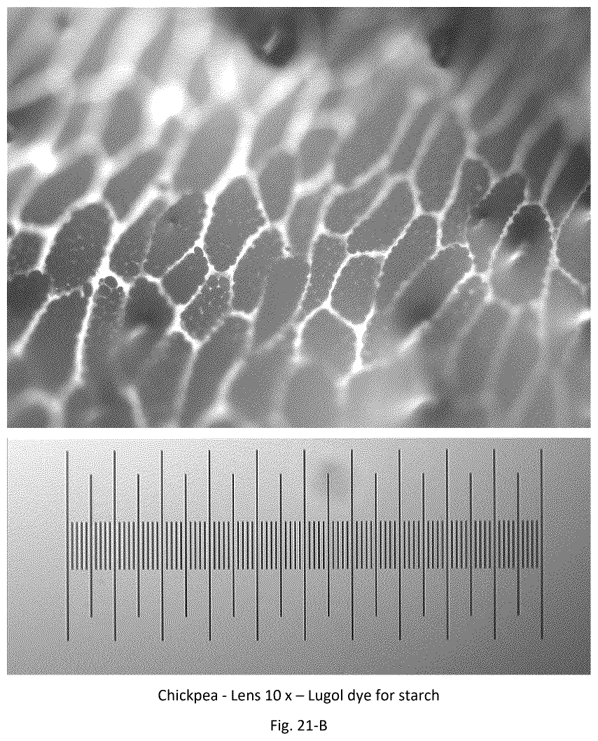

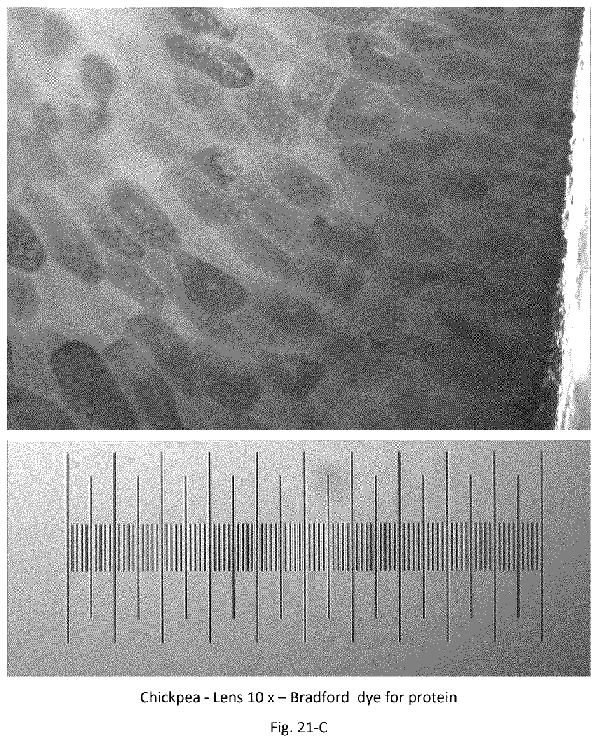

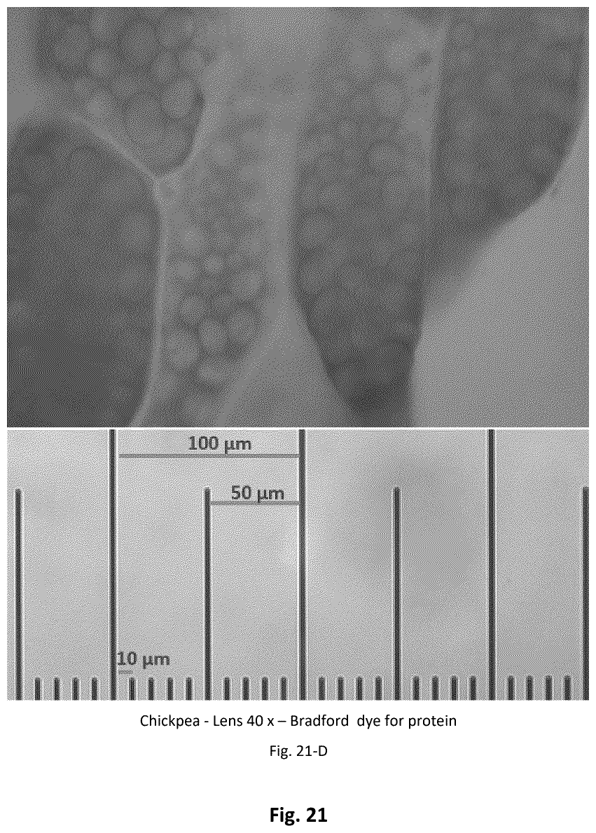

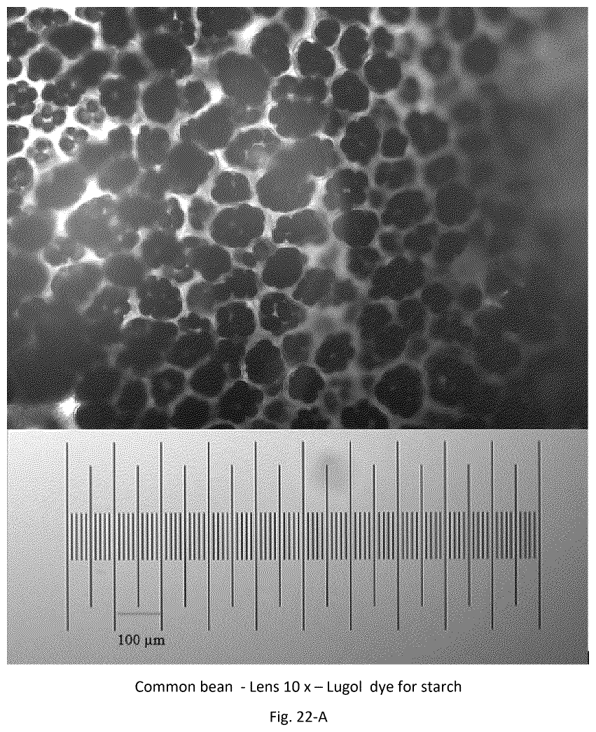

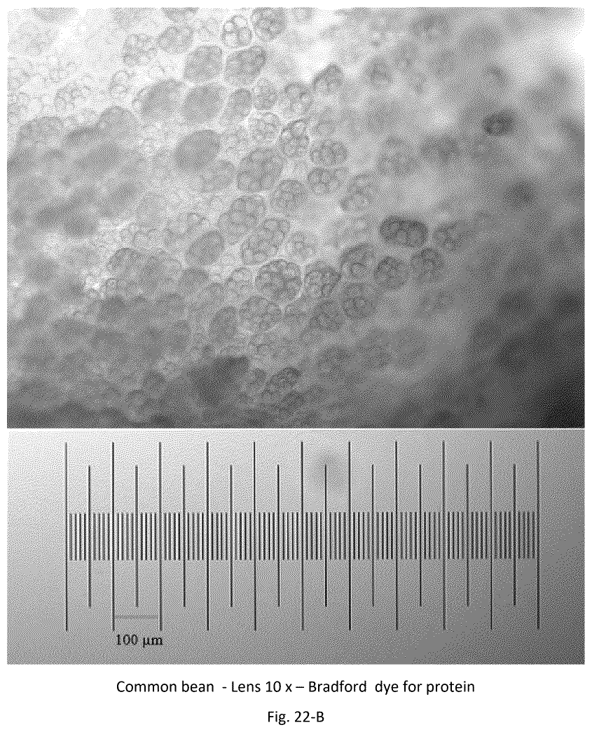

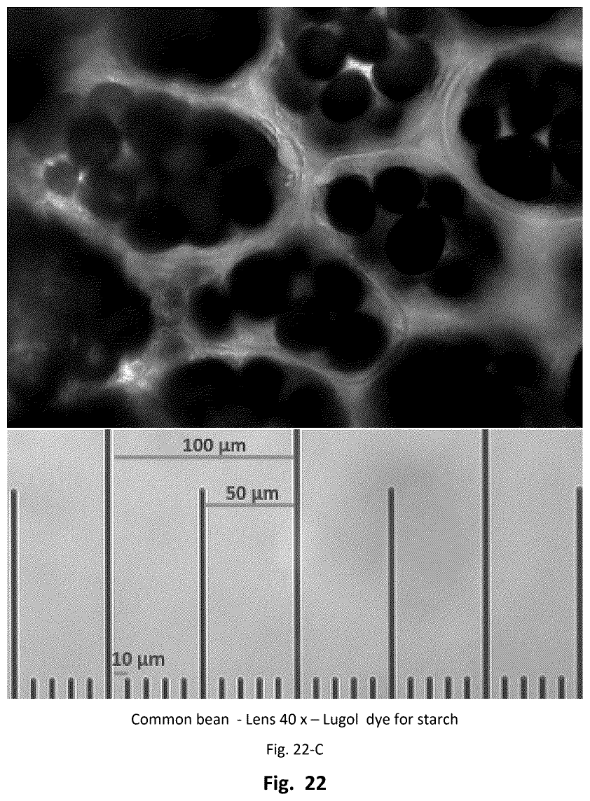

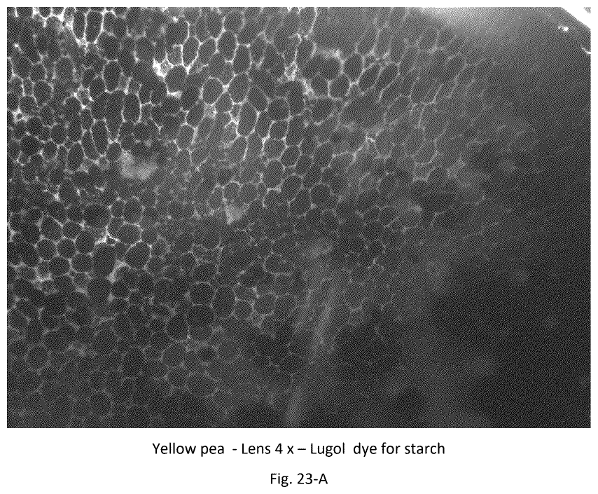

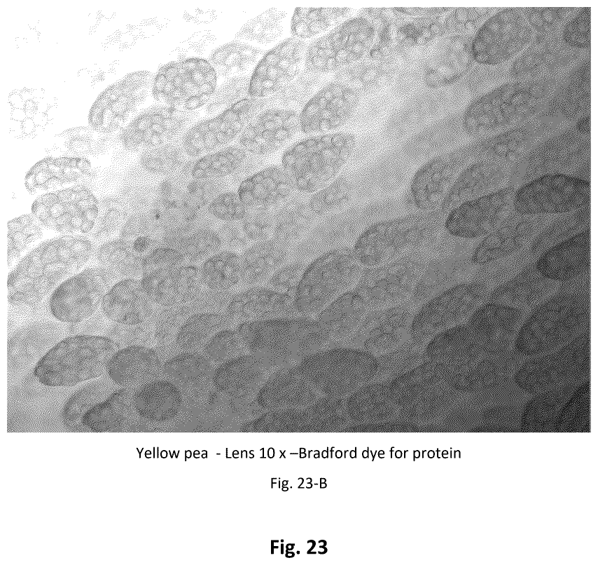

5—Thin slides cut with a scalpel blade of the cotyledon/embryo colored with Lugol and with Bradford. Images of these were made under the microscope. As earlier, describe microscopic compliance used were Lugol solution (BCCK7440 62650-IL-F—Sigma-Aldrich (hereinafter-called Lugol or Lugol Dye)) and Bradford Coomassie brilliant blue G-250 dye (Bradford Dye Reagent liquid Cat. No: J61522.AP of Thermoscientific Germany (hereinafter called Bradford Dye)) protein-binding dye and microscopic visualized with VisiScope series 200 (VRW Avantor (BE), microscope with 4 lenses (10S N-Plan 100×/1.25 OII/water ∞/0.17 (hereafter called lens 100×), 10SN—Plan 40×/0.65 ∞/0.17 (hereafter called lens 40×), 10SN—Plan 10×/0.25 ∞/0.17 (hereafter called lens 10×) and 10 SN—Plan 4×/0.10 ∞/− (hereafter called lens 4×)) and with Image Focus plus software of Euromex, NL. As microscopic measuring scale, Objective Micrometer MA285×. 1/100 (0.01 mm) of Meiji Techno Japan was used. As displayed in FIG. 20A to FIG. 23B the cellular structures of cell walls surrounding protein bodies and their starch bodies remained intact in the chickpeas, fava beans, common beans, and yellow peas under the conditions of the sodium bicarbonate solution treatment process.

### Example 13

Example 13-a Whole yellow peas treatment by a sodium bicarbonate solution for tasting. Whole yellow peas with seed coat (dry whole hulled yellow peas) were treated in a 5% sodium bicarbonate solution according to the following manner.

1-300-gram dry yellow peas with seed coat were added to 1500 ml of a 5% sodium bicarbonate in portable tap water solution in a Thermomix TM6 bowl and at a temperature of 60° C. gently stirred (speed 1.5) for 2 hours. The solution was removed, and the yellow peas and their seed coat were collected on a test sieve (mesh S-steel, ISO 3310/1 body Ø200×50 mm) of Retsch Germany with a mesh size of 300 μm.

2—Skipping the portable freshwater rinse step these yellow peas and their seed coats were add to a new 1500 ml of a 5% sodium bicarbonate in portable tap water solution in a Thermomix TM6 bowl and at a temperature of 60° C. gently stirred (speed 1.5) for an additional 2 hours. The solution was removed again, and the yellow peas and their seed coat were collected on a test sieve (mesh S-steel, ISO 3310/1 body Ø200×50 mm) of Retsch Germany with a mesh size of 300 μm.

3—Skipping the portable freshwater rinse step these yellow peas and their seed coats were replaced in 1500 ml of portable tap water in a Thermomix TM6 bowl and at a temperature of 60° C. gently stirred (speed 1.5) for an additional 2 hours. These yellow peas and their seed coat were collected on a test sieve (mesh S-steel, ISO 3310/1 body Ø200×50 mm) of Retsch Germany with a mesh size of 300 μm.

4—Skipping the portable freshwater rinse step, these yellow peas and their seed coats were placed again in a 1500 ml of portable tap water in a Thermomix TM6 bowl and at a temperature of 60° C. gently stirred (speed 1.5) for an additional 2 hours. These yellow peas (cotyledon & embryo) and their seed coat after the bicarbonate treatment were collected on a test sieve (mesh S-steel, ISO 3310/1 body Ø200×50 mm) of Retsch Germany with a mesh size of 300 μm.

Example 13-b Treatment only by portable freshwater (tap water). Another batch of whole yellow peas with seed coat (dry whole hulled yellow peas) were treated on the same way as in Example 13 A, with the difference that only portable freshwater (tap water) had been used for this entire process (and no sodium bicarbonate) solutions.

Example 13-c Sensory Analysis. Scores given by a panel of taste testers (10 individuals) for the absence of taste attributes.

The taste panel had been trained by tasting a reference product of yellow peas (with seed coat) that was incubated for 24 h at refrigeration temperature of about 4° C. in pasteurized tap water (200 gram of yellow peas per 1 liter of water) and this reference product was given a flavor intensity score of 10 to compare they two yellow pea batches (of example 13-a and example 13-b). The taste panel evaluated the intensity of the samples for the attributes: tasteless (0) to 10 (test of the reference product), respectively. Scores from all 10 taste testers for each attribute were averaged for each sample. These average scores are presented in Table 6 for ease of recognition the sample prepared according of example 13-a and that prepared according to Example 13-b is called, “S-Carbonate” and “S-Water.”

The average score for “S-Carbonate” was 3.1 and “S-Water” was 4.1 versus the reference cold-water incubation with 10 score. Only for “S-Water,” there was a remark that it caused a pea-aftertaste

### Example 14 Pre-Treatment of Yellow Pea Pulses Under Various Conditions (as Displayed in Tables 7 and 8 and Fermentation by the Kefir Vegan Ferment and the Vegan Yogurt Ferment

Pre-treatment is carried out in a bowl of a Thermomix under gentle stirring (speed 1.5) each time with 250 grams of dry yellow pea pulses in a 1.5-liter volume at 60° C. Consequently, halve of the whole pulses (suspended into a pasteurized 5% cane sugar watery solution in a sterile and sealable glass jars (preserving jars) had been anaerobically fermented at 22° C. The fermentation with vegan yogurt starter culture was 14 days and the fermentation with vegan kefir starter culture was 7 days. The other half of the pulses had been stored in a food freezer. The batches of both the not fermented and fermented pulses have been freeze-dried and divided into small test vials with a number or letter mark for blinded taste and texture (mouthfeel) testing. Results and more detailed treatment conditions are displayed in Table 7 (A &B) and table 8 (A&B).

Sulphur, bitter, metallic, and cardboard are favor attributes that are generally considered repellent. Green/grassy, earthy, pungent are content dependent. But in the context of pulses for further processing into pulse flours or into separate items such as pulse protein, starch, fibers or derived food items such as non-dairy (vegan dairy) etc., they are to be avoid and are considered repellent. Honey-like, cucumber, citrus-like, salty, nutty are generally considered tasty. The overall flavor removal was also investigated.

Analyzing the treatment conditions, surprising findings are that without fermentation (non-fermented (nf)) the least repellent flavor attributes (repellent score of 0) is obtained for the combination of is BC+ZC+IN (Group 94). Zinc and/or iron can thus be an additive to enhance or guarantee the BC effect. BC+ZC+IN is not the only with a repellent score of zero in combination with a non-fermented (nf) Several other treatment groups gave a repellent score of 0 in this combination, including: BC+CL, BC+MC, BC+CC, BC+CS+CL+CC+MC, BC and BC+CS. The results suggest that these additives can be used along with BC to remove the repellent flavors from pulses. The results also demonstrate the powerful effect of BC of removing the repellent flavors. The treatment BC only has consistently lower repellent scores compared to CS+CL+CC+MC combination, thus without BC. Considering the overall flavor intensity, for the unfermented pulses the combination BC+ZC+IN (with (non-fermented (nf)) has the lowest overall flavor intensity (3.56) in the dataset. This combination is the best at decreasing the overall flavor among the options tested. Again, this surprisingly demonstrated that combining BC with IN (iron(ii)fumarate) and/or ZN (Zinc oxide) can enhance the overall flavor removal, at least in the dynamic setup that these pulses are mixed for an hour or more in such watery solution of 0.5% to 7% of BC with mg amount of iron or zinc. In the consequent fermentation context. The treatment BC+CL (calcium lactate) with kefir ferment fermentation (KF) provides the highest “honey like” flavor. In addition, the BC+CC (calcium carbonate) with KF provides also the highest “citrus like” flavor attribute. This combination of BC+CC with KF provides the highest “citrus like” flavor attribute while maintaining a significant “honey like” flavor attribute. This is interesting as BC+CC and BC+CL are also an effective repellent removal combination. These are thus an ideal treatment to remove repellent favors from pea pulses and to prepare this as a feedstock for fermentation by a Kefir ferment or a vegan Kefir ferment, where by in the pulse feedstock repellent flavor compounds are removed or suppressed so that the vegan ferment fermentation can provide non-disturbed flavor profiles from the selected ferments and produce non-dairy from pulses with a more natural dairy feel aroma profile.

Surprisingly the combination of pre-treatment BC+ZC+IN with treatment vegan yogurt ferment fermentation (YF) provides the highest “citrus like” flavor attribute. This combination of Treatment 1: BC+ZC+IN with the YF fermentation treatment provides the highest “citrus like” flavor attribute (3.8) while maintaining a significant “honey like” flavor attribute (2.2). On the other had the combination of pre-treatment BC with treatment YF provides the highest “honey like” flavor attribute. These (BC or BC+ZC+IN) are all powerful repellent flavor attribute removers.

The disclosure thus provides a way to remove negative repellent attribute flavor from pulses such as yellow pea and prepare these in a feedstock that by vegan yogurt fermentation provides pleasant dairy like flavor attributes.

Another surprising finding is that the combination of BC+CS+CL+CC+MC with treatment nf provides the term “intact” under the heading “status of the pulse.” This is also maintained after the fermentation with the vegan Kefir ferment. The conditions of such combination can this be adapted for a stable production of whole peas with a dairy feel. This flavor profile of pre-treatment BC+CS+CL+CC+MC with treatment 2: nf is as follows: Repellent Flavors (Sum): 0.0 (very low, indicating no strong negative flavors like sulfur, bitter, metallic, or earthy). Honey Like: 1.56 (moderate level). Citrus Like: 0.22 (low level). This treatment thus has an excellent profile in terms of low repellent flavors, a moderate honey-like flavor, but a relatively low citrus-like flavor. In contrast, this flavor profile of pre-treatment BC+CS+CL+CC+MC with treatment KF is as follows: Repellent Flavors (Sum): 0.0 (very low, indicating no negative flavors like sulfur, bitter, metallic, or earthy); Honey Like: 1.0 (moderate level) and Citrus Like: 3.8 (high level). This treatment has an excellent profile in terms of low repellent flavors and a strong citrus-like flavor, with a moderate honey-like flavor. It has a delicate (tender, light) to crunchy texture. General Mouthfeel impressions were acid milk: 1, neutral: 3, slightly acid: 2, pleasant: 2, milky: 1, dairy like: 1.

### Example 15

Results and further detailed treatment conditions on pulses are displayed in Tables 9 a & 9 B. The distinct treatment of the yellow pea pulses is so called dynamic or static. With dynamic is meant that dry pulses 200-gram (200 gram/1 liter) were at 60° C. stirred in either water or a sodium bicarbonate (BC) solution at 1%, 2.5% or 5% and a pH of 8.3 or a by HCL adjusted pH of lower pH (as in Table 9) or in water (0% BC). The stirring happens in a Thermomix bowl at 60° C. degrees while stirring at a low speed of speed 1.5 Washing is hereby carried out on the same way. There is a consequent rinse was of rinsing the pulses in a sieve under a water stream.

By static is meant that the dry pulses are put in either water or a BC solution (200 gram/liter) in a glass jar and incubated at either 20° C. or in refrigerator at 4° C. without stirring. Washing is for the BC groups hereby carried out by replacing the BC solution by water. There is a consequent rinse was of rinsing the pulses in a sieve under a water stream. The term “SC) means that at start of the treatment the dry pulses were with a seed coat. The term “SO SC” means that at start the seed coat of the yellow pea pulses had been removed (as indicated in table 9).

The “moving” treatment way lowers the repellant flavor attributes (sulfur, grassy, bitter, earthy, metallic, pungent) more effectively than the “static” treatment way, as the average values for these attributes are significantly lower in the “moving” treatment. The moving treatment and wash strikes a better balance, significantly reducing unpleasant sensory attributes while still delivering a high level of desirable flavors. Static methods amplify both the good and bad sensory characteristics is a drawback. “Moving” treatment is more effective at reducing repellant flavor attributes, making it a preferred method if the goal is to minimize undesirable tastes. If enhancing specific pleasant flavors like “cucumber” or “citrus like” is prioritized, “static” might have some advantages, but this comes at the cost of increased repellant flavors.

In the moving treatment increasing BC % strongly lowers repellant flavors, such as sulfur, grassy, and bitter, which improves the overall flavor profile by reducing undesired notes. It enhances the honey-like flavor, adding a pleasant sweetness to the taste. However, it reduces some pleasant attributes, such as nutty and cucumber flavors, indicating a potential trade-off.

While in this moving treatment the BC % has a clear positive impact, significantly reducing these undesirable flavors the BC % improves the “honeylike” flavor but decreases “nutty” and “cucumber” flavors, which might affect the balance. The average correlation across all taste compounds of −0.462 is indicated that on average, increasing BC % tends to reduce overall taste compound levels in the moving treatment. In contrast, in the static treatment, there is no clear or consistent relationship between BC % and the removal of repellant attributes. While some repellant flavors like grassy and bitter decrease with higher BC %, others, such as sulfur, earthy, and metallic, increase. This inconsistency highlights the static treatment's limitations in effectively managing repellant flavors compared to the moving treatment.

The moving treatment with BC is clearly the better method for removing repellant flavors compared to the static treatment. It provides more favorable results in reducing sulfur, grassy, bitter, earthy, metallic, and other undesired tastes. Hereby, the overall impact of the overall impact of pH is mild, with a slight tendency to increase flavor intensity.

### Example 16

For the foaming capacity (FC) 15 grams of freeze-dried pulse is add to 685 water and blended for 2 minutes in by a Thermomix TM6 in the Thermomix bowl at speed 10. To measure this FC the blended samples were poured into graduated beaker and the volume (mL) was measured at 0 min. The foaming capacity is measured as the percent increase in volume with the following formula: Foaming Capacity (%)=volume immediately after blending (mL)−volume without foam (mL)/volume without foam (mL)×100.

Such foaming capacity is an important indicator of functionality, particularly in food science and application.

Yellow peas (250 gram/1.5 liter) were in a Thermomix bowl of the TM6 stirred at speed 1.5 for 15 minutes at different temperatures and sodium bicarbonate % Details are in Tables 10 A and 10 B.

The foaming capacity is compared with yellow peas that have been taking up water (group DSi6 of Table 9)

For this very short (15 minutes) BC treatment, the results show how the percentage of BC and the treatment temperature impact the sensory attributes of the products, which can be grouped into two categories: repellent (undesirable) and tasty (desirable) flavors. Concerning the effects of BC % for this very short treatment it was observed that at 1% BC, the repellent attributes (e.g., sulfur, grassy, bitter) are generally lower than at 5% BC for the 90° C. temperature, suggesting that higher BC percentages amplify undesirable flavors at the higher temperature range. In contrast, at 60° C., the repellent attributes at 1% BC are higher than at 5% BC. Specifically, for 1% BC at 60° C., the repellent score is 0.89, which is slightly higher than the score for 5% BC at 60° C. (0.74). At 80° C., both 1% and 5% BC result in minimal repellent flavors, showing that temperature plays a role in suppressing repellent attributes. This contrasts with other temperatures like 60° C. or 90° C., where the BC percentage has a more noticeable impact.

At 60° C. the green/grassy attribute is slightly higher for 1% BC compared to 5% BC. This indicates that at a lower temperature (60° C.), increasing the BC percentage reduces the green/grassy off tone flavor. At 80° C. with 5% BC the green/grassy attribute further decreases compared to 1% BC. At 90° C. the green/grassy attribute is 0.00, effectively neutralized for both 1% BC and 5% BC. At such very short treatment time (15 minutes) 80° C. is an optimal treatment temperature and the % BC may be lower than 5%. For the short term treatment of 15 min. 70° C. with 5% BC provides the best result for minimizing green/grassy flavors among the compared conditions.

Temperature and BC percentage both play a role in reducing metallic flavors. For this short term treatment, the best reduction is observed at 70° C. with 5% BC, where metallic flavors are completely neutralized. The higher temperature alone (1% BC at 70° C.) does not effectively reduce earthy flavors. For this short term treatment, the combination of 70° C. and 5% BC is necessary to eliminate earthy flavors entirely.

While for the long-term treatment of 1 to 4 hours, it was previously demonstrated that in such moving treatment at 60° C. the BC % has a clear positive impact, significantly reducing these undesirable flavors, here it was demonstrated that at the higher temperatures this is not so. At 1% BC, the repellent attributes (e.g., sulfur, grassy, bitter) are generally lower than at 5% BC for the 90° C. temperature, suggesting that higher BC percentages amplify undesirable flavors at the higher temperature range. The best combination of BC % and treatment temperature (° C.) to achieve the least overall flavor intensity in this experiment was BC %: 1, Treatment Temperature: 90° C. with an Overall Flavor Intensity: 7.56.

The disclosed method allows taste removal or taste neutralization.

The best combination of BC % and treatment temperature (° C.) to achieve the least overall flavor intensity at a treatment temperature of 70° C. was a BC %: 5 (Overall Flavor Intensity: 10.22) and the best combination of BC % and treatment temperature (° C.) to achieve the least overall flavor intensity at a treatment temperature of 60° C. is a BC %: 5 (Overall Flavor Intensity: 13.43). Since the best protein functionality is maintained at lower temperatures, the 50° C.-70° C. temperature treatment range can be preferred, if the native functionalities of for instance, the pea components (e.g., starch and protein) have to be maintained. Apply regression modeling or approximate trends manually using the closest data points (e.g., from 60° C. and 70° C.) using use regression to estimate the optimal values suggest that the estimated optimal combinations for the least overall flavor intensity are at 50° C. a BC %: 5 (Estimated Overall Flavor Intensity: 14.87) and a 55° C.: a BC %: 5 (Estimated Overall Flavor Intensity: 14.05)

For the foaming capacity (FC) test a 15 gram of freeze-dried pulse is add to 685 water and blended for 2 minutes by a Thermomix TM6 in the Thermomix bowl at speed 10. To measure this FC the blended samples were poured into graduated beaker and the volume (mL) was measured at 0 min. The foaming capacity is measured as the percent increase in volume with the following formula: Foaming Capacity (%)=volume immediately after blending (mL)−volume without foam (mL)/volume without foam (mL)×100.

Such foaming capacity is an important indicator of functionality, particularly in food science and application.

In the table 10 B groups A4, A1, A15, A14, A5, A10, A2 and A3 are groups of BC treatments at a different % in water. The DSi1 group is a treatment with water at 0% BC. “FC %” stands for this the foaming capacity. In these experiments the BC treatments that came closest to DSi1 were A4 (1% BC at 60° C.): FC %=25.37% (difference=−3.41%) and A1 (5% BC at 60° C.): FC %=25.37% (difference=−3.41%)

While DSi1 (water-only treatment) still provides the best foaming capacity, the treatments 1% BC at 60° C. and 5% BC at 60° C. (at 60° C.) are the top BC treatments that approach DSi1's performance. Treatments above 70° C. A14 (5% BC at 70° C.) and A15 (1% BC at 70° C.) performed further away from DSi1, with larger differences in FC %.

The disclosure proses to concentrations for 0.5% to 5% BC in temperature ranges of 50° C. to 70° C. and preferably in ranges from 55° C. to 60° C. to treat pulse seed such as pea, fava, common bean and chickpea from repellent flavor or off tone removal while maximally maintaining the native functionalities or for maximally maintaining the cellular structures and bodies.

### Example 17

Table 11 A, B & C provides the treatment condition detailed conditions. It provides the concentrations of sodium bicarbonate and combinations with H₂O₂, ET and/or SG and the concentration of sodium bicarbonate used. The abbreviations H₂O₂ is hydrogen peroxide; SG is sodium gluconate, ET is erythritol, BC is sodium bicarbonate. Water only or a in water solutions of these compounds is used to incubate the yellow peas while stirring. This happens in the bowl of a Thermomix (TM6) 200 grams of whole dry peas are mixed while stirring at the speed 1.5 at 60° C. Table 11 also provides the time of such treatment. The concentration of sodium gluconate and erythritol was 2.5%. The concentration of H₂O₂ was 5%. The was step in the Thermomix bowl follows such in bowl treatment step. There are groups wherein the yellow peas were first dry treated in a glass cookware jar (Pyrex) with glass lid (Pyrex) at 260 watt for 10 minutes in a microwave (M dry roast). In case this is the first treatment before the in-solution treatment in the stirring Thermomix bowl. There are also two steaming treatments. M steam and T steam. These are treatments after the in-solution treatment in the stirring Thermomix bowl. The M steam treatment is of the yellow peas after treatment in the Thermomix in a microwave steaming bag at 900 watt for 4 minutes. The T steam treatment is in a steaming Basket (Simmering Basket) of the TM6 Thermomix for 40 minutes with water in the understanding bowl at 120° C. (Varoma function). Such T-steam temperature will typically stabilize around 100° C. or slightly lower within the yellow pea mass. Steaming with a Thermomix is representative for a convective heat transfer and latent heat transfer driven by the phase change of water from liquid to steam. The Thermomix heats water to its boiling point (100° C. at standard atmospheric pressure) or beyond (e.g., Varoma mode, around 120° C.) to create steam. The water undergoes a phase transition from liquid to vapor, absorbing latent heat of vaporization (approximately 2260 kJ/kg at 100° C.) without increasing in temperature. The steam generated is transported to the food via forced convection. As steam condenses on the cooler surface of the food, it releases its latent heat, directly warming the food. Over time, the food's surface temperature approaches the steam temperature, but the internal temperature will lag due to conduction limits. If the steaming duration is long enough, the food can reach thermal equilibrium close to the boiling point of water. This process ensures uniform cooking while preventing overheating.

The data analyzed demonstrate that overall, T steam reduce repellant flavors and enhance pleasant and tasty flavors like nutty and honey-like notes. This suggests that T steam an effective method for improving sensory profiles. The correlation analysis reveals the following effects of T steam time (in minutes) on flavor attributes. The negative Correlations (Repellant Attributes Decrease) are Green/Grassy (−0.547): Strong decrease; Metallic (−0.492): Moderate decrease; Bitter (−0.475): Moderate decrease; Pungent (−0.297): Weak decrease; Sulphur (−0.095): Very weak decrease. The positive Correlations (Pleasant Attributes Increase) are Honey-like (+0.614): Strong increase, Nutty (+0.681): Strong increase and Salty (+0.317): Moderate increase.

It was surprisingly found that the combination of T steam time and the BC additive creates a synergistic effect. The repellant flavors like bitterness and metallic notes are reduced more effectively with certain BC Additive levels. Pleasant flavors like nutty and honey-like notes can be enhanced by specific BC Additive concentrations during longer steaming processes. Concerning the repellant flavors (e.g., sulfur, green/grassy, and/or bitter) in groups with higher BC %, these attributes tend to have stronger negative correlations with T steam time. This suggests that higher BC % enhances the ability of steaming to reduce undesirable flavors. For the pleasant flavors (e.g., honey-like, nutty) there is a positive correlation. The enhancement may grow stronger with specific BC % values, implying that BC can amplify the ability of steaming to boost desirable flavors. Increasing BC Additive % (e.g., from 0% to 2.5%) improves the reduction of green/grassy notes and enhances nutty and honey-like flavors. However, the higher BC % might slightly reduce attributes like cucumber and citrus-like. 0% BC (Group D) achieves balanced flavor reduction and enhancement with no repellant notes and moderate pleasant flavors. The 2.5% BC (Group T): Further reduces grassy notes and amplifies nutty and honey-like attributes but slightly compromises cucumber and citrus-like flavors. In combination with T steaming the 1% BC additive: enhances pleasant flavors like honey-like, nutty, and cheesy, with minimal repellant flavors. The 1% BC is more effective for enhancing pleasant flavors and minimizing repellant ones, making it preferable for sensory improvement.

Concerning the effect of the extra additives ET, H₂O₂, SG or H₂O₂+SG in the T steaming with and without BC the following is observed. Without BC Additive (0% BC), H₂O₂ performs better in reducing repellant flavors compared to SG. Both additives maintain high pleasant flavors like honey-like and nutty. With BC Additive (2.5% BC): ET provides a balance of reducing repellant flavors while enhancing pleasant ones. H₂O₂+SG is the most effective at eliminating repellant flavors but slightly compromises on cucumber and citrus-like notes. It is important to stress that these observations are in combinations with convective heat transfer steaming such as this T steaming of the experimental set up. Because apparently; H₂O₂ does not always reduce flavors like green/grassy, bitter, earthy, and metallic. In some cases (e.g., bitter and earthy), these notes are slightly higher when H₂O₂ is used compared to the overall data set. While H₂O₂ is effective in completely removing sulfur, its impact on other repellant flavors is mixed. It requires combination treatments such as this steaming to achieve a more consistent reduction in all repellant flavors.

A combination (2.5% BC and 10 minutes dry roasting) creates a flavor profile with low repellant notes, making it a promising process for enhancing sensory quality.

H₂O₂. It appears that there are no conditions in the dataset where SG completely eliminates all repellant flavors (i.e., sulfur, green/grassy, bitter, earthy, metallic, and pungent). SG performs best in reducing repellant flavors during T steaming for 40 minutes, even without roasting (M dry roast time=0). In this condition, all major repellant flavors (bitter, earthy, metallic, pungent, sulfur) are eliminated, while green/grassy is reduced significantly (0.3). Erythritol (ET performs best in reducing or eliminating repellant flavors during T steaming for 40 minutes without roasting (M dry roast time=0). Without steaming or roasting, ET has a partial effect, significantly reducing sulfur and earthy notes but leaving moderate levels of green/grassy and bitter flavors.

Concerning the overall flavor reductions, the combination of T steaming for 40 minutes and M dry roasting for 10 minutes achieves the lowest overall flavor intensity while minimizing repellant flavors and retaining moderate levels of pleasant flavors.

BC Additive (5%) performs best in reducing repellant flavors without T steaming, achieving the lowest overall intensity. 2.5% BC Additive offers reductions but is less effective compared to 5%. Without BC (0%), repellant flavors remain high, particularly green/grassy and bitter notes.

If the focus is on the maintained foaming capacity functionality (FC), the treatment temperature that provides the highest foaming capacity (FC %) is 60° C., with an FC % of 25.37%. The 1% BC additive provides the best foaming capacity, outperforming both lower (0%) and higher (2.5% and 5%) concentrations.

Concerning the convention steaming (T steaming) and microwave steaming (M steaming) it turns out that T steaming (40 minutes) is less harmful to foaming than steaming (4 minutes) in the microwave. Microwaves reduce the overall foaming capacity drastically. If flavor reduction with maintained native functionalities is the choice the in-water treatment and convention steaming or a combination thereof is the choice.

Surprisingly, it was found that after T steaming with 1% BC and the 5% BC treated peas (freeze-dried), stable emulsions could be generated by blending in the Thermomix bowl (speed 10, 15 gram sunflower oil, 15-gram pea powder and 670 ml water) with a uniform distribution of droplets <10 μm after 48 hours at room temperature. FIGS. 25 and 26 display the microscopic image (lens 10×) of the 83 and 80 treatment Table (see table 11 A, B & C) condition (T steam) of this example. Dry microwave dry roasting, however, significantly reduced foaming capacity. FIG. 27 is the microscopic image of an emulsion made with freeze-dried yellow peas that were subject to a 24 hour incubation in water only (in refrigerator) and subsequently have been freeze-dried. A 15 gram fraction thereof was subjected to the same emulsification protocol The microscopic visualization is with a VisiScope series 200 (VRW Avantor (BE) microscope with 4 lenses (10S N-Plan 100×/1.25 OII/water ∞/0.17 (hereafter called lens 100×), 10SN—Plan 40×/0.65 ∞/0.17 (hereafter called lens 40×), 10SN—Plan 10×/0.25 ∞/0.17 (hereafter called lens 10×) and 10 SN—Plan 4×/0.10 ∞/− (hereafter called lens 4×)) and with Image Focus plus software of Euromex, NL. As microscopic measuring scale, Objective Micrometer MA285×. 1/100 (0.01 mm) of Meiji Techno Japan was used.

Taste testers had been extensively trained on flavor notes of cheesy, sulfur, honey-like, green and grassy, earthy, nutty, salty, pungent, metallic, cucumber, citrus-like and bitter with different dried natural produce that are each of these flavor notes. All taste test have been carried out on unidentified samples that are marked by a letter or number code. From example 14 on score are provide to the flavor attributes in a scale from 1 to 10 and the tester are asked to mention under a section “Additional Comments” if the find the produce pleasant or unpleasant. Or if they recognize a flavor that is not on the score table. They also have also been trained to recognize textures on dried food items with a texture classification as follows: For Harder Textures: —Crunchy: This is a common term for foods with a crisp, brittle texture. —Chewy: This term describes foods that require more effort to chew, often due to a tough or fibrous texture. —Hard: This is a general term for foods that are difficult to bite through. For More Delicate Textures: Flaky: This term is often used to describe foods that break apart easily into small pieces. —Tender: This describes foods that are soft and easily chewed. Light: This term suggests a food that is not overly heavy or dense. Of these textures it has to be marked, which is applicable.

### Example 18

A Vorwerk Thermomix TM6 was used to continuously stir in its bowl in water or an aqueous solution field-dried yellow peas with seed coat (100 gram/liter). Such Thermomix has a “left turn” stir function, which is useful for gently stirring ingredients. The yellow peas were stirred with this “left turn” stir function. Hereby the stir speed was on setting “Soft/Stir” (speed 1 or 100 rpm). This continuous moving treatment is hereafter called dynamic or stirring or mixing. The compounds (such as BC, MC, CC, CL, CS, iron and zinc) added at to certain concentration in the water or an aqueous solution to treat the pulses, the treatment time and the treatment temperature for each treatment condition is explained in table 12. A constant high temperature treatment (80° C.) during a short time of 60 minutes was preferred. So, this treatment was carried out, while for 60 minutes stirring the yellow peas in the aqueous medium at a constant temperature of 80° C. The focus was on material recovery. Protection against leaching from the pea material into the aqueous medium was measured by comparing the end weight of the pea material recovered. The water used was tap water. As shown in Table 12 in all groups the yellow peas were 100 g/L subjected to continuous stirring (speed 1) at a temperature of 80° C. and for 60 minutes. After each treatment the pea material of each treatment group was rinsed washed in a 400 mesh (38 μm opening size (μm)) sieve under a tap water stream at 22° C. for 10 minutes. The recovered weight on the sieve of pea material from all other groups was compared with the control C1 treatment group (5% sodium bicarbonate (weight/weight percent (w/w %)) only. In all groups the aqueous medium was water with 5% sodium bicarbonate (weight/weight percent (w/w %)). In the control group (C1) the aqueous medium was water with 5% sodium bicarbonate (weight/weight percent (w/w %)) without addition of another substance. In test group (C2) the aqueous medium was water with 5% sodium bicarbonate (weight/weight percent (w/w %) and 2% calcium chloride (weight/weight percent (w/w %)). In another test group (C3) the aqueous medium was water with 5% sodium bicarbonate (weight/weight percent (w/w %) and 2% calcium sulfate (weight/weight percent (w/w %)). In yet another test group (C4) the aqueous medium was water with 5% sodium bicarbonate (weight/weight percent (w/w %) and 2% calcium lactate (weight/weight percent (w/w %)). Table 12 provides an overview of treatments and measured data. And FIG. 28 (referring to Table 12) provides a graphic display of results. Abbreviations are used in tables and graphics. CS means calcium sulfate (CaSO₄ (calcium sulfate), a salt of the bivalent cation calcium), CL means calcium lactate, Ca(C₃H₅O₃)₂ (calcium lactate) a salt of the bivalent cation calcium and CC means calcium chloride, CaCl₂) (calcium chloride) a salt of the bivalent cation calcium. BC means sodium bicarbonate (NaHCO₃) and MC means magnesium chloride (MgCl₂).

### Example 19

A Vorwerk Thermomix TM6 was used to continuously stir in its bowl in aqueous medium field-dried yellow peas (100 gram/liter). Such Thermomix has a “left turn” stir function, which is useful for gently stirring ingredients. The yellow peas were stirred with this “left turn” stir function. Hereby the stir speed was on setting “Soft/Stir” (speed 1 or 100 rpm). Hereafter this stir operation is called dynamic or stirring or mixing treatment. A constant high temperature treatment (80° C.) for a time of 200 minutes (3.3 hours) was preferred. The focus was on the material recovery effect of the treatment on material recovery or protection against leaching of the pea material into the aqueous medium. The water used was tap water. As shown in table 13 in all groups the yellow peas were 100 g/L subjected to continuous stirring (speed 1) at a temperature of 80° C. and for a time of 200 minutes. After each treatment the pea material of each treatment group was put again in a bowl of Vorwerk Thermomix TM6 to continuously stir in its bowl in 1 liter tap a water at 60° C. and on setting “Soft/Stir” (speed 1 or 100 rpm) for 100 minutes and thereafter it was collected on a 400 mesh (38 μm opening size (μm)) stainless steel sieve. The recovered weight from all other groups was compared with the C5 treatment group (5% sodium bicarbonate (weight/weight percent (w/w %)) only in all groups the aqueous treatment medium was water with 5% sodium bicarbonate (weight/weight percent (w/w %)). In a group (C5) the aqueous medium was water with 5% sodium bicarbonate (weight/weight percent (w/w %)) without addition of another substance. In another group (C6) the aqueous medium was water with 5% sodium bicarbonate (weight/weight percent (w/w %) and 280 mg iron (iron (II) fumarate)+100 mg zinc (zinc oxide) per liter water. In another group (C7) the aqueous medium was water with 5% sodium bicarbonate (weight/weight percent (w/w %) and 1% magnesium chloride (weight/weight percent (w/w %)). In yet another group (C8) the aqueous medium was water with 5% sodium bicarbonate (weight/weight percent (w/w %) and 1% calcium lactate (weight/weight percent (w/w %))+1% calcium sulfate (weight/weight percent (w/w %))+1% calcium chloride (weight/weight percent (w/w %)). Abbreviations are used in tables and graphics. CS means calcium sulfate (CaSO₄ (calcium sulfate), a salt of the bivalent cation calcium), CL means calcium lactate, Ca(C₃H₅O₃)₂ (calcium lactate) a salt of the bivalent cation calcium and CC means calcium chloride, CaCl₂) (calcium chloride) a salt of the bivalent cation calcium. BC means sodium bicarbonate (NaHCO₃) and MC means magnesium chloride (MgCl₂).

### Example 20

A Vorwerk Thermomix TM6 was used to continuously stir field-dried yellow peas (100 gram/liter) in its bowl in aqueous medium. Such Thermomix has a “left turn” stir function, which is useful for gently stirring ingredients. The yellow peas were stirred with this “left turn” stir function. Hereby the stir speed was on setting “Soft/Stir” (speed 1 or 100 rpm). There were 22 different treatment groups (A to V under the heading “Group” in table 15. The full treatment descriptions for each group (A-V) in the displayed table 15. Each row summarizes the treatment composition and conditions, including percentages of added components (like BC, CC, MC), minerals (iron and zinc), processing method (stirred or static soak), time, and temperature. After each treatment the pea material of each of the stirring treatment group was put again in a bowl of Vorwerk Thermomix TM6 to continuously stir in its bowl in 1 liter tap a water at 60° C. and on setting “Soft/Stir” (speed 1 or 100 rpm) for 100 minutes and thereafter it was collected on a 400 mesh (38 μm opening size (μm)) sieve. Table 15 provides data on off-tone taste panel testing on the dried (freeze-dried) pea material of only the first 14 treatments (Groups A to N). Table 15 provides the off-tone taste panel testing on all 22 different treatment groups (A to V under the heading “Group”).

As can be seen in the respective Tables 14 and 15, the clusters of treatments are groups A-D: Stirred, sodium bicarbonate dose response where by A is a control with no sodium bicarbonate (0%), stirred at 60° C. for ˜3.3 hours, B is 2.5% sodium bicarbonate, stirred at 60° C. for ˜3.3 hours, C is 5.0% sodium bicarbonate, stirred at 60° C. for ˜3.3 hours and D is 10.0% sodium bicarbonate, stirred at 60° C. for ˜3.3 hours. They share the treatment temperature, stirring treatment and treatment time. Only the concentration of sodium bicarbonate in the treatment water (weight/weight percent (w/w %)) varies. These treatments isolate the effect of increasing sodium bicarbonate concentration under identical thermal and mixing conditions.

The cluster “groups E-G” (Static soak, sodium bicarbonate dose response) concern E a control with no sodium bicarbonate (0%), static soak at 22° C. for 12 hours, F a 2.5% sodium bicarbonate, static soak at 22° C. for 12 hours and G a 5.0% sodium bicarbonate, static soak at 22° C. for 12 hours. So, they all share treatment time, treatment temperature and are all soaked without continuous stirring. The variation is the sodium bicarbonate concentration in the treatment water (weight/weight percent (w/w %)). These examine the impact of passive soaking (no stirring) at ambient temperature with different sodium bicarbonate doses.

Groups H (5% BC), I (0% BC), and J (2.5% BC) are treated by static soak for a longer period of 24 hours at ambient temperature. So, these share treatment time, treatment temperature and treatment condition of no continuous stirring of the pea material, but a soaking. The only variation is the sodium bicarbonate concentration in the treatment water. (weight/weight percent (w/w %)).

The groups K-N are stirred with 5% sodium bicarbonate in the treatment water (weight/weight percent (w/w %)) for the same treatment time and a temperature range is tested from low 20° C. to high 80° C.

The groups O-V are stirred with 2% sodium bicarbonate in the treatment water (weight/weight percent (w/w %)) at a temperature of 55° C. and for 3.3 hours or 2.5% sodium bicarbonate in the treatment water (weight/weight percent (w/w %)) at a temperature of 75° C. and for 1.7 hours, respectively. For each there is a combination of sodium bicarbonate with iron/zinc, or with calcium chloride/calcium lactate, or with magnesium chloride or with calcium chloride/calcium lactate/magnesium chloride as displayed in table 15.

The headings per column are 1) “Group” this is the label for each treatment group (A to V), 2) “Treatment BC %” this is the percentage of a treatment the agent sodium bicarbonate (weight/weight percent (w/w %)) on the water, 3) “Treatment CC %” concerns the percentage of calcium chloride(weight/weight percent (w/w %)) on the water, 4) Treatment CL %” concerns the percentage of calcium lactate (weight/weight percent (w/w %)) on the water, 5) “Treatment Iron mg” concerns a group wherein iron added in milligrams per liter water, 6) “Treatment Zinc mg” concerns a group wherein zinc added in milligrams per liter, 7) Treatment MC % concerns a treatment group where magnesium chloride is add at the indicated % (weight/weight percent (w/w %)) on the water, 8) “Treatment process” concerns a treatment whether the sample of yellow pea in water or the aqueous water solution was either stirred or static soaked, 9) the heading “Treatment process time hours” indicates the duration of treatment in hours, 10) the heading “Treatment process temperature ° C.” provides the temperature during treatment in degrees Celsius, 11) the heading “Off Tone Intensity Scale 1-10 Average” provide the average off-tone intensity score from six panelists, using a 1-10 sensory scale per ISO 13299:2016: 1=nil, 3=slight, 5=moderate, 7=strong and 10=extreme and 12) the heading “Off Tone Intensity Scale 1-10 Standard deviation” concerns the standard deviation of the off-tone intensity scores, showing variation across panelist responses. Part of the treated pea material (from the groups A to N) was freeze-dried for panel taste testing on this dry product (see table 14). In contrast, pea material from the treatment groups A to V were not dried after treatment and had been panel taste tested as a wet product (see table 15).

The tasting test (see Table 14) on the dry yellow pea material is used for key variables for comparison and to assess treatment effectiveness at reducing off-tones. Key variables are, for instance, “Treatment BC %”: % of treatment agent (e.g., 0%, 2.5%, 5%, 10%), “Treatment process”: “stirred” vs. “static soak” and “Off-Tone Intensity (Average of six blind tastings): a lower score is better, and a higher score is worse (scale 1=no off-tone, 10=extreme off-tone). It can be observed for the stirred treatments at 60° C. for ˜3.3 hours that increasing BC % from 0 to 10% reduces off-tone intensity from ˜2.33 to ˜1.29 (a neglectable level). This very interesting if one wants to fraction such treated dry peas into starch, protein or fiber concentrates or isolates without a burden of off tones in such fractions.

Overall, stirring+BC treatment agent is clearly more effective at reducing off-tones than a static soak at room temperature (see FIG. 30). Higher BC % (up to 10%) in the stirred process appears to significantly reduce off-tones.

When comparing stirred vs. static soak directly, the stirred treatment clearly outperformed static soaking in reducing off-tones, even at much shorter treatment times: 1) No BC, static vs. stirred: A static soak at ambient temperature yielded high off-tone intensity (score ˜7-9). In contrast, a stirred treatment at 60° C. for only 3.3 h (with no BC) resulted in a far lower off tone (−2.33). This means that agitation and heat alone can significantly diminish off-flavor intensity (likely by speeding up extraction or breakdown of off-tone compounds), whereas a long static soak without BC allowed off-tones to remain strong or even increase. 2) With BC, static vs. stirred: With BC added, stirring+heat was even more effective. For example, using 5% BC, a static 24 h soak at 22° C. achieved an off-tone score of about 3.17 (moderate-slight intensity). The same BC level with stirring (3.3 h at 60° C.) brought the off tone down to essentially nil (˜1.0). In fact, in one trial all panelists scored the stirred 5% BC sample as 1 (no off-flavor detected), eliminating the off-tone altogether. Thus, stirring (especially with some heat) greatly enhances the BC treatment's effectiveness, yielding much lower off-tone intensity than static soaking for equivalent or even shorter treatment times. The stirred treatments are superior to static soaks help the BC interact with and neutralize off-flavor compounds more efficiently for reducing off-flavors: they work faster and achieve a greater reduction in intensity. Static soaking at room temperature, In contrast, is relatively ineffective on its own and can even aggravate off-notes over extended time if BC is absent or low.

Within the 55-65° C. temperature range, the different percentages of BC treatment clearly affected off-tone (off-tone intensity (1-10 scale)) on these dry pea pulse materials. As the BC percentage increases from 0% to 10%, the average off-tone intensity decreases, suggesting a dose-dependent mitigation of off-tones. The lowest off-tone intensity was observed at 10% BC. Standard deviation also decreases, indicating more consistent sensory results at higher BC concentrations. And the outcome for the broader temperature range of 50° C. to 70° C. is identical to the narrower 55-65° C. range. For BC treatments, the stirred process results in a significantly lower average off-tone intensity compared to the static soak. Additionally, the stirred method shows lower variability, suggesting more consistent sensory results (table 14, FIG. 30).

Considering the need to keep temperature ≤75° C. (to protect the natural product quality, for example), the ideal treatment condition is one that uses stirring, a moderate heat (around 60-75° C.), and BC at an effective concentration. Based on the data, a practical optimum is ˜5% BC with a stirred soak at ˜60° C. for ˜3-4 hours. Under these conditions, the panel reported virtually no off-flavors (off-tone intensity ˜1 on the scale). Using a higher BC dose (10%) or pushing the temperature slightly higher (to 75° C.) is not necessary, as 5% BC at 60° C. already achieved the minimum off-tone possible in the tests. In fact, 5% BC was enough to eliminate off-tones, and raising the dose to 10% gave only marginal further improvement. Likewise, heating beyond 60° C. to 75-80° C. did not perceptibly lower the off-tone beyond the ˜1.0 level. This is interesting as minimizing material loss is preferred, for instance, by erosion at the outer surface of the peas during the dynamic treatment. This is also interesting since it was found and demonstrated that the temperature's effect in combination with other treatments affect the molecular structural characteristics in the starch bodies, as demonstrated further in this disclosure.

Overall, to maximize off-tone reduction while staying ≤75° C., one can use BC treatment with stirring at about 60° C. This condition ensures the BC is fully effective: it dramatically reduces off-flavor intensity in a short time without needing extreme conditions. For example, a stirred 60° C. treatment with BC brought the off tone down to “nil” levels, compared to much higher intensities under cooler or static conditions. Thus, the recommended ideal is 5% BC, stirred, ˜60° C., for a few hours, which achieves the best off-tone improvement while adhering to the ≤75° C. requirement.

Comparing both tables 14 and 15, 1) BC treatment clearly reduces off-tone in both wet and dry forms. The effect is even stronger in wet samples, as they came from the treatment without the freeze-drying process and 2) stirring is crucial: dramatically improves off-tone results both before and after drying. Drying increases off-tone slightly for both methods but stirred BC-treated samples remain clearly superior. Static soaking is consistently less effective, especially in wet form. These findings were for the selection of optimal BC treatments combined with findings of optimal temperature and duration treatments for minimal material loss and optimally maintaining the semi-crystalline structure, radial molecular arrangement and birefringence of the starch bodies.

The treatment process had a very pronounced effect on off-tone intensity. Holding the recipe constant, static soak (no stirring, typically at 22° C. for extended time) resulted in significantly higher off-tone ratings than the stirred process (heated and agitated). For example, with 2.5% BC and no other additives, a static soak (12 h at 22° C.) produced an off-tone rating of ˜7.86, whereas the same formulation with a stirred treatment (3.33 h at 60° C.) yielded a much lower off-tone of ˜1.57 (a barely detectable off tone taste).

The dataset (FIG. 36, Table 15 of the Example 20 treatments) shows a clear reduction in off-tone intensity (rated on a 1-10 scale) when BC is present, compared to when no BC is used. In a controlled series of experiments at 60° C. with stirring for 3.33 h (and no other additives), increasing the BC concentration from 0% to 10% lowered the average off-tone score from about 2.57 (no BC) down to 1.25 (10% BC), as illustrated above. In fact, any addition of BC tended to reduce off-flavor intensity. Across all trials, runs without BC had much higher off-tone ratings on average (median ˜8.3) than runs with BC (median ˜1.3). This indicates that incorporating BC into the treatment greatly diminishes off-tone intensity, suggesting BC is effective at suppressing the undesirable off-taste.

The results (FIG. 36, table 15 of the Example 20 treatments) indicate practical temperature treatment zone for bicarbonate treatment is 55° C.-60° C. with stirring. It provides a strong off-tone reduction and manageable processing conditions. 75° C. gives the lowest off tone but may approach the threshold for unwanted degradation depending on the natural produce used or if it is protected or not protected by a bivalent ion such as calcium (Examples 18, table 12; Example 19, table 13). Combining sodium bicarbonate with minerals (zinc+iron) is most effective at reducing off-tone and sodium bicarbonate treatment+magnesium chloride is also beneficial. BC alone performed very well at 55° C., suggesting this temperature amplifies the effect of BC without need for combinations. BC+Zn+Fe consistently performs well (both globally and at 55° C.). In Adding BC clearly reduces off-tone intensity in stirred treatments. The trend aligns with overall findings in the treatments of example 20: BC is beneficial for off-tone removal. BC treatment reliably reduces off-tone. Stirring at 55-60° C. is optimal for off-tone reduction using BC. Static soaking, even at mild temperatures, is clearly less effective.

Within the subset of stirred treatments at or below 75° C., the lowest off-tone intensity observed was 1.0 (the minimum on the 1-10 scale). Several conditions achieved this minimal off-tone rating of barely detectable or not detectable level. One ideal scenario in the data was a treatment using BC with gentle heating: BC concentration: 2.0% and other compounds (CC, CL, iron, zinc, MC): none added (all at 0), Process: stirred, Temperature: 55° C. (within the ≤75° C. constraint), Time: 3.33 h providing an off-tone intensity (avg): 1.00 (lowest observed). Under these conditions, the off tone was effectively neutralized (rating of 1.0). Notably, this treatment involved a moderate BC level (2%) and moderate heat. Other near-optimal conditions included using 2.5% BC at 75° C. for 1.67 h (with similarly low off-tone ≈1.0). Overall, the ideal treatment for BC (to minimize off-tastes) is to use a stirred process with relatively mild temperature (up to 75° C.) and an adequate BC dose—the example above achieved the best taste outcome (off-tone as low as possible) with BC and no additional additives.

In summary, the analysis of the Wet off A V dataset (of example 20, table 15 demonstrates that using BC in the treatment markedly reduces off-tone intensity, especially under stirred, heated conditions. Stirring the treatment (particularly with some heat) is far more effective at minimizing off-flavors than static soaking. The optimal condition for employing BC (under practical temperature limits) was identified as a stirred process at moderate heat (≤75° C.) with a sufficient BC dosage, achieving the lowest possible off-tone rating.

### Example 21

Field dried yellow peas with seed coat ware at 100 gram/liter treated under various conditions as displayed in Table 16. Before wet milling each the pea material of each treatment group (1-20) was rinsed washed on a 400 mesh (38 μm opening size (μm)) sieve under a tap water stream at 22° C. for 10 minutes. Consequently, 50 gram freeze-dried pea material from each of the treatment step displayed in Table 16 was put in the bowl of a Vorwerk Thermomix TM6 with 650 gram tap water and this has been wet grinded by operating its mixing knife in “right turn” cut function at a 10,200 revolutions per minute (set to its highest speed, level 10) for 10 to 20 seconds to separate the starch bodies from the cellular structure.

It was observed that from dry pea material that had been treated under a process as described in table 14 the starch bodies will either separate within these 10 to 20 seconds wet milling or not, they stay in clusters. If the starch bodies within such seconds did not separate from their parenchyma cells and were not released into individual bodies from their cluster (individual starch granules densely packed or embedded within a complex and continuous protein matrix), the pea material was subjected to a wet grinding of 5 minutes by operating its mixing knife in “right turn” cut function at a 10,200 revolutions per minute (set to its highest speed, level 10). In that case it was observed that such prolonged milling will not release the starch bodies from their clusters, or it will only result in destruction of the starch bodies (starch body fragments).

After this wet grinding with a dropper pipette a few μl of such wet grind was put in a small vial to have this mixed with a few drops of either Lugol or Bradford dye to see the organic matter mixture turn into provides a distinct deep blue-black or dark purple color (starch) or vibrant blue color (protein), respectively. With a dropper pipette a droplet with colored pea matter is put on a microscope slide and covered with a cover slip and put above the aperture of on the microscopic stage of a microscope with camera for image inspection. The microscope was equipped with a polarizing filter. A polarizer was placed below the samples and an analyzer (second polarizer) above it at 90° between its light source and the sample holder. One inspection criterion was the Maltese cross (also called an extinction cross or birefringence cross), at dark “x” pattern that one can see when looking at a native starch granule between crossed polarizers. Such a Maltese cross is a built-in structural thermometer. The presence or absence of this optical phenomenon is directly linked to the molecular organization within the starch granule, specifically its degree of crystallinity.

Starch granules that show a distinct Maltese cross are in their native, uncooked state. Their key structural characteristics are: 1) Semi-crystalline Structure: Native starch granules are composed of both amorphous and crystalline regions. These regions are arranged in concentric layers, often referred to as “growth rings.” 2) Radial Molecular Arrangement: Within the granule, the two main components of starch—amylose and amylopectin—are organized in a radial fashion. The long chains of these glucose polymers are oriented perpendicular to the surface of the granule and 3) Birefringence: This highly ordered, semi-crystalline structure causes the starch granule to be birefringent, or doubly refracting. When polarized light passes through the granule, it is split into two rays that travel at different speeds. This property is the direct cause of the Maltese cross, which is an interference pattern created by the interaction of the polarized light with the radially arranged crystalline structures. The center of the cross, known as the hilum, is the point of origin for the granule's growth. In essence, the Maltese cross is a visual indicator of the intact, highly organized, semi-crystalline nature of a native starch granule.

The absence of the Maltese cross signifies a significant and irreversible change in the starch granule's structure, a process known as gelatinization. The structural and qualitative differences in these granules are: 1) Loss of Crystallinity: As the starch granule is heated, the hydrogen bonds that maintain the crystalline structure are disrupted. Water is absorbed by the granule, causing it to swell. This leads to the loss of the ordered, crystalline regions, and the granule becomes amorphous, 2) Amorphous Structure: An amorphous structure lacks the long-range molecular order of a crystal. Consequently, it does not exhibit a birefringence. Without the ordered arrangement of polymer chains, the polarized light is no longer split in a way that produces the characteristic interference pattern and Irreversible Swelling and Solubilization: During gelatinization, the granule swells dramatically, and amylose leaches out. The once distinct, dense particle becomes a swollen, hydrated network that has lost its granular integrity. Therefore, a starch particle that does not form a Maltese cross has undergone gelatinization, lost its native crystalline structure and become an amorphous, swollen gel. This is the fundamental difference between cooked and raw starch at a microscopic level. Its disappearance signals that native starch has been fundamentally reordered, while its persistence shows that the granules survived the processing step essentially unchanged. When the starch granules are broken down by heating and gelatinization occurs, the Maltese cross disappears. Maltese cross has disappeared (no birefringence) when the radial semicrystalline order of the granule has been disrupted, for instance, by starch gelatinization or hydrolysis or the starch granule is largely amorphous and swollen. If after treatment of the pea pulses the Maltese cross still stays intact (bright extinction cross) one can assume that that the starch granules remain native (semicrystalline) and radial double-helix clusters are preserved, and the processing remained below the gelatinization threshold.

The Maltese cross visualization and the intact starch bodies separability (Example 21 and Table 16) revealed that the lower to moderate temperatures (20-75° C.) can preserve starch structure, especially when the treatment time is short to moderate (1.7-3.3 hours for the BC % ranges from 0% to 5%. Under these conditions effective preservation is observed even at 5%, depending on time and temperature. The preservation is more likely at 1) 20° C. for 3.3 hours with 5% BC, 2) 60° C. for 1.7-3.3 hours with 2.5-5% BC and 3) 75° C. for 1.7 hours, especially if time is kept shorter. However, loss of Maltese cross (red) is observed at higher temperatures (≥75° C.) and longer times and appears at moderate BC % if combined with high temp or prolonged time. Although it has been demonstrated by other examples that these bivalent ions or salts thereof protect material loss, for instance, by erosion during the stirring treatment, there is no consistent effect of the additives, including Magnesium chloride up to 2% and other compounds (CC, CS, CL) at 1% iron/zinc at the ≤200 mg/liter dose on preserving or destroying the Maltese cross.

Across all successful runs the BC level was either 2.5% or 5%; lower BC was never the factor that failed All failures shared one feature: 80° C. for 3.3 h (regardless of additives—even at 5% BC, or with MgCl₂, CC, CS, CL). And the additives also did not enhance failure.

It was also observed that that after yellow peas that were treated according to group 1 of table 16 can be dried in hot air (60° C.) and thereafter when milled in the Thermomix TM6 either dry or in water at the by operating the Thermomix's mixing knife in “right turn” cut function at a 10,200 revolutions per minute (set to its highest speed, level 10) resulted in a release from their cluster (individual starch granules densely packed or embedded within a complex and continuous protein matrix) into intact individual starch bodies. And that these starch bodies maintained their structural characteristics of semi-crystalline structure, radial molecular arrangement and birefringence. Under crossed polarizers it was yet possible to microscopically visualize the Maltese cross on these starch bodies.

Several documents are cited throughout the text of this specification. Each of the documents herein (including any manufacturer's specifications, instructions etc.) are hereby incorporated by reference; however, there is no admission that any document cited is indeed prior art of the disclosure.

It will be apparent to those skilled in the art that to change the texture of the final foodstuff various made by the process of the disclosure modifications and variations can be made in varying the pH of the bicarbonate solution or bicarbonate/carbonate pulse treatment solution or thereto adding the bivalent ions in a particular dose or by modifying the temperature or treatment time of the pulses using the bicarbonate solution or bicarbonate/carbonate pulse treatment of the treatment system and method of the disclosure and in construction of without departing from the scope or spirit of the disclosure. Examples of such modifications have been previously provided.

Other embodiments of the disclosure will be apparent to those skilled in the art from consideration of the specification and practice of the disclosure disclosed herein.

It is intended that the specification and Examples be considered as exemplary only.

Each and every claim is incorporated into the specification as an embodiment of the disclosure. Thus, the claims are part of the description and are a further description and are in addition to the preferred embodiments of the disclosure.

Each of the claims set out a particular embodiment of the disclosure.

### REFERENCES

Fenn, D., Wang, N., & Maximiuk, L. (2021). Physicochemical, anti-nutritional, and functional properties of air-classified protein concentrates from commercially grown Canadian yellow pea (Pisum sativum) varieties with variable protein levels. Cereal Chemistry, 99(1), 157-168.
Grasso, N., Lynch, N., Arendt, E., & O'Mahony, J. (2021). Chickpea protein ingredients: a review of composition, functionality, and applications. Comprehensive Reviews in Food Science and Food Safety, 21(1), 435-452.
Lefèvre, C., Bohuon, P., Lullien-Pellerin, V., & Mestres, C. (2022). Modeling the thermal denaturation of the protein-water system in pulses (lentils, beans, and chickpeas). Journal of Agricultural and Food Chemistry, 70(32), 9980-9989.
Pelgrom, P., Wang, J., Boom, R., & Schutyser, M. (2015). Pre- and post-treatment enhance the protein enrichment from milling and air classification of legumes. Journal of Food Engineering, 155, 53-61.
Pulivarthi, M. (2023). Dry fractionation process operations in the production of protein concentrates: a review. Comprehensive Reviews in Food Science and Food Safety, 22(6), 4670-4697.
Rempel, C., Li, X., Geng, X., Liu, Q., & Zhang, Y. (2019). Manufacture of defatted canola meal with enhanced nutritive composition by air classification on an industrial scale. Journal of the Science of Food and Agriculture, 100(2), 764-774.
Thiessen, D., Campbell, G., & Tyler, R. (2003). Utilization of thin distillers' solubles as a palatability enhancer in rainbow trout (Oncorhynchus mykiss) diets containing canola meal or air-classified pea protein. Aquaculture Nutrition, 9(1), 1-10.
Vogelsang-O'Dwyer, M., Petersen, I., Joehnke, M., Sørensen, J., Bez, J., Detzel, A., . . . & Zannini, E. (2020). Comparison of faba bean protein ingredients produced using dry fractionation and isoelectric precipitation: techno-functional, nutritional and environmental performance. Foods, 9(3), 322.
Bazoche, P., Guinet, N., Poret, S., & Teyssier, S. (2023). Does the provision of information increase the substitution of animal proteins with plant-based proteins? an experimental investigation into consumer choices. Food Policy, 116, 102426.
Huang, Z., Zhang, J., Zhang, G., Gao, F., & Bi, C. (2023). The impact of high-pressure homogenization and thermal processing on the functional properties of de-fatted chickpea flour dispersion. Foods, 12(7), 1513.
Nadeeshani, H., Senevirathne, N., Somaratne, G., & Bandara, N. (2022). Recent trends in the utilization of pulse protein in food and industrial applications. Acs Food Science & Technology, 2(5), 722-737.
Pathiraje, D., Carlin, J., Der, T., Wanasundara, J., & Shand, P. (2023). Generating multi-functional pulse ingredients for processed meat products—scientific evaluation of infrared-treated lentils. Foods, 12(8), 1722.
Szczebyło, A., Rejman, K., Halicka, E., & Laskowski, W. (2020). Towards more sustainable diets—attitudes, opportunities and barriers to fostering pulse consumption in polish cities. Nutrients, 12(6), 1589.
Zha, F., Rao, J., & Chen, B. (2021). Modification of pulse proteins for improved functionality and flavor profile: a comprehensive review. Comprehensive Reviews in Food Science and Food Safety, 20(3), 3036-3060.
Žugčić, T., Abdelkebir, R., Barba, F., Jambrak, A., Gálvez, F., Zamuz, S., . . . & Lorenzo, J. (2018). Effects of pulses and microalgal proteins on quality traits of beef patties. Journal of Food Science and Technology, 55(11), 4544-4553.

### Tables in the Disclosure

TABLE 1

| Moist pulse | pre- | | | | pulse | |
|---|---|---|---|---|---|---|
| before drying | treatment | ferment | Firmness | taste | tone | aroma |
| yellow pea | BC medium | vegan kefir | Medium | only slightly sour with a mild | No | pleasant |
| | | starter | | and refreshing tart | | |
| yellow pea | BC-BicCa | vegan kefir | soft | only slightly sour with a mild | No | pleasant |
| | medium | starter | | and refreshing tart | | |
| yellow pea | BC medium | sauerkraut | Medium | unpleasant: taste too sharp tart | No | unpleasant |
| | | starter | | and tangy, funky resembling | | |
| | | | | that sauerkraut flavor | | |
| yellow pea | BC-BicCa | sauerkraut | soft | unpleasant: taste too sharp tart | No | unpleasant |
| | medium | starter | | and tangy, funky resembling | | |
| | | | | that sauerkraut flavor | | |
| chickpea | BC medium | vegan kefir | medium | only slightly sour with a mild | No | pleasant |
| | | starter | | and refreshing tart | | |
| chickpea | BC-BicCa | vegan kefir | soft | only slightly sour with a mild | No | pleasant |
| | medium | starter | | and refreshing tart | | |
| chickpea | BC medium | vegan yogurt | medium | Pleasant tanginess citric and | No | distinct & |
| | | starter | | lactic acid like | | pleasant |
| Fava/Faba | BC medium | vegan kefir | soft | only slightly sour with a mild | No | very |
| | | starter | | and refreshing tart | | pleasant |
| Fava/Faba | BC medium | sauerkraut | medium | tart & tangy but less than for | No | unpleasant |
| | | starter | | chickpea | | |
| Common bean | BC medium | vegan kefir | medium | only slightly sour with a mild | No | pleasant |
| | | starter | | and refreshing tart | | |
| Common bean | BC medium | sauerkraut | soft (seed | tart & tangy but less than for | No | unpleasant |
| | | starter | coats: | chickpea | | |
| | | | medium) | | | |

Table 1 displays an observation on the different wet pulse materials that were the different medium pre-treatment and thereafter that were subject to one-week anaerobic fermentation at 22° C. for one week.

TABLE 2

| | | | | Self | Taste | Plant | | |
|---|---|---|---|---|---|---|---|---|
| | | | | Desintegrating | intensity | tone | | |
| | Dried | pre- | | in mouth on | Scale | Scale | Taste | |
| A | pulse | treatment | ferment | scale 1-9 * | 1-5 ** | 1-5 *** | specification | Mouthfeel |
| | yellow | BC medium | vegan | 6 | 3 | 1 | Cheesy, sweet | Initial dry |
| | pea | | kefir | | | | | than |
| | | | starter (II) | | | | | becomes |
| | | | | | | | | creamy |
| B | yellow | BC-BicCa | vegan | 9 | 3 | 1 | Buttery, cheesy, | creamy |
| | pea | medium | kefir | | | | kefir like | |
| | | | starter (II) | | | | | |
| C | chickpea | BC medium | vegan | 6 | 3 | 3 | Sweet, slightly | Dry than |
| | | | kefir | | | | acid | creamy |
| | | | starter (II) | | | | | |
| D | chickpea | BC-BicCa | vegan | 8 | 3 | 1 | Cheesy, buttery, | Creamy, |
| | | medium | kefir | | | | little sour, Kefir | not dry |
| | | | starter (II) | | | | like | |
| E | chickpea | BC medium | vegan | 7 | 4 | 1 | Acid & sweet | creamy |
| | | | yogurt | | | | | |
| | | | starter (I) | | | | | |
| F | Fava/Faba | BC medium | vegan | 8 | 2 | 1 | Cheesy, sweet, | creamy |
| | | | kefir | | | | buttery | |
| | | | starter (II) | | | | | |
| G | Common | BC medium | vegan | 6 | 2 | 1 | Light sweet, light | Dry than |
| | bean | | kefir | | | | acid | creamy |
| | | | starter (II) | | | | | |
| H | Puffed | puffing | — | 2 | 3 | 2 | Buckwheat plant | Dry |
| | buckwheat | | | | | | tone, roasted, | |
| | | | | | | | sweet | |
| I | Puffed | puffing | — | 5 | 4 | 3 | Slightly bitter & | Dry than |
| | quinoa | | | | | | quinoa plant tone | creamy |
| J | Puffed | puffing | — | 5 | 3 | 2 | Sweet - slight rice | Dry than |
| | rice | | | | | | plant tone | creamy |
| K | Puffed | puffing | — | 6 | 4 | 4 | Concentrated oat | Dry than |
| | oat | | | | | | flavor, sweet, | sticky |
| | | | | | | | some bitterness | |

Table 2 displays texture and taste/aroma features of chickpea (C. arietinum), yellow pea (P. sativum), common bean (P. vulgaris) and fava bean (V. faba), that were pre-treated by the BC medium treatment or the BC-BivCa medium treatment according to Example 2 that were subjected as whole pulses to fermentation by I) the vegan yogurt starter culture (A. oryzae, S. cerevisiae, L. bulgaricus, S. thermophiles, L. plantarum, L. casei, and L. lactis) or II) the vegan kefir starter culture (L. lactis subsp. lactis, L. lactis subsp. cremoris, L. lactis subsp. diacetylactis, L. delbrueckii subsp. bulgaricus, L. helveticus, L. rhamnosus, L. paracasei, L. acidophilus, S. thermophilus, B. bifidum, and L. mesenteroides) according to Example 2.

The groups evaluated in this dried whole pulse test are:
A. whole yellow peas BC medium—vegan kefir starter culture fermentation
B. whole yellow pea pulse—BC-BivCa medium—vegan kefir starter culture fermentation
C. whole chickpeas—BC-BivCa medium treatment—vegan kefir starter culture fermentation
D. whole chickpeas—BC medium process—vegan kefir starter culture fermentation
E. whole chickpeas—BC medium—vegan yogurt starter culture fermentation
F. whole fava beans—BC medium process—vegan kefir starter culture fermentation
G. whole common bean—BC medium—vegan kefir starter culture fermentation
H. Puffed buckwheat (Udea Holding B.V.)
I. Puffed quinoa (Udea Holding B.V.)
J. Puffed rice (Céréco Société par actions simplifiée)
K. Puffed Oats Unsweetened Organic (Udea Holding B.V.)
self-disintegrate in the mouth: (Rate on scale of 1-9) 1-9*=1 being slow and 9 being instantaneous.
Taste intensity Scale 1-5** Overall Flavor Intensity: 1) Very weak/2) Weak/3) Moderate/5) Strong/5) Very strong
Plant tone Scale 1-5*** 1) No Plant-tones detected/2) Slight Plant-tone/3) Moderate Plant-tone/4) Strong Plant-tone/5) Overpowering Plant-tone

TABLE 3

| | | | Solid material | Solid material | Solid dry material |
|---|---|---|---|---|---|
| | | | recovery | recovery | recovery |
| | | PH | wet | dry | % |
| 1 | sodium bicarbonate + calcium | 7.8 | 766 | 276.526 | 79 |
| | lactate | | | | |
| 2 | sodium bicarbonate + sodium | 9.5 | 685 | 223.31 | 64 |
| | hydroxide | | | | |
| 3 | sodium bicarbonate + calcium | 7.7 | 831 | 310.794 | 89 |
| | chloride | | | | |
| 4 | sodium bicarbonate + calcium | 7.6 | 799 | 290.836 | 83 |
| | sulphate | | | | |
| 5 | sodium bicarbonate + calcium | 8.1 | 787 | 264.432 | 76 |
| | carbonate | | | | |
| 6 | sodium bicarbonate | 8.1 | 815 | 278.73 | 80 |
| 7 | sodium bicarbonate + magnesium | 8.2 | 809 | 289.622 | 83 |
| | chloride | | | | |
| 8 | sodium bicarbonate + ferrous | 8.2 | 792 | 249.48 | 71 |
| | lactate + zinc oxide | | | | |
| 9 | sodium + calcium carbonate + | 7.7 | 827 | 269.602 | 77 |
| | calcium sulphate + magnesium | | | | |
| | chloride + ferrous lactate + zinc | | | | |
| | oxide | | | | |

Table 3 displays the chickpea pulse materials recovery after the immersion in the different solutions and the washing steps.

TABLE 4

| | | | Status of | | | |
|---|---|---|---|---|---|---|
| | | | the | Taste of the | Texture | Texture |
| | | | chickpea + | chickpea + | Homogenized * & | Homogenized * & |
| | | | seed coat | seed coat | incubated for | incubated for |
| | | pH | wet | wet | 24 h at 4° C. * | 24 h at 4° C. * |
| 1 | sodium bicarbonate + | 7.8 | tender- | neutral | firm/set | like Greek yogurt |
| | calcium lactate | | crisp | | | strained for a |
| | | | | | | longer time |
| 2 | sodium bicarbonate + | 9.5 | mashing | neutral | soupy/runny | drinking yogurt |
| | sodium hydroxide | | | | | like |
| 3 | sodium bicarbonate + | 7.7 | tender- | neutral | tick/creamy | like Greek/Bulgarian |
| | calcium chloride | | crisp | | | yogurt |
| 4 | sodium bicarbonate + | 7.6 | tender- | neutral | firm/set | like Greek yogurt |
| | calcium sulphate | | crisp | | | strained for a longer |
| | | | | | | time |
| 5 | sodium bicarbonate + | 8.1 | tender- | neutral/ | tick/creamy | like Greek/Bulgarian |
| | calcium carbonate | | crisp | nutty | | yogurt |
| 6 | sodium bicarbonate | 8.1 | firm | neutral | tick/creamy | like Greek/Bulgarian |
| | | | | | | yogurt |
| 7 | sodium bicarbonate + | 8.2 | tender- | neutral/ | set/wobbly but | custard yogurt/Quark |
| | magnesium chloride | | crisp | nutty | spoonable | or quarg like/cottage |
| | | | | | | cheese like |
| 8 | sodium bicarbonate + | 8.2 | mashing | tasty | tick/creamy | like Greek yogurt |
| | ferrous lactate + zinc | | | | | |
| | oxide | | | | | |
| 9 | sodium + calcium | 7.7 | most firm | neutral | soupy/runny | drinking yogurt like |
| | carbonate + calcium | | | | | |
| | sulphate + magnesium | | | | | |
| | chloride + ferrous | | | | | |
| | lactate + zinc oxide | | | | | |

Table 4 provides some pre-fermentation technical features as result of the different pre-treatment conditions

Features observable on pre-treated wet chickpea matter of which the water has been leaked of through a 20 μm sieve.
1. Firm means that that the wet chickpea matter offers more resistance than tender-crisp, but still has a slight bite.
2. Tender-Crisp means that the wet chickpea matter has a light resistance to bite, retains its shape well.
3. Creamy means that the wet chickpea matter is smooth and yields easily to pressure may start to break down slightly.
4. Mashing means that the wet chickpea matter easily breaks down with minimal pressure (ideal for dishes like hummus).
* For this homogenate texture test 500 gram of chickpea each of the different (1-9) pre-treatments was in mixing bowl of the Vorwerk Thermomix TM6 joined with 982.5 gram water, 7.5 gram sugarcane sugar and 10 grams of canola oil. These were homogenized at a speed setting 10 (10200) for 5 minutes and at a speed 6 (3,100 rpm) for 5 minutes. 100 grams of each such substance was poured in a glass jar and sealed each for storage in refrigerator at 4° C.

Features observable on the cold stored (4° C.) chickpea matter homogenate:
1. Soupy/Runny means it is very thin and pourable, like drinking yogurt
2. Set/Wobbly: means it gels slightly but jiggles when disturbed.
3. Thick/Cream means it is smooth and dense, offering mild resistance to a spoon.
4. Firm/Set means it holds its shape well, requires some pressure from a spoon.

TABLE 5

| | | Ferment A | Ferment A | Ferment A | Ferment B | Ferment B | Ferment B |
|---|---|---|---|---|---|---|---|
| | | Texture | Texture | Taste/aroma | Texture | Texture | Taste/aroma |
| 1 | sodium | firm/set | like Greek | Moderately | set/wobbly | custard yogurt/ | Mildly sour |
| | bicarbonate + | | yogurt strained | sour | | Quark or quarg | |
| | calcium | | for a longer | | | like/cottage | |
| | lactate | | time | | | cheese like | |
| 2 | sodium | soup/runny | drinking | Moderately | soupy/ | drinking | Mildly sour |
| | bicarbonate + | | yogurt like | sour Tasty | running | yogurt like | Aroma less |
| | sodium | | | | | | accepted |
| | hydroxide | | | | | | |
| 3 | sodium | tick/creamy | like Greek/ | Sharp/tangy | set/wobbly | custard yogurt/ | Moderately sour |
| | bicarbonate + | | Bulgarian | sour Tasty | | Quark or quarg | Nice aroma |
| | calcium | | yogurt | | | like/cottage | |
| | chloride | | | | | cheese like | |
| 4 | sodium | tick/creamy | like Greek/ | Highly sour/ | set/wobbly | custard yogurt/ | Sharp/tangy |
| | bicarbonate + | | Bulgarian | astringent | | Quark or quarg | sour |
| | calcium | | yogurt | Lactic acid | | like/cottage | |
| | sulphate | | | feel | | cheese like | |
| 5 | sodium | tick/creamy | like Greek/ | Moderately | _lost_{—} | x | x |
| | bicarbonate + | | Bulgarian | sour - | | | |
| | calcium | | yogurt | resembling | | | |
| | carbonate | | | citric acid - | | | |
| | | | | fruity taste - | | | |
| | | | | fruity aroma | | | |
| 6 | sodium | lost_{—} | x | x | firm/set | like Greek | Moderately sour |
| | bicarbonate | | | | | yogurt strained | Tasty Nice |
| | | | | | | for a longer | aroma Dairy |
| | | | | | | time | feel |
| 7 | sodium | tick/creamy | like Greek/ | Highly | set/wobbly | custard yogurt/ | Mildly sour |
| | bicarbonate + | | Bulgarian | sour/ | | Quark or quarg | Fruity Nice |
| | magnesium | | yogurt | astringent | | like/cottage | aroma |
| | chloride | | | Tasty | | cheese like | |
| 8 | sodium | tick/creamy | like Greek/ | Sharp/tangy | set/wobbly | custard yogurt/ | Moderately sour, |
| | bicarbonate + | | Bulgarian | sour Tasty | | Quark or quarg | Other taste |
| | ferrous | | yogurt | | | like/cottage | sensation is |
| | lactate + | | | | | cheese like | neutral |
| | zinc oxide | | | | | | |
| 9 | sodium + | set/wobbly | custard | Sharp/tangy | set/wobbly | custard yogurt/ | Highly |
| | calcium | | yogurt/ | sour Tastes | | Quark or quarg | sour/astringent |
| | carbonate + | | Quark or quarg | well | | like/cottage | |
| | calcium | | like/cottage | | | cheese like | |
| | sulphate + | | cheese like | | | | |
| | magnesium | | | | | | |
| | chloride + | | | | | | |
| | ferrous | | | | | | |
| | lactate + | | | | | | |
| | zinc oxide | | | | | | |

Table 5 displays texture and taste/aroma features of the different pre-treatment groups 1 to 9 that were subjected to homogenization and fermentation. These technical features were observed on the whole chickpea pulsed that 1) had been treated with the different solutions (1-9) by the process of Example 8, consequently 2) were homogenate for each 500 gram of chickpea each of the different (1-9) pre-treatments was in mixing bowl of the Vorwerk Thermomix TM6 joined with 982.5 gram water, 7.5 gram sugarcane sugar and 10 grams of canola oil. These were homogenized at a speed setting 10 (10200) for 5 minutes and at a speed 6 (3,100 rpm) for 5 minutes and consequently 3) such homogenate was inoculated with ferment culture group A or ferment culture group B (Example 8) for two weeks.

The terms in Table 4 have the following meanings:
1. Mildly sour means a subtle sourness barely noticeable on the tongue, resembling lightly flavored drink yogurt.
2. Moderately sour means a clear sour note, but still pleasant and refreshing, resembling standard plain yogurt.
3. Sharp/tangy sour means more intense sourness, might cause a slight pucker, resembling Greek yogurts.
4. Highly sour/astringent means very strong sourness with a noticeable drying or puckering sensation, resembling some Bulgarian yogurts or sour cream.

TABLE 6

| | (tasteless) 0-10 score (reference taste) | | |
|---|---|---|---|
| Individual | “S-Carbonate” | “S-Water” | Reference |
| 1 | 2 | 4 | 10 |
| 2 | 4 | 6 | 10 |
| 3 | 6 | 8 | 10 |
| 4 | 0 | 1 | 10 |
| 5 | 5 | 7 | 10 |
| 6 | 4 | 2 | 10 |
| 7* | 1 | 3 | 10 |
| 8 | 2 | 3 | 10 |
| 9 | 4 | 1 | 10 |
| 10 | 3 | 6 | 10 |
| Average | 3.1 | 4.1 | 10 |

*Individual indicated pea aftertaste for “S-Water” test sample

TABLE 7
(panel A)

| | | | K.F. | | | K.F. | | | K.F. | | | K.F. | |
|---|---|---|---|---|---|---|---|---|---|---|---|---|---|
| | Group | 95 | 70 | | 97 | 71 | | 94 | 72 | | 96 | 73 | |
| Flavor | Flavor | | | | | | | | | | | | |
| Generally Repellent | sulfur | 0.00 | 0.00 | | 0.00 | 0.00 | | 0.00 | 0.00 | | 0.00 | 0.00 | |
| Generally Repellent | green/grassy | 0.22 | 0.00 | ↓ | 0.33 | 0.00 | ↓ | 0.00 | 0.00 | | 0.00 | 0.00 | |
| Generally Repellent | bitter | 0.00 | 0.00 | | 0.11 | 0.00 | ↓ | 0.00 | 0.00 | | 0.00 | 0.00 | |
| Generally Repellent | earthy | 0.00 | 0.00 | | 0.00 | 0.00 | | 0.00 | 0.00 | | 0.00 | 0.00 | |
| Generally Repellent | metallic | 0.00 | 0.00 | | 0.11 | 0.00 | ↓ | 0.00 | 0.00 | | 0.00 | 0.00 | |
| Generally Repellent | pungent | 0.00 | 0.00 | | 0.00 | 0.00 | | 0.00 | 0.00 | | 0.00 | 0.00 | |
| Generally Tasty | honey-like | 1.33 | 1.80 | | 2.00 | 1.40 | | 0.78 | 1.80 | | 1.44 | 2.40 | |
| Generally Tasty | cucumber | 2.11 | 1.40 | ↓ | 2.44 | 0.00 | ↓ | 1.22 | 0.80 | ↓ | 1.67 | 0.20 | ↓ |
| Generally Tasty | citrus-like | 0.44 | 2.40 | ↑ | 0.11 | 2.80 | ↑ | 0.11 | 4.40 | ↑ | 0.44 | 4.60 | ↑ |
| Generally Tasty | salty | 0.00 | 0.00 | | 0.00 | 0.20 | ↑ | 0.00 | 0.40 | ↑ | 0.11 | 0.00 | |
| Generally Tasty | nutty | 2.00 | 0.20 | ↓ | 1.56 | 0.40 | ↓ | 1.44 | 1.20 | ↓ | 1.22 | 0.40 | ↓ |
| Treatment | | BC | | | BC + CS | | | BC + ZC + IN | | | BC + CL | | |
| Treatment time | | 198 min. | | | 198 min. | | | 198 min. | | | 198 min. | | |
| Wash time | | 198 min. | | | 198 min. | | | 198 min. | | | 198 min. | | |
| Treatment temp. | | 60° C. | | | 60° C. | | | 60° C. | | | 60° C. | | |
| Fermentation temp. | | | 22° C. | | | 22° C. | | | 22° C. | | | 22° C. | |
| Ferm. time days | | | 7 | | | 7 | | | 7 | | | 7 | |
| | | | K.F. | | | K.F. | | | K.F. | | | K.F. | |
| | Group | 90 | 74 | | 93 | 75 | | 92 | 76 | | 98 | 77 | |
| Flavor | Flavor | | | | | | | | | | | | |
| Generally Repellent | sulfur | 0.00 | 0.00 | | 0.00 | 0.00 | | 0.00 | 0.00 | | 0.00 | 0.00 | |
| Generally Repellent | green/grassy | 0.00 | 0.00 | | 0.00 | 0.00 | | 0.00 | 0.00 | | 0.44 | 0.00 | ↓ |
| Generally Repellent | bitter | 0.00 | 0.00 | | 0.00 | 0.00 | | 0.00 | 0.00 | | 0.00 | 0.00 | |
| Generally Repellent | earthy | 0.00 | 0.00 | | 0.00 | 0.00 | | 0.00 | 0.00 | | 0.22 | 0.00 | ↓ |
| Generally Repellent | metallic | 0.00 | 0.00 | | 0.00 | 0.00 | | 0.00 | 0.00 | | 0.00 | 0.00 | |
| Generally Repellent | pungent | 0.00 | 0.00 | | 0.00 | 0.00 | | 0.00 | 0.00 | | 0.00 | 0.00 | |
| Generally Tasty | honey-like | 1.56 | 1.60 | | 2.33 | 1.60 | | 1.56 | 1.00 | | 0.44 | 1.00 | |
| Generally Tasty | cucumber | 2.00 | 0.40 | ↓ | 2.33 | 1.20 | ↓ | 2.33 | 0.40 | ↓ | 2.33 | 1.20 | ↓ |
| Generally Tasty | citrus-like | 0.56 | 2.20 | ↑ | 0.67 | 5.40 | ↑ | 0.22 | 3.80 | ↑ | 0.56 | 1.20 | ↑ |
| Generally Tasty | salty | 0.00 | 0.40 | ↑ | 0.11 | 0.00 | ↓ | 0.00 | 0.20 | ↑ | 0.00 | 0.20 | ↑ |
| Generally Tasty | nutty | 1.33 | 2.20 | ↑ | 2.33 | 0.40 | ↓ | 2.00 | 0.00 | ↓ | 1.22 | 0.80 | ↓ |
| Treatment | | BC + MC | | | BC + CC | | | BC + all | | | NO BC + all | | |
| Treatment time | | 198 min. | | | 198 min. | | | 198 min. | | | 198 min. | | |
| Wash time | | 198 min. | | | 198 min. | | | 198 min. | | | 198 min. | | |
| Treatment temp. | | 60° C. | | | 60° C. | | | 60° C. | | | 60° C. | | |
| Fermentation temp. | | | 22° C. | | | 22° C. | | | 22° C. | | | 22° C. | |
| Ferm. time days | | | 7 | | | 7 | | | 7 | | | 7 | |

TABLE 7
(panel A & B)

| | | | | treatment | wash | status | status | bite | general |
|---|---|---|---|---|---|---|---|---|---|
| | | post | | time | time | of the | of the | impressions | impressions |
| Group | Test | process | treatment | (minutes) | (minutes) | pulse | seed coat | count | count |
| 95 | 10 | nf | 5% “BC” | 2 × 99 | 2 × 99 | most | released | “light”: 10 | neutral: 4 |
| | | | | | | intact | | | pleasant: 6 |
| | | | | | | | | | dairy feel: 1 |
| | | | | | | | | | very pleasant: 1 |
| 70 | 5 | KF | 5% “BC” | 2 × 99 | 2 × 99 | most | released | tender: 1 | pleasant: 2 |
| | | | | | | intact | | light: 3 | “dairy feel”: 1 |
| 97 | 10 | nf | 5% “BC” + 0.5% “CS” | 2 × 99 | 2 × 99 | split | released | “light”: 9 | neutral: 4 |
| | | | | | | | | “tender”: 1 | very neutral: 1 |
| | | | | | | | | | pleasant: 4 |
| | | | | | | | | | very pleasant: 2 |
| 71 | 5 | KF | 5% “BC” + 0.5% “CS” | 2 × 99 | 2 × 99 | split | released | “light”: 4 | neutral: 2 |
| | | | | | | | | “very | pleasant: 2 |
| | | | | | | | | light”: 1 | acid: 2 |
| | | | | | | | | | citrus feel: 1 |
| | | | | | | | | | dairy-like: 1 |
| 94 | 10 | nf | 5% “BC” + “ZC” (140 mg/ | 2 × 99 | 2 × 99 | partial | partial | “light”: 8 | neutral: 6 |
| | | | liter) + “IN” (140 mg/liter) | | | split | release | “tender”: 2 | pleasant: 2 |
| 72 | 5 | KF | 5% “BC” + “ZC” (140 mg/ | 2 × 99 | 2 × 99 | partial | release | “crunchy”: 1 | pleasant: 4 |
| | | | liter) + “IN” (140 mg/liter) | | | split | | “light”: 4 | neutral except acid: 1 |
| | | | | | | | | | neutral: 1 |
| | | | | | | | | | dairy-like: 1 |
| | | | | | | | | | acid: 1 |
| | | | | | | | | | dairy feel: 1 |
| | | | | | | | | | perfect food additive: 1 |
| | | | | | | | | | lactic acid: 1 |
| | | | | | | | | | Kefir-like: 1 |
| | | | | | | | | | citrus feel: 1 |
| 96 | 10 | nf | 5% “BC” + 0.5% “CL” | 2 × 99 | 2 × 99 | partial | partial | “tender”: 4 | neutral: 4 |
| | | | | | | split | release | “light”: 6 | very neutral: 1 |
| | | | | | | | | | pleasant: 2 |
| | | | | | | | | | very pleasant: 1 |
| | | | | | | | | | some sweetness: 1 |
| 73 | 5 | KF | 5% “BC” + 0.5% “CL” | 2 × 99 | 2 × 99 | partial | partial | “light”: 4 | neutral: 1 |
| | | | | | | split | release | “tender”: 1 | dairy-like: 2 |
| | | | | | | | | | acid: 1 |
| | | | | | | | | | dairy feel: 2 |
| | | | | | | | | | lactic acid: 1 |
| | | | | | | | | | “nice acid sweet |
| | | | | | | | | | balance”: 1 |
| | | | | | | | | | milky: 1 |
| 90 | 10 | nf | 5% “BC” + 0.5% “MC” | 2 × 99 | 2 × 99 | mainly | partial seed | tender: 3 | neutral: 8 |
| | | | | | | intact | coat release | flaky: 4 | pleasant: 2 |
| | | | | | | | | light: 3 | very pleasant: 2 |
| 74 | 5 | KF | 5% “BC” + 0.5% “MC” | 2 × 99 | 2 × 99 | intact | partial seed | light: 3 | neutral: 1 |
| | | | | | | | coat release | flaky: 1 | dairy feel: 1 |
| | | | | | | | | tender: 1 | very pleasant: 1 |
| | | | | | | | | | pleasant: 1 |
| | | | | | | | | | very neutral: 1 |
| | | | | | | | | | yogurt/kefir-like: 1 |
| 93 | 10 | nf | 5% “BC” + 0.5% “CC” | 2 × 99 | 2 × 99 | split | release | light: 9 | neutral: 5 |
| | | | | | | | | flaky: 1 | likable: 2 |
| | | | | | | | | | pleasant: 3 |
| | | | | | | | | | sweet: 2 |
| 75 | 5 | KF | 5% “BC” + 0.5% “CC” | 2 × 99 | 2 × 99 | split | release | light: 5 | very pleasant: 2 |
| | | | | | | | | | pleasant: 3 |
| | | | | | | | | | neutral: 1 |
| | | | | | | | | | citrus feel: 1 |
| | | | | | | | | | citrus-like: 1 |
| | | | | | | | | | kefir feel: 1 |
| | | | | | | | | | nice food additive: 1 |
| 92 | 10 | nf | 5% “BC” + 0.5% “CC” + 0.5% | 2 × 99 | 2 × 99 | intact | with seed | light: 7 | neutral: 7 |
| | | | “CS” + 0.5% “CC” + 0.5% | | | | coat | tender: 1 | unique: 1 |
| | | | “MC” + “ZC” (140 mg/ | | | | | crunchy: 1 | pleasant: 3 |
| | | | liter) + “IN” (140 mg/liter) | | | | | flaky: 1 | very neutral: 1 |
| | | | | | | | | | very pleasant: 1 |
| | | | | | | | | | nutty: 2 |
| | | | | | | | | | sweet: 1 |
| 76 | 5 | KF | 5% “BC” + 0.5% “CC” + 0.5% | 2 × 99 | 2 × 99 | intact | with seed | tender: 3 | acid milk: 1 |
| | | | “CS” + 0.5% “CC” + 0.5% | | | | coat | Crunchy: 1 | neutral: 3 |
| | | | “MC” + “ZC” (140 mg/ | | | | | light: 1 | slightly acid: 2 |
| | | | liter) + “IN” (140 mg/liter) | | | | | | pleasant: 2 |
| | | | | | | | | | milky: 1 |
| | | | | | | | | | dairy-like: 1 |
| 98 | 10 | nf | NO “BC” + 0.5% “CC” + 0.5% | 2 × 99 | 2 × 99 | split | release | tender: 3 | neutral: 5 |
| | | | “CS” + 0.5% “CC” + 0.5% | | | | | crunchy: 5 | very neutral: 1 |
| | | | “MC” + “ZC” (140 mg/ | | | | | flaky: 2 | pleasant: 2 |
| | | | liter) + “IN” (140 mg/liter) | | | | | | not so pleasant: 1 |
| 77 | 5 | KF | NO “BC” + 0.5% “CC” + 0.5% | 2 × 99 | 2 × 99 | split | release | chewy: 2 | pleasant: 1 |
| | | | “CS” + 0.5% “CC” + 0.5% | | | | | crunchy: 3 | very neutral: 2 |
| | | | “MC” + “ZC” (140 mg/ | | | | | | neutral: 2 |
| | | | liter) + “IN” (140 mg/liter) | | | | | | slightly acid: 1 |

Table 7 (panel A & B) “K. F.” or “KF” is an abbreviation to identify the groups that have been fermented for two weeks by a vegan kefir ferment. “BC” means sodium bicarbonate. “CS” is calcium sulphate. “CL” is calcium lactate. “CC” is calcium carbonate. “ZC” is zinc. “IN” is iron. “MC” is magnesium chloride. “NO BC” means that sodium bicarbonate is absent. And “all” means CS+CC+CL+ZC+IN+MC. In these test The concentration for BC is 5%, for CC, CS, CL and MC (magnesium chloride)=each 0.5%. And the concentration of IN and for ZC is 140 mg/liter each.

TABLE 8
A

| | | | Y.F. | | | Y.F. | | | Y.F. | | | Y.F. | |
|---|---|---|---|---|---|---|---|---|---|---|---|---|---|
| | Group | 104 | 123 | | 105 | 122 | | 101 | 125 | | 91 | 130 | |
| Flavor | Flavor | | | | | | | | | | | | |
| Generally Repellent | sulfur | 0.00 | 0.00 | | 0.00 | 0.00 | | 0.00 | 0.00 | | 0.00 | 0.00 | |
| Generally Repellent | green/grassy | 0.00 | 0.00 | | 0.00 | 0.00 | | 0.00 | 0.20 | | 0.00 | 0.00 | |
| Generally Repellent | bitter | 0.00 | 0.00 | | 0.00 | 0.00 | | 0.00 | 0.00 | | 0.00 | 0.00 | |
| Generally Repellent | earthy | 0.00 | 0.00 | | 0.00 | 0.00 | | 0.00 | 0.00 | | 0.00 | 0.00 | |
| Generally Repellent | metallic | 0.00 | 0.00 | | 0.00 | 0.00 | | 0.00 | 0.00 | | 0.00 | 0.00 | |
| Generally Repellent | pungent | 0.00 | 0.00 | | 0.00 | 0.00 | | 0.00 | 0.00 | | 0.00 | 0.00 | |
| Generally Tasty | honey-like | 2.22 | 2.60 | | 2.11 | 2.00 | | 0.89 | 2.20 | | 1.44 | 2.60 | |
| Generally Tasty | cucumber | 1.89 | 0.20 | ↓ | 2.00 | 0.00 | ↓ | 1.44 | 0.40 | ↓ | 2.56 | 1.60 | ↓ |
| Generally Tasty | citrus-like | 0.22 | 2.80 | ↑ | 0.89 | 2.80 | ↑ | 0.11 | 3.80 | ↑ | 0.56 | 2.20 | ↑ |
| Generally Tasty | salty | 0.11 | 0.00 | | 0.11 | 0.20 | | 0.11 | 0.20 | | 0.00 | 0.00 | |
| Generally Tasty | nutty | 2.00 | 0.60 | ↓ | 1.89 | 0.80 | ↓ | 1.11 | 0.80 | ↓ | 2.11 | 1.40 | ↓ |
| Treatment | | BC | | | BC + CS | | | BC + ZC + IN | | | BC + CL | | |
| Treatment time | | 198 min. | | | 198 min. | | | 198 min. | | | 198 min. | | |
| Wash time | | 198 min. | | | 198 min. | | | 198 min. | | | 198 min. | | |
| Treatment temp. | | 60° C. | | | 60° C. | | | 60° C. | | | 60° C. | | |
| Ferm. temp. | | | 22° C. | | | 22° C. | | | 22° C. | | | 22° C. | |
| Ferm. time days | | | 14 | | | 14 | | | 14 | | | 14 | |
| | | | Y.F. | | | Y.F. | | | Y.F. | | | Y.F. | |
| | Group | 99 | 127 | | 106 | 126 | | 100 | 129 | | 102 | 128 | |
| Flavor | Flavor | | | | | | | | | | | | |
| Generally Repellent | sulfur | 0.00 | 0.00 | | 0.00 | 0.00 | | 0.00 | 0.00 | | 0.00 | 0.00 | |
| Generally Repellent | green/grassy | 0.11 | 0.00 | ↓ | 0.00 | 0.00 | | 0.00 | 0.00 | | 0.78 | 0.00 | ↓ |
| Generally Repellent | bitter | 0.00 | 0.00 | | 0.00 | 0.00 | | 0.00 | 0.00 | | 0.22 | 0.00 | |
| Generally Repellent | earthy | 0.00 | 0.00 | | 0.00 | 0.00 | | 0.00 | 0.00 | | 0.22 | 0.00 | ↓ |
| Generally Repellent | metallic | 0.00 | 0.00 | | 0.00 | 0.00 | | 0.00 | 0.00 | | 0.00 | 0.00 | |
| Generally Repellent | pungent | 0.00 | 0.00 | | 0.00 | 0.00 | | 0.00 | 0.00 | | 0.00 | 0.00 | |
| Generally Tasty | honey-like | 1.56 | 1.80 | | 0.78 | 2.40 | | 1.22 | 1.60 | | 0.11 | 1.60 | |
| Generally Tasty | cucumber | 2.22 | 1.20 | ↓ | 2.00 | 1.00 | ↓ | 2.22 | 0.80 | ↓ | 1.67 | 0.80 | ↓ |
| Generally Tasty | citrus-like | 0.44 | 1.80 | ↑ | 0.56 | 3.00 | ↑ | 0.22 | 2.80 | ↑ | 0.56 | 3.40 | ↑ |
| Generally Tasty | salty | 0.00 | 0.20 | | 0.00 | 0.00 | | 0.00 | 0.00 | | 0.00 | 0.00 | |
| Generally Tasty | nutty | 1.89 | 0.80 | ↓ | 1.11 | 0.80 | ↓ | 1.33 | 1.20 | ↓ | 0.78 | 1.40 | ↓ |
| Treatment | | BC + MC | | | BC + CC | | | BC + all | | | NO BC &all | | |
| Treatment time | | 198 min. | | | 198 min. | | | 198 min. | | | 198 min. | | |
| Wash time | | 198 min. | | | 198 min. | | | 198 min. | | | 198 min. | | |
| Treatment temp. | | 60° C. | | | 60° C. | | | 60° C. | | | 60° C. | | |
| Ferm. temp. | | | 22° C. | | | 22° C. | | | 22° C. | | | 22° C. | |
| Ferm. time days | | | 14 | | | 14 | | | 14 | | | 14 | |

TABLE 8
B

| | | | | treatment | wash | status | status | bite | general |
|---|---|---|---|---|---|---|---|---|---|
| | | | | time | time | of the | of the | impressions | impressions |
| Group | Tests | | treatment | (minutes) | (minutes) | pulse | seed coat | count | count |
| 104 | 10 | nf | 5% “BC” | 2 × 99 | 2 × 99 | partially | released | “light”: 10 | “neutral”: 6 |
| | | | | | | intact | | | “pleasant”: 5 |
| | | | | | | | | | “sweet”: 1 |
| | | | | | | | | | pleasant: 6 |
| | | | | | | | | | dairy feel: 1 |
| | | | | | | | | | very pleasant: 1 |
| 123 | 5 | Y.F | 5% “BC” | 2 × 99 | 2 × 99 | partially | released | “light”: 4 | “pleasant”: 6 |
| | | | | | | intact | | “very | “neutral”: 1 |
| | | | | | | | | light”: 1 | “dairy feel”: 3 |
| | | | | | | | | | “dairy like”: 1 |
| | | | | | | | | | “no off tone”: 1 |
| | | | | | | | | | “pleasant acids”: 1 |
| | | | | | | | | | “sweet”: 1 |
| | | | | | | | | | “yogurt”: 1 |
| 105 | 10 | nf | 5% BC + 0.5% “CS” | 2 × 99 | 2 × 99 | partially | released | “light”: 8 | “neutral”: 5 |
| | | | | | | intact | | “tender”: 2 | “very neutral”: 1 |
| | | | | | | | | | “pleasant”: 7 |
| | | | | | | | | | “very pleasant”: 1 |
| | | | | | | | | | “dairy feel”: 1 |
| | | | | | | | | | “sweet note”: 1 |
| 122 | 5 | Y.F | 5% BC + 0.5% “CS” | 2 × 99 | 2 × 99 | split | released | “light”: 4 | “pleasant”: 5 |
| | | | | | | | | “very light”: | “neutral”: 1 |
| | | | | | | | | | “fermented |
| | | | | | | | | | dairy”: 1 |
| | | | | | | | | | “dairy like”: 1 |
| | | | | | | | | | “dairy feel”: 1 |
| | | | | | | | | | “pleasant acid”: 1 |
| | | | | | | | | | “complex pleasant |
| | | | | | | | | | acids”: 1 |
| 101 | 10 | nf | 5% BC + “ZC” (140 mg/ | 2 × 99 | 2 × 99 | split | partial | “light”: 8 | “neutral”: 6 |
| | | | liter) + “IN” (140 mg/liter) | | | | release | “tender”: 1 | “pleasant”: 2 |
| | | | | | | | | “flaky”: 1 | |
| 125 | 5 | Y.F | 5% BC + “ZC” (140 mg/ | 2 × 99 | 2 × 99 | split | released | “light”: 5 | “yogurt like”: 1 |
| | | | liter) + “IN” (140 mg/liter) | | | | | | “pleasant”: 4 |
| | | | | | | | | | “lactic acid”: 1 |
| | | | | | | | | | “dairy like”: 1 |
| | | | | | | | | | “sweet-sour”: 1 |
| | | | | | | | | | “dairy feel”: 2 |
| 91 | 10 | nf | 5% BC + 0.5% “CL” | 2 × 99 | 2 × 99 | split | released | “light”: 9 | “neutral”: 4 |
| | | | | | | | | | “pleasant”: 6 |
| | | | | | | | | | “sweet”: 1 |
| | | | | | | | | | “very neutral”: 1 |
| | | | | | | | | | “very pleasant”: 1 |
| 130 | 5 | Y.F | 5% BC + 0.5% “CL” | 2 × 99 | 2 × 99 | split | released | “light”: 4 | “dairy feel”: 3 |
| | | | | | | | | “tender”: 1 | “very pleasant”: 1 |
| | | | | | | | | | “pleasant”: 3 |
| | | | | | | | | | “fermented dairy”: 1 |
| | | | | | | | | | “yogurt feel”: 1 |
| 99 | 10 | nf | 5% BC + 0.5% “MC” | 2 × 99 | 2 × 99 | split | released | “light”: 3 | “neutral”: 5 |
| | | | | | | | | “tender”: 3 | “pleasant”: 6 |
| | | | | | | | | “crunchy”: 2 | “very pleasant”: 1 |
| | | | | | | | | “flaky”: 2 | |
| 127 | 5 | Y.F | 5% BC + 0.5% “MC” | 2 × 99 | 2 × 99 | split | released | “tender”: 1 | “neutral”: 2 |
| | | | | | | | | “light”: 2 | “nice balance”: 1 |
| | | | | | | | | “crunchy”: 1 | “light acid”: 1 |
| | | | | | | | | | “pleasant”: 2 |
| | | | | | | | | | “very pleasant”: 1 |
| | | | | | | | | | “dairy”: 1 |
| 103 | 10 | nf | 5% BC + 0.5% “CC” | 2 × 99 | 2 × 99 | split | released | “tender”: 2 | “neutral”: 7 |
| | | | | | | | | “light”: 5 | “very neutral”: 1 |
| | | | | | | | | “crunchy”: 3 | “very pleasant”: 1 |
| | | | | | | | | | “slightly acid”: 1 |
| 126 | 5 | Y.F | 5% BC + 0.5% “CC” | 2 × 99 | 2 × 99 | split | released | “light”: 5 | “neutral”: 2 |
| | | | | | | | | | “pleasant”: 2 |
| | | | | | | | | | “very pleasant”: 1 |
| | | | | | | | | | “dairy feel”: 1 |
| | | | | | | | | | “dairy like”: 1 |
| | | | | | | | | | “complex tasty |
| | | | | | | | | | acid”: 1 |
| | | | | | | | | | “yogurt like”: 1 |
| 100 | 10 | nf | 5% BC + 0.5% “CC” + 0.5% | 2 × 99 | 2 × 99 | most | most | “light”: 2 | “neutral”: 3 |
| | | | “CS” + 0.5% “CC” + 0.5% “MC” | | | split | released | “flaky”: 2 | “pleasant”: 3 |
| | | | | | | | | “crunchy”: 4 | |
| 129 | 5 | Y.F | 5% BC + 0.5% “CC” + 0.5% | 2 × 99 | 2 × 99 | split | released | “tender”: 1 | “neutral”: 2 |
| | | | “CS” + 0.5% “CC” + 0.5% “MC” | | | | | “light”: 3 | “pleasant”: 4 |
| | | | | | | | | “crunchy”: 1 | “pleasant but |
| | | | | | | | | | acid”: 1 |
| | | | | | | | | | “fermented |
| | | | | | | | | | dairy”: 1 |
| | | | | | | | | | “yogurt feel”: 1 |
| | | | | | | | | | “citrus feel”: 1 |
| | | | | | | | | | “dairy feel”: 1 |
| 102 | 10 | nf | NO “BC” + 0.5% “CC” + 0.5% | 2 × 99 | 2 × 99 | split | released. | “chewy”: 2 | “neutral”: 5 |
| | | | “CS” + 0.5% “CC” + 0.5% “MC” | | | | | “flaky”: 1 | “some unpleasant |
| | | | | | | | | “crunchy”: 7 | note”: 1 |
| 128 | 5 | Y.F | NO “BC” + 0.5% “CC” + 0.5% | 2 × 99 | 2 × 99 | split | released | “tender”: 1 | “neutral”: 1 |
| | | | “CS” + 0.5% “CC” + 0.5% “MC” | | | | | “crunchy”: 3 | “pleasant”: 4 |
| | | | | | | | | “flaky”: 1 | “very pleasant”: 1 |
| | | | | | | | | | “yogurt feel”: 1 |
| | | | | | | | | | “less dairy like”: 1 |

Table 8 (panel A & B) “Y.F.” or “YF” is an abbreviation to identify the groups that have been fermented for two weeks by a vegan kefir ferment.

“BC” means sodium bicarbonate. “CS” is calcium sulphate. “CL” is calcium lactate. “CC” is calcium carbonate. “ZC” is zinc. “IN” is iron. “MC” is magnesium chloride. “NO BC” means that sodium bicarbonate is absent. And herein “all” means BC+CS+CL+CC+MC but not with ZC+IN. In these tests, the concentration for BC is 5%, for CC, CS, CL and MC (magnesium chloride)=each 0.5%. And the concentration of IN and for ZC is 140 mg/liter each.

TABLE 9A

| | | | | Treat | Treatment | | Wash | Wash | | |
|---|---|---|---|---|---|---|---|---|---|---|
| | Seed | | | time | temperature | Treatment | time | temperature | Wash | Additional |
| Group | coat | BC % | pH | (min.) | in ° C. | way | (min.) | in ° C. | way | wash |
| DS2 | yes | 5 | 8.3 | 198 | 60 | moving | 198 | 60 | moving | rinse |
| DSw | yes | 2.5 | 8.3 | 60 | 60 | moving | 99 | 60 | moving | rinse |
| DSy | yes | 0 | 7.6 | 60 | 60 | moving | 99 | 60 | moving | rinse |
| DSa8 | yes | 1 | 6.4 | 99 | 60 | moving | 99 | 60 | moving | rinse |
| DS3 | yes | 0 | 6.4 | 720 | 4 | static | 720 | 4 | static | rinse |
| DSi1 | yes | 0 | 7.6 | 720 | 4 | static | 720 | 4 | static | rinse |
| DSi2 | NO | 0 | 7.6 | 720 | 4 | static | 720 | 4 | static | rinse |
| DSi3 | yes | 5 | 7.6 | 720 | 4 | static | 720 | 4 | static | rinse |
| DSi4 | yes | 5 | 7.6 | 720 | 20 | static | 720 | 20 | static | rinse |
| DSi5 | yes | 1 | 7.6 | 720 | 4 | static | 720 | 4 | static | rinse |
| DSi6 | yes | 1 | 7.6 | 720 | 20 | static | 720 | 20 | static | rinse |

| | | | | | | | Honey- | | Citrus | | |
|---|---|---|---|---|---|---|---|---|---|---|---|
| Group | sulfur | grassy | bitter | earthy | metallic | pungent | like | cucumber | like | salty | nutty |
| DS2 | 0 | 0.7 | 0 | 0 | 0 | 0 | 1.8 | 1.6 | 1.1 | 0 | 1.8 |
| DSw | 0 | 2.7 | 0.8 | 0.1 | 0.3 | 0 | 1.8 | 3.3 | 1.6 | 0 | 2 |
| DSy | 0.3 | 3.8 | 3 | 0.1 | 0.7 | 0 | 1.1 | 3.7 | 2.6 | 0 | 2.2 |
| DSa8 | 0.0 | 0.9 | 0.3 | 0.0 | 0.0 | 0.0 | 1.6 | 2.0 | 0.1 | 0.0 | 2.0 |
| DS3 | 0.7 | 6.2 | 5.1 | 1.1 | 2.3 | 0.9 | 1.4 | 5.3 | 3.2 | 0.3 | 1.9 |
| DSi1 | 1.6 | 7.1 | 6.4 | 3.1 | 3.2 | 2.3 | 1.7 | 5.5 | 2.2 | 0.9 | 2.2 |
| DSi2 | 1.7 | 7.1 | 7.5 | 3.6 | 3.8 | 2.2 | 1.7 | 4.2 | 1.8 | 0.9 | 2.3 |
| DSi3 | 2.2 | 6.2 | 5.3 | 3.4 | 3.8 | 1.7 | 1.4 | 2.3 | 1.5 | 0.8 | 1.4 |
| DSi4 | 1.9 | 5.9 | 4.1 | 4.1 | 3.8 | 1.4 | 1.2 | 2.2 | 1.2 | 1.0 | 1.8 |
| DSi5 | 2.2 | 6.0 | 4.4 | 4.3 | 3.9 | 1.4 | 1.2 | 2.4 | 1.4 | 0.9 | 1.6 |
| DSi6 | 2.2 | 6.4 | 5.6 | 3.8 | 4.1 | 1.4 | 1.6 | 2.7 | 1.3 | 1.0 | 2.0 |

TABLE 9B

| Group | DS2 | DSw | DSy | DSa8 | DS3 | DSi1 | DSi2 | DSi3 | DSi4 | DSi5 | DSi6 |
|---|---|---|---|---|---|---|---|---|---|---|---|
| sulfur | 0 | 0 | 0.3 | 0.0 | 0.7 | 1.6 | 1.7 | 2.2 | 1.9 | 2.2 | 2.2 |
| green/grassy | 0.7 | 2.7 | 3.8 | 0.9 | 6.2 | 7.1 | 7.1 | 6.2 | 5.9 | 6.0 | 6.4 |
| bitter | 0 | 0.8 | 3 | 0.3 | 5.1 | 6.4 | 7.5 | 5.3 | 4.1 | 4.4 | 5.6 |
| earthy | 0 | 0.1 | 0.1 | 0.0 | 1.1 | 3.1 | 3.6 | 3.4 | 4.1 | 4.3 | 3.8 |
| metallic | 0 | 0.3 | 0.7 | 0.0 | 2.3 | 3.2 | 3.8 | 3.8 | 3.8 | 3.9 | 4.1 |
| pungent | 0 | 0 | 0 | 0.0 | 0.9 | 2.3 | 2.2 | 1.7 | 1.4 | 1.4 | 1.4 |
| honey-like | 1.8 | 1.8 | 1.1 | 1.6 | 1.4 | 1.7 | 1.7 | 1.4 | 1.2 | 1.2 | 1.6 |
| cucumber | 1.6 | 3.3 | 3.7 | 2.0 | 5.3 | 5.5 | 4.2 | 2.3 | 2.2 | 2.4 | 2.7 |
| citrus-like | 1.1 | 1.6 | 2.6 | 0.1 | 3.2 | 2.2 | 1.8 | 1.5 | 1.2 | 1.4 | 1.3 |
| salty | 0 | 0 | 0 | 0.0 | 0.3 | 0.9 | 0.9 | 0.8 | 1.0 | 0.9 | 1.0 |
| nutty | 1.8 | 2 | 2.2 | 2.0 | 1.9 | 2.2 | 2.3 | 1.4 | 1.8 | 1.6 | 2.0 |
| BC Additive % | 5 | 2.5 | 0 | 1 | 0 | 0 | 0 | 5 | 5 | 1 | 1 |
| pH | 8.3 | 8.3 | 7.6 | 6.4 | 6.5 | 7.6 | 7.6 | 7.6 | 7.6 | 7.6 | 7.6 |
| Treat time (min.) | 198 | 60 | 60 | 99 | 1440 | 1440 | 1440 | 720 | 720 | 720 | 720 |
| Treat temp ° C. | 60 | 60 | 60 | 60 | 4 | 4 | 4 | 4 | 20 | 4 | 20 |
| Treatment way | moving | moving | moving | moving | static | static | static | static | static | static | static |
| Wash time (min.) | 198 | 99 | 99 | 99 | 0 | 0 | 0 | 720 | 720 | 720 | 720 |
| Wash temp. ° C. | 60 | 60 | 60 | 60 | 0 | 0 | 0 | 4 | 20 | 4 | 20 |
| Wash way | moving | moving | moving | moving | static | static | static | static | static | static | static |
| additional wash | rinse | rinse | rinse | rinse | rinse | rinse | rinse | rinse | rinse | rinse | rinse |
| pea state | with SC | with SC | with SC | with SC | with SC | with SC | NO SC | with SC | with SC | with SC | with SC |

TABLE 10
A

| | Group | A4 | A1 | A15 | A14 | A5 | A10 | A2 | A3 |
|---|---|---|---|---|---|---|---|---|---|
| Generally Repellent | sulfur | 0.2 | 0.0 | 0.0 | 0.0 | 0.0 | 0.0 | 0.0 | 0.0 |
| Generally Repellent | green/grassy | 2.8 | 2.6 | 1.3 | 1.0 | 0.2 | 0.0 | 0.0 | 0.6 |
| Generally Repellent | bitter | 1.0 | 1.0 | 0.3 | 0.2 | 0.0 | 0.0 | 0.0 | 0.2 |
| Generally Repellent | earthy | 0.3 | 0.4 | 0.4 | 0.0 | 0.0 | 0.0 | 0.0 | 0.0 |
| Generally Repellent | metallic | 0.8 | 0.4 | 0.2 | 0.0 | 0.0 | 0.0 | 0.0 | 0.0 |
| Generally Repellent | pungent | 0.2 | 0.0 | 0.0 | 0.0 | 0.0 | 0.0 | 0.0 | 0.0 |
| Generally Tasty | honey-like | 2.6 | 2.7 | 2.7 | 2.4 | 3.6 | 3.3 | 2.4 | 3.0 |
| Generally Tasty | cucumber | 3.0 | 3.1 | 2.4 | 2.6 | 2.6 | 2.6 | 2.7 | 2.4 |
| Generally Tasty | citrus-like | 1.2 | 0.9 | 1.0 | 0.9 | 0.4 | 0.6 | 0.2 | 0.3 |
| Generally Tasty | salty | 0.0 | 0.0 | 0.4 | 0.2 | 0.1 | 0.1 | 0.0 | 0.1 |
| Generally Tasty | nutty | 2.0 | 2.3 | 2.9 | 2.9 | 3.0 | 3.0 | 2.2 | 3.3 |
| | BC Additive | 1% BC | 5% BC | 1% BC | 5% BC | 1% BC | 5% BC | 1% BC | 5% BC |
| | Extra additive | | | | | | | | |
| | pH | 8.3 | 8.3 | 8.3 | 8.3 | 8.3 | 8.3 | 8.3 | 8.3 |
| | Treat time (min.) | 15 | 15 | 15 | 15 | 15 | 15 | 15 | 15 |
| | Treat temp ° C. | 60 | 60 | 70 | 70 | 80 | 80 | 90 | 90 |
| | Wash time (min.) | 30 | 30 | 30 | 30 | 30 | 30 | 30 | 30 |
| | Wash temp. ° C. | 60 | 60 | 60 | 60 | 60 | 60 | 60 | 60 |

TABLE 10
B

| | | treat | | Green/ | | | | | Honey | | Citrus | | | |
|---|---|---|---|---|---|---|---|---|---|---|---|---|---|---|
| group | BC % | temp ° C. | sulfur | grassy | bitter | earthy | metallic | pungent | like | cucumber | like | salty | nutty | FC % |
| A4 | 1.0 | 60.0 | 0.2 | 2.8 | 1.0 | 0.3 | 0.8 | 0.2 | 2.6 | 3.0 | 1.2 | 0.0 | 2.0 | 25.4 |
| A1 | 5.0 | 60.0 | 0.0 | 2.6 | 1.0 | 0.4 | 0.4 | 0.0 | 2.7 | 3.1 | 0.9 | 0.0 | 2.3 | 25.4 |
| A15 | 1.0 | 70.0 | 0.0 | 1.3 | 0.3 | 0.4 | 0.2 | 0.0 | 2.7 | 2.4 | 1.0 | 0.4 | 2.9 | 17.9 |
| A14 | 5.0 | 70.0 | 0.0 | 1.0 | 0.2 | 0.0 | 0.0 | 0.0 | 2.4 | 2.6 | 0.9 | 0.2 | 2.9 | 22.4 |
| A5 | 1.0 | 80.0 | 0.0 | 0.2 | 0.0 | 0.0 | 0.0 | 0.0 | 3.6 | 2.6 | 0.4 | 0.1 | 3.0 | 10.3 |
| A10 | 5.0 | 80.0 | 0.0 | 0.0 | 0.0 | 0.0 | 0.0 | 0.0 | 3.3 | 2.6 | 0.6 | 0.1 | 3.0 | 7.2 |
| A2 | 1.0 | 90.0 | 0.0 | 0.0 | 0.0 | 0.0 | 0.0 | 0.0 | 2.4 | 2.7 | 0.2 | 0.0 | 2.2 | 7.1 |
| A3 | 5.0 | 90.0 | 0.0 | 0.6 | 0.2 | 0.0 | 0.0 | 0.0 | 3.0 | 2.4 | 0.3 | 0.1 | 3.3 | 2.9 |
| Dsi1 | 0.0 | 4.0 | 1.6 | 7.1 | 6.4 | 3.1 | 3.2 | 2.3 | 1.7 | 5.5 | 2.2 | 0.9 | 2.2 | 28.8 |

TABLE 11
A

| | | Green/ | | | | | Honey | | Citrus | | |
|---|---|---|---|---|---|---|---|---|---|---|---|
| Group | Sulfur | grassy | Bitter | Earthy | Metallic | Pungent | like | Cucumber | like | Salty | Nutty |
| 2 | 0.0 | 0.8 | 0.0 | 0.0 | 0.0 | 0.0 | 1.2 | 1.2 | 1.2 | 0.0 | 1.5 |
| Y | 0.3 | 3.8 | 3 | 0.1 | 0.7 | 0 | 1.1 | 3.7 | 2.6 | 0 | 2.2 |
| E | 0 | 3.4 | 2.5 | 0.2 | 0.5 | 0.1 | 1.1 | 3.7 | 2.2 | 0.1 | 1.8 |
| G | 0 | 3 | 2.1 | 0 | 0.2 | 0 | 1.8 | 3.1 | 1.4 | 0 | 1.8 |
| R | 0 | 2.7 | 0.8 | 0.1 | 0.3 | 0 | 1.8 | 3.3 | 1.6 | 0 | 2 |
| C | 0 | 3.7 | 1.1 | 0.1 | 0.4 | 0.1 | 1.6 | 3.6 | 1.7 | 0 | 2.1 |
| F | 0 | 1.4 | 0.8 | 0.1 | 0.3 | 0 | 1.5 | 2.7 | 0.9 | 0 | 2.3 |
| M | 0 | 4.4 | 2.3 | 0.5 | 0.6 | 0 | 1.3 | 4.2 | 2.1 | 0 | 1.5 |
| V | 0.1 | 3.8 | 1.1 | 0.2 | 0.4 | 0.1 | 2 | 3.7 | 2.2 | 0 | 1.4 |
| 80 | 0.1 | 0.1 | 0.0 | 0.0 | 0.0 | 0.0 | 3.3 | 3.6 | 0.6 | 0.7 | 4.6 |
| 83 | 0.0 | 0.0 | 0.0 | 0.0 | 0.0 | 0.0 | 4.2 | 2.9 | 0.6 | 0.9 | 4.9 |
| 47 | 0 | 0.2 | 0 | 0.1 | 0 | 0 | 3.6 | 3 | 0.5 | 0 | 5.3 |
| T | 0.0 | 0.4 | 0.0 | 0.0 | 0.0 | 0.0 | 3.3 | 1.7 | 0.6 | 0.3 | 4.2 |
| D | 0.0 | 0.8 | 0.0 | 0.0 | 0.0 | 0.0 | 2.8 | 1.9 | 0.8 | 0.0 | 3.6 |
| 48 | 0.1 | 0 | 0 | 0 | 0 | 0 | 5 | 2.2 | 0.9 | 0.1 | 5.3 |
| S | 0 | 0 | 0 | 0 | 0 | 0 | 3.9 | 1.7 | 0.3 | 0.1 | 4.5 |
| P | 0 | 0 | 0 | 0 | 0 | 0 | 2.1 | 1.6 | 0.4 | 0 | 2.2 |
| L | 0 | 0.6 | 0.1 | 0.3 | 0 | 0 | 3.4 | 2.2 | 1.7 | 0 | 3.4 |
| J | 0.0 | 0.3 | 0.0 | 0.0 | 0.0 | 0.0 | 4.4 | 2.2 | 0.8 | 0.0 | 4.6 |
| O | 0 | 0.3 | 0 | 0 | 0 | 0 | 2.8 | 2 | 0.6 | 0 | 4.3 |
| I | 0 | 0.1 | 0 | 0 | 0 | 0 | 2.7 | 2 | 0.7 | 0 | 3 |
| W | 0 | 0.3 | 0 | 0.1 | 0 | 0 | 3.7 | 1.9 | 0.7 | 0.1 | 4.9 |
| X | 0 | 0 | 0 | 0 | 0 | 0 | 2.7 | 1.8 | 0.3 | 0 | 3.1 |
| A | 0 | 0.3 | 0 | 0 | 0 | 0 | 3.7 | 1.8 | 0.3 | 0 | 4 |
| B | 0 | 0.1 | 0 | 0 | 0 | 0 | 3.4 | 1.8 | 0.8 | 0.1 | 3.2 |
| H | 0 | 0.3 | 0 | 0 | 0 | 0 | 3 | 1.9 | 0.7 | 0 | 3.9 |
| K | 0 | 0.7 | 0 | 0 | 0 | 0 | 2.6 | 1.9 | 0.9 | 0 | 2.8 |
| 1 | 0 | 0.6 | 0 | 0 | 0 | 0 | 2.1 | 1.9 | 0.7 | 0 | 2.9 |
| Q | 0 | 0 | 0 | 0 | 0 | 0 | 3.2 | 1.4 | 0.8 | 0.1 | 3.1 |
| U | 0.1 | 0.2 | 0 | 0 | 0 | 0 | 2.7 | 1.7 | 0.4 | 0.2 | 3.2 |
| Z | 0 | 0.6 | 0.2 | 0 | 0 | 0 | 2.9 | 2 | 0.7 | 0 | 3.4 |

TABLE 11
B

| | | | | | | | | | T | M | M dry |
|---|---|---|---|---|---|---|---|---|---|---|---|
| | BC | | | Treat | Treat | Wash | Wash | | steam | steamed | roast |
| | Additive | extra | | time | temp | time | temp. | Wash | time | time | time |
| group | % | additive | pH | (min.) | ° C. | (min.) | ° C. | additional | (min.) | (min.) | (min.) |
| 2 | 5 | | 8.3 | 198 | 60 | 198 | 60 | rinse | 0 | 0 | 0 |
| Y | 0 | | 8.3 | 60 | 60 | 99 | 60 | rinse | 0 | 0 | 0 |
| E | 2.5 | H₂O₂ | 8.3 | 60 | 60 | 99 | 60 | rinse | 0 | 0 | 0 |
| G | 0 | H₂O₂ | 8.3 | 60 | 60 | 0 | | rinse | 0 | 0 | 0 |
| R | 2.5 | | 8.3 | 60 | 60 | 99 | 60 | rinse | 0 | 0 | 0 |
| C | 2.5 | SG | 8.3 | 60 | 60 | 60 | 60 | rinse | 0 | 0 | 0 |
| F | 2.5 | SG | 8.3 | 60 | 60 | 99 | 60 | rinse | 0 | 0 | 0 |
| M | 0 | SG | 8.3 | 60 | 60 | 99 | 60 | rinse | 0 | 0 | 0 |
| V | 2.5 | ET | 8.3 | 60 | 60 | 99 | 60 | rinse | 0 | 0 | 0 |
| 80 | 5 | | 8.3 | 60 | 60 | 99 | 60 | rinse | 40 | 0 | 0 |
| 83 | 1 | | 8.3 | 60 | 60 | 99 | 60 | rinse | 40 | 0 | 0 |
| 47 | 5 | | 8.3 | 60 | 60 | 0 | | rinse | 40 | 0 | 0 |
| T | 2.5 | | 8.3 | 60 | 60 | 0 | | rinse | 40 | 0 | 0 |
| D | 0 | | 8.3 | 60 | 60 | 0 | | rinse | 40 | 0 | 0 |
| 48 | 1 | | 8.3 | 60 | 60 | 0 | | rinse | 40 | 0 | 0 |
| S | 2.5 | ET | 8.3 | 60 | 60 | 0 | | rinse | 40 | 0 | 0 |
| P | 2.5 | H₂O₂ | 8.3 | 60 | 60 | 0 | | rinse | 40 | 0 | 0 |
| L | 0 | H₂O₂ | 8.3 | 60 | 60 | 0 | | rinse | 40 | 0 | 0 |
| J | 0 | SG | 8.3 | 60 | 60 | 0 | | rinse | 40 | 0 | 0 |
| O | 0 | SG | 8.3 | 60 | 60 | 0 | | rinse | 40 | 0 | 0 |
| I | 2.5 | H₂O₂ + SG | 8.3 | 60 | 60 | 0 | | rinse | 40 | 0 | 0 |
| W | 2.5 | | 8.3 | 60 | 60 | 0 | | rinse | 40 | 0 | 10 |
| X | 2.5 | H₂O₂ + SG | 8.3 | 60 | 60 | 99 | 60 | rinse | 40 | 0 | 10 |
| A | 2.5 | ET | 8.3 | 60 | 60 | 99 | 60 | rinse | 0 | 4 | 0 |
| B | 2.5 | SG | 8.3 | 60 | 60 | 99 | 60 | rinse | 0 | 4 | 0 |
| H | 2.5 | ET | 8.3 | 60 | 60 | 99 | 60 | rinse | 0 | 4 | 0 |
| K | 2.5 | | 8.3 | 60 | 60 | 99 | 60 | rinse | 0 | 4 | 0 |
| 1 | 2.5 | H₂O₂ | 8.3 | 60 | 60 | 99 | 60 | rinse | 0 | 4 | 0 |
| Q | 0 | H₂O₂ | 8.3 | 60 | 60 | 99 | 60 | rinse | 0 | 4 | 0 |
| U | 0 | | 8.3 | 60 | 60 | 99 | 60 | rinse | 0 | 4 | 0 |
| Z | 0 | SG | 8.3 | 60 | 60 | 99 | 60 | rinse | 0 | 4 | 0 |

TABLE 12
indicating the inhibitors of leaching

| | | Process | Process | BC | CC | CS | CL | Iron | Zinc |
|---|---|---|---|---|---|---|---|---|---|
| | | Time | temperature | treatment | treatment | treatment | Treatment | treatment | treatment |
| Group | Process | minutes | ° C. | % BC | % CC | % CS | % CL | mg | mg |
| C1 | stirred | 60 | 80 | 5 | 0 | 0 | 0 | 0 | 0 |
| C2 | stirred | 60 | 80 | 5 | 2 | 0 | 0 | 0 | 0 |
| C3 | stirred | 60 | 80 | 5 | 0 | 2 | 0 | 0 | 0 |
| C4 | stirred | 60 | 80 | 5 | 0 | 0 | 2 | 0 | 0 |

| | | Wash | Wash | | More weight | Higher weight |
|---|---|---|---|---|---|---|
| | | time | temperature | Weight | gram versus | in % versus |
| Group | Wash | minutes | ° C. | gram | Group C1 | Group C1 |
| C1 | rinse | 10 | 22 | 197.8 | 0 | 0 |
| C2 | rinse | 10 | 22 | 220.0 | 22.2 | 11.2 |
| C3 | rinse | 10 | 22 | 252.0 | 54.2 | 27.4 |
| C4 | rinse | 10 | 22 | 244.8 | 47.0 | 23.8 |

TABLE 13
indicating the inhibitors of leaching

| | | Process | Process | BC | CC | CS | CL | Iron |
|---|---|---|---|---|---|---|---|---|
| | | Time | temperature | treatment | treatment | treatment | treatment | treatment |
| Group | Process | minutes | ° C. | % | % | % | % | mg |
| C5 | stirred | 200 | 80 | 5 | 0 | 0 | 0 | 0 |
| C6 | stirred | 200 | 80 | 5 | 0 | 0 | 0 | 280 |
| C7 | stirred | 200 | 80 | 5 | 0 | 0 | 0 | 0 |
| C8 | stirred | 200 | 80 | 5 | 1 | 1 | 1 | 0 |

| | | | | | | | More | Higher |
|---|---|---|---|---|---|---|---|---|
| | | | | | | | weight | weight |
| | | | | | | post | gram | in % |
| | Zinc | MC | | Wash | Wash | treatment | versus | versus |
| | treatment | treatment | | time | temperature | weight | Group | Group |
| Group | mg | %_MC | Wash | minutes | ° C. | gram | C5″ | C5 |
| C5 | 0 | 0 | stirring | 100 | 60 | 101.8 | 0 | 0 |
| C6 | 100 | 0 | stirring | 100 | 60 | 106.7 | 5.0 | 2.5 |
| C7 | 0 | 1 | stirring | 100 | 60 | 114.4 | 12.7 | 6.4 |
| C8 | 0 | 0 | stirring | 100 | 60 | 153.6 | 51.9 | 26.2 |

Dry peas material off tone testing (samples A-N - Example 20)

| | | | | Treatment | Off Tone | Off Tone |
|---|---|---|---|---|---|---|
| | | | Treatment | process | Intensity | Intensity Scale |
| | Treatment | Treatment | process | temperature | Scale 1-10 | 1-10 Standard |
| Group | BC % | process | time hours | ° C. | Average | deviation |
| A | 0 | stirred | 3.3 | 60 | 2.3 | 2.4 |
| B | 2.5 | stirred | 3.3 | 60 | 2.4 | 1.6 |
| C | 5 | stirred | 3.3 | 60 | 1.9 | 1.6 |
| D | 10 | stirred | 3.3 | 60 | 1.3 | 0.5 |
| E | 0 | static soak | 12 | 22 | 7.0 | 0.9 |
| F | 2.5 | static soak | 12 | 22 | 4.7 | 2.9 |
| G | 5 | static soak | 12 | 22 | 4.4 | 2.8 |
| H | 5 | static soak | 24 | 22 | 3.2 | 0.8 |
| I | 0 | static soak | 24 | 22 | 8.9 | 0.4 |
| J | 2.5 | static soak | 24 | 22 | 6.1 | 2.7 |
| K | 5 | stirred | 3.3 | 80 | 1.1 | 0.4 |
| L | 5 | stirred | 3.3 | 60 | 1.0 | 0.0 |
| M | 5 | stirred | 3.3 | 40 | 3.3 | 2.2 |
| N | 5 | stirred | 3.3 | 20 | 3.3 | 2.3 |

Table 14 displays the result on the panel taste testing of the freeze-dried yellow pea material. In the headings 1) “Group” is an identifier for the experimental group or treatment condition (a 6 sample replicate group), 2) “Treatment BC %) provides the percentage concentration of the sodium bicarbonate (weight/weight percent (w/w %) on the treatment water), 3) “Treatment process” concerns a type or method of treatment applied (static soaking or continuous stirring wherein the pea material moves in the treatment water), 4) “Treatment process time hours” concerns the duration of the treatment process, expressed in hours, 5) “Treatment process temperature ° C.” concerns the temperature in degrees Celsius at which the treatment was carried out, 6) “Off Tone Intensity Scale 1-10 Average” concerns the average perceived intensity of off-tones, where: 1=no off-tone, and 10=extremely intense off-tone and 7) “Off Tone Intensity Scale 1-10_Standard_deviation” concerns the standard deviation of off-tone scores, reflecting the variability or consistency in sensory evaluations among panelists.

Wet pea material off tone testing (samples A-V- Example 20)

| | | | | | | | | | | | Off Tone |
|---|---|---|---|---|---|---|---|---|---|---|---|
| | | | | | | | | Treatment | Treatment | Off Tone | Intensity |
| | | | | | | | | process | process | Intensity | Scale 1-10 |
| | Treatment | Treatment | Treatment | Treatment | Treatment | Treatment | Treatment | time | temperature | Scale 1-10 | Standard |
| Group | BC % | CC % | CL % | Iron mg | Zinc mg | MC % | process | hours | ° C. | Average | deviation |
| A | 0 | 0 | 0 | 0 | 0 | 0 | stirred | 3.3 | 60 | 2.6 | 2.5 |
| B | 2.5 | 0 | 0 | 0 | 0 | 0 | stirred | 3.3 | 60 | 1.6 | 1.0 |
| C | 5 | 0 | 0 | 0 | 0 | 0 | stirred | 3.3 | 60 | 1.3 | 0.8 |
| D | 10 | 0 | 0 | 0 | 0 | 0 | stirred | 3.3 | 60 | 1.3 | 0.5 |
| E | 0 | 0 | 0 | 0 | 0 | 0 | static soak | 12 | 22 | 8.3 | 0.8 |
| F | 2.5 | 0 | 0 | 0 | 0 | 0 | static soak | 12 | 22 | 7.9 | 2.0 |
| G | 5 | 0 | 0 | 0 | 0 | 0 | static soak | 12 | 22 | 4.4 | 3.1 |
| H | 5 | 0 | 0 | 0 | 0 | 0 | static soak | 24 | 22 | 3.7 | 1.9 |
| I | 0 | 0 | 0 | 0 | 0 | 0 | static soak | 24 | 22 | 8.7 | 0.5 |
| J | 2.5 | 0 | 0 | 0 | 0 | 0 | static soak | 24 | 22 | 6.3 | 2.2 |
| K | 5 | 0 | 0 | 0 | 0 | 0 | stirred | 3.3 | 80 | 1.1 | 0.4 |
| L | 5 | 0 | 0 | 0 | 0 | 0 | stirred | 3.3 | 60 | 1.1 | 0.4 |
| M | 5 | 0 | 0 | 0 | 0 | 0 | stirred | 3.3 | 40 | 2.3 | 1.7 |
| N | 5 | 0 | 0 | 0 | 0 | 0 | stirred | 3.3 | 20 | 3.6 | 1.4 |
| O | 2 | 0 | 0 | 0 | 0 | 0 | stirred | 3.3 | 55 | 1.0 | 0.0 |
| P | 2 | 1 | 1 | 0 | 0 | 0 | stirred | 3.3 | 55 | 2.3 | 1.4 |
| Q | 2 | 0 | 0 | 140 | 50 | 0 | stirred | 3.3 | 55 | 1.2 | 0.4 |
| R | 2 | 0 | 0 | 0 | 0 | 1 | stirred | 3.3 | 55 | 1.8 | 0.8 |
| S | 2.5 | 0 | 0 | 0 | 0 | 0 | stirred | 1.7 | 75 | 1.3 | 0.8 |
| T | 2.5 | 1 | 1 | 0 | 0 | 1 | stirred | 1.7 | 75 | 1.2 | 0.4 |
| U | 2.5 | 0 | 0 | 0 | 0 | 0 | stirred | 1.7 | 75 | 1.0 | 0.0 |
| V | 2.5 | 0 | 0 | 140 | 50 | 0 | stirred | 1.7 | 75 | 1.0 | 0.0 |

Table 15 provides averages and standard deviation of an off-tone intensity observed by a panel of six tasters on the wet yellow pea pulse material that were not dried but were tastes directly after the last wash step. This pulse material had not been freeze-dried. It is a 10-point intensity scale 1=nil, 3=slight, 5=moderate, 7=strong, 10=extreme.

Table 16 (referring to Example 21) concerns pea material treatment conditions and wet milling of example 21. Table 16 provides an overview of treatments of field dried yellow peas and the effect thereof on 1) the ability under crossed polarizers to microscopically visualize the Maltese cross on its starch bodies and 2) to separate the individual starch bodies intactly from their cluster (individual starch granules densely packed or embedded within a complex and continuous protein matrix). The headings on each column are 1) “Group,” which is an identifier for each experimental condition or treatment group, 2) “Treatment BC %,” which is the percentage of sodium bicarbonate (weight/weight percent (w/w %) in the water solution used in the treatment, 3) “Treatment CC %,” which is the percentage of calcium chloride (weight/weight percent (w/w %) in the water solution used in the treatment, 4) “Treatment CS %,” which is the percentage of calcium sulphate (weight/weight percent (w/w %) in the water solution used in the treatment, 5) “Treatment CL %,” which is the percentage of calcium lactate weight/weight percent (w/w %) in the water solution used in the treatment, 6) “Treatment Iron mg,” which is the amount of iron (in milligrams in the water solution) used in the treatment, 7) “Treatment Zinc mg,” which is the amount of zinc (in milligrams) in the water solution used in the treatment, 8) “Treatment MC %,” which is the percentage of magnesium chloride (weight/weight percent (w/w %) in the water solution used in the treatment, 9) “Treatment process,” which is the type of processing method used (“stirred” or “static soak”), 10) “Treatment process time hours,” which is the duration of the treatment process in hours, 11) “Treatment process temperature ° C., which is Temperature during the treatment process, in degrees Celsius, 12) “Maltese cross,” which indicates whether the starch granules retained their native semi-crystalline structure (Yes=intact, No=gelatinized) and 13) “Intact Separation,” which indicates whether the starch bodies separate from their cluster (individual starch granules densely packed or embedded within a complex and continuous protein matrix) into intact individual starch bodies. The images in the table show for each treatment a microscopic photo made through the lens 40×/0.65 IOS N-Plan filter and polaroid filter. The treated and wet milled yellow peas sample on the microscope cover glass” was Lugol and Bradford stained and was covered by a cover slip for further microscopic analysis.

What is claimed is:

1. A method of processing produce selected from the group consisting of chickpea (Cicer arietinum), yellow pea (Pisum sativum), common bean (Phaseolus vulgaris), and fava bean (Vicia faba), or tissues thereof, the method comprising:
a) continuously stirring the produce or produce tissues for a period between 1 to 6 hours at a temperature between 50° C. and 70° C. in an aqueous bicarbonate solution or bicarbonate/carbonate solution containing 0.5% to 10 weight/weight percent bicarbonate salt;
b) removing the solution containing off-flavor compounds from the processed produce or produce tissues; and
c) washing the processed produce or produce tissues;
wherein the method substantially diminishes off-flavor while preserving the semi-crystalline structure of starch bodies within the produce or produce tissues.

2. The method according to claim 1, further comprising:
grinding the washed produce or produce tissues to release starch bodies, protein bodies, and fibers into a wet flour mixture.

3. The method according to claim 1, further comprising:
grinding the washed produce or produce tissues to release starch bodies, protein bodies, and fibers into a wet flour mixture and
separating a starch-enriched fraction from a protein-and-fiber-enriched fraction.

4. The method according to claim 1, further comprising:
grinding the washed produce or produce tissues to release starch bodies, protein bodies, and fibers into a wet flour mixture and further comprising separating a starch-enriched fraction from a protein-and-fiber-enriched fraction wherein
i) fractions with increased starch and fractions with increased protein and fiber or
ii) fractions with increased starch and fractions with increased protein and fractions with increased fiber
are separated from wet flour or suspension by collecting particles on different mesh sieves of a sieve shaker or by precipitation, filtration, coagulation, flocculation, and/or centrifugation.

5. The method according to claim 1, further comprising:
grinding the washed produce or produce tissues to release starch bodies, protein bodies, and fibers into a wet flour mixture and further comprising separating a starch-enriched fraction from a protein-and-fiber-enriched fraction wherein
i) fractions with increased starch and fractions with increased protein and fiber or
ii) fractions with increased starch and fractions with increased protein and fractions with increased fiber are separated from wet flour or suspension by collecting particles on different mesh sieves of a sieve shaker or by precipitation, filtration, coagulation, flocculation, and/or centrifugation and
wherein the method further comprises wet milling and/or wet grinding and/or homogenizing the fractions into smaller particle size ingredients.

6. The method according to claim 1, further comprising drying the washed produce or produce tissue and subsequently milling it to release starch bodies, protein bodies, and fibers into a dry flour mixture.

7. The method according to claim 1, further comprising drying the washed produce or produce tissue and subsequently milling it to release starch bodies, protein bodies, and fibers into a dry flour mixture wherein
i) particle fractions with increased starch and particle fractions with increased protein and fiber or
ii) fractions with increased starch and fractions with increased protein and fractions with increased fiber are separated from dry flour.

8. The method according to claim 7, wherein the method further comprising:
grinding the fractions into smaller particle size ingredients.

9. The method according to claim 1, further comprising drying the washed produce or produce tissue and subsequently milling it to release starch bodies, protein bodies, and fibers into a dry flour mixture wherein the dry flour is flow in an air stream through a series sieve with decreased mesh following larger mesh to capture fractions with different particle sizes and different starch, protein and/or fiber content or wherein particle fractions with increased starch and particle fractions with increased protein and fiber are separated from dry flour by air classification into a protein/fiber rich and a starch rich fraction.

10. The method according to claim 9, further comprising:
grinding the fractions into smaller particle size ingredients.

11. The method according to claim 1, wherein the aqueous bicarbonate solution or bicarbonate/carbonate solution comprising bicarbonate salt (MHCO₃), or bicarbonate salt (MHCO₃) and carbonate salt (M₂CO₃) or bicarbonate salt (MHCO₃) and hydroxide salt (MOH), wherein M is an alkali metal cation, and with a pH between pH 7 and 10.

12. The method according to claim 1, wherein the aqueous bicarbonate solution or bicarbonate/carbonate solution comprising bicarbonate salt (MHCO₃), or bicarbonate salt (MHCO₃) and carbonate salt (M₂CO₃), or bicarbonate salt (MHCO₃) and hydroxide salt (MOH), wherein M is an alkali metal cation, and with a pH between pH 7 and 10.

13. The method according to claim 1, wherein the aqueous bicarbonate solution or aqueous bicarbonate/carbonate solution comprises 0.5 to 5% bicarbonate salt (MHCO₃) wherein M is an alkali metal cation and optionally pH is adjusted by a hydroxide salt (MOH), wherein M is an alkali metal cation.

14. The method according to claim 1, wherein the solution is a carbonic acid-bicarbonate-carbonate system comprising sodium bicarbonate (Na⁺HCO₃⁻) or sodium carbonate (Na₂CO₃) or a combination thereof or comprising potassium bicarbonate (KHCO₃) or potassium carbonate (K₂CO₃) or a combination thereof and when comprising base that this is a hydroxide, of the group consisting of sodium hydroxide, potassium hydroxide, calcium hydroxide and magnesium hydroxide.

15. The method according to claim 1, wherein the produce or produce tissue is stirred for at least 30 minutes in the bicarbonate solution or bicarbonate/carbonate solution at a temperature in a range of 55-65° C.

16. The method according to claim 1, wherein aqueous bicarbonate solution or bicarbonate/carbonate solution is provided with a salt or an oxide of anyone of the bivalent ions of the group consisting of Ca⁺⁺, Fe⁺⁺, Mg⁺⁺, and Zn⁺⁺.

17. The method according to claim 1, wherein the chickpea, yellow pea, common bean fava bean produce are as whole pulses (hulled or de-hulled pulses), as split pulses or as chopped solids thereof with a Feret diameter (Dmax) of 1 to 4 mm, or a combination thereof.

18. The method according to claim 1, for preparing a dry flour mixture of the produce or the tissues thereof or a dry produce or tissue thereof with a hexanal level below 0.05 μM/g.

19. The method according to claim 1, wherein the processed produce or produce tissues have an average off-tone intensity score of 3.0 or less on a 10-point sensory scale and wherein starch bodies within the processed produce or produce tissues retain a Maltese cross pattern when viewed under cross-polarized light.

20. A method of processing starch-protein pulse(s) selected from the group consisting of chickpea (Cicer arietinum), yellow pea (Pisum sativum), common bean (Phaseolus vulgaris), fava bean (Vicia faba), and/or any combination thereof, or tissues thereof to remove off-flavors from the starch-protein pulse(s) or tissues while simultaneously preserving native, semi-crystalline structure of starch bodies contained therein to enable their subsequent separation, the method comprising the steps of:
a) continuously stirring the starch-protein pulse(s) or tissues thereof for a period of between about 1 to about 6 hours at a temperature of between 50° C. and 70° C. in an aqueous bicarbonate solution containing 0.5% to 10% by weight of a bicarbonate salt;
b) removing solution containing off-flavor compounds from the treated starch-protein pulse(s) or tissues thereof; and
c) washing the treated starch-protein pulse(s) or tissues thereof; so as to substantially diminish off-flavor of the starch-protein pulse(s) or tissues thereof while preserving the native semi-crystalline structure of starch bodies within the starch-protein pulse(s) or tissues thereof, as may be evidenced by retention of a Maltese cross pattern in the starch bodies when viewed under cross-polarized light, thereby enabling subsequent separation of intact starch bodies.

21. The method according to claim 20, wherein the treated pulse has an average off-tone intensity score of 3.0 or less on a 10-point sensory scale.

22. The method according to claim 20, further comprising producing a dry flour from the treated starch-protein pulse(s) or tissues thereof, said dry flour having a hexanal level below 0.05 μM/g.

23. The method according to claim 20, wherein the aqueous bicarbonate solution further comprises at least one salt or an oxide of a bivalent ion selected from the group consisting of Ca++, Fe++, Mg++, and Zn++.

24. The method according to claim 23, which reduces material loss from the starch-protein pulse(s) or tissues thereof during step a).

25. The method according to claim 20, further comprising:
a step of grinding the washed starch-protein pulse(s) or tissues thereof to release the intact starch bodies and
a step of separating a starch-enriched fraction from a protein-and-fiber-enriched fraction.

26. The method according to claim 25, wherein separation of the starch-enriched fraction from a protein-and-fiber-enriched fraction comprises wet sieving or dry air classification.

27. A pulse flour made of starch-protein pulse(s) selected from the group consisting of chickpea (Cicer arietinum), yellow pea (Pisum sativum), common bean (Phaseolus vulgaris), fava bean (Vicia faba), and/or any combination thereof, or tissues thereof,
wherein the pulse flour comprises a population of starch granules wherein at least 80% of said starch granules exhibit a Maltese cross pattern when viewed under cross-polarized light, and
wherein the pulse flour has an average off-tone intensity score of 3.0 or less on a 10-point sensory scale.

28. The pulse flour of claim 27, wherein the pulse flour has a hexanal level below 0.05 μM/g.
